(19) United States
(12) Patent Application Publication
(10) Pub. No.: US 2026/0293841 A1
(43) Pub. Date: Oct. 1, 2026

(54) PET TRAVEL CARRIER

(71) Applicant: JANI INTERNATIONAL PTE. LTD., Singapore (SG)

(72) Inventors: Curtis M. Hartenstine, Birdsboro, PA (US); Patrick J.G. Bowers, West Chester, PA (US); Daniel A. Sack, Mohnton, PA (US); Joshua Ferguson, Southampton, PA (US); Colin F. Eggert-Crowe, King of Prussia, PA (US); Lance J. Clemmer, Mohnton, PA (US); Jerry S. Ingraham, Denver, PA (US)

(21) Appl. No.: 19/490,112

(22) PCT Filed: Jun. 14, 2024
(86) PCT No.: PCT/US2024/034078

§ 371 Date: Dec. 4, 2025

Related U.S. Application Data
(60) Provisional application No. 63/508,699, filed on Jun. 16, 2023.
(60) Provisional application No. 63/519,165, filed on Aug. 11, 2023.
(60) Provisional application No. 63/578,494, filed on Aug. 24, 2023.
(60) Provisional application No. 63/584,747, filed on Sep. 22, 2023.
(60) Provisional application No. 63/595,584, filed on Nov. 2, 2023.
(60) Provisional application No. 63/598,562, filed on Nov. 14, 2023.
(60) Provisional application No. 63/625,664, filed on Jan. 26, 2024.
(60) Provisional application No. 63/552,306, filed on Feb. 12, 2024.

(51) Int. Cl. A01K 1/02

(52) U.S. Cl. CPC A01K 1/0272

(57) ABSTRACT

A pet carrier for containing animals on a vehicle seat having at least one vehicle seat anchor includes a body defining an enclosure having an interior within which an animal is receivable. The body includes a cavity. At least one rigid latch connector is mounted to the body for movement between a stowed position and a deployed position. The at least one rigid latch connector is receivable within the cavity when in the stowed position and is connectable to the at least one vehicle seat anchor of the vehicle seat when in the deployed position.

### CROSS REFERENCE TO RELATED APPLICATIONS

This application claims the benefit of U.S. Application No. 63/508,699, filed on Jun. 16, 2023, U.S. Application No. 63/519,165, filed on Aug. 11, 2023, U.S. Application No 63/578,494, filed on Aug. 24, 2023, U.S. Application No. 63/584,747, filed on Sep. 22, 2023, U.S. Application No. 63/595,584, filed on Nov. 2, 2023, U.S. Application No. 63/598,562, filed on Nov. 14, 2023, U.S. Application No. 63/625,664, filed on Jan. 26, 2024, and U.S. Application No. 63/552,306, filed on Feb. 12, 2024 which is incorporated herein by reference in its entirety.

### BACKGROUND

The present disclosure relates generally to an animal containment unit or carrier for installation in a vehicle, and more particularly to an animal containment unit or carrier that includes connectors for installation in a vehicle.

A crate or another type of carrier can be used to transport animals in a vehicle (e.g., automobile, airplane, train, bicycle, or the like). However, many existing carriers suffer from various deficiencies. For example, some carriers are insufficiently anchored to contain and protect the animal in the event of a car crash. In another example, a carrier may be difficult to install in the vehicle. In still another example, a carriers may not be sized for airline carry-on travel (e.g., able to fit underneath a conventional airplane seat).

### SUMMARY

According to an embodiment, a pet carrier for containing animals on a vehicle seat having at least one vehicle seat anchor includes a body defining an enclosure having an interior within which an animal is receivable. The body includes a cavity. At least one rigid latch connector is mounted to the body for movement between a stowed position and a deployed position. The at least one rigid latch connector is receivable within the cavity when in the stowed position and is connectable to the at least one vehicle seat anchor of the vehicle seat when in the deployed position.

In addition to one or more of the features described above, or as an alternative, in further embodiments the at least one rigid latch connector is translatable along an axis between the stowed position and the deployed position.

In addition to one or more of the features described above, or as an alternative, in further embodiments the at least one rigid latch connector is rotatable about an axis between the stowed position and the deployed position.

In addition to one or more of the features described above, or as an alternative, in further embodiments at least one biasing mechanism is operably coupled to the at least one rigid latch connector to bias the at least one rigid latch connector to the deployed position.

In addition to one or more of the features described above, or as an alternative, in further embodiments the body includes a first section and a second section. The first section includes a frame and containment materials extending at least partially about the frame and the second section includes a base, the frame being connectable to the base.

In addition to one or more of the features described above, or as an alternative, in further embodiments the cavity is formed in the base.

In addition to one or more of the features described above, or as an alternative, in further embodiments a latch deployment mechanism is operable to automatically transform the at least one rigid latch connector from the stowed position to the deployed position in response to an input.

In addition to one or more of the features described above, or as an alternative, in further embodiments the latch deployment mechanism includes a deployment actuator operably coupled to the at least one rigid latch connector by a deployment assembly. The at least one rigid latch connector automatically transforms from the stowed position to the deployed position in response to operation of the deployment actuator.

In addition to one or more of the features described above, or as an alternative, in further embodiments the at least one rigid latch connector further comprises a plurality of rigid latch connectors. The deployment actuator is operably coupled to the plurality of rigid latch connectors such that the plurality of rigid latch connectors are simultaneously transformable between the stowed position and the deployed position in response to operation of the deployment actuator.

In addition to one or more of the features described above, or as an alternative, in further embodiments the deployment actuator is a handle arranged at the base.

In addition to one or more of the features described above, or as an alternative, in further embodiments the deployment actuator is a handle arranged at front of the body.

In addition to one or more of the features described above, or as an alternative, in further embodiments a release mechanism is operably coupled to the at least one rigid latch connector to unlock the at least one rigid latch connector.

In addition to one or more of the features described above, or as an alternative, in further embodiments the release mechanism further includes a release actuator and at least one transmitted operatively connecting the at least one rigid latch connector to the release actuator.

In addition to one or more of the features described above, or as an alternative, in further embodiments the release actuator is a handle arranged at the first section of the body.

In addition to one or more of the features described above, or as an alternative, in further embodiments the deployment actuator is the release actuator.

According to an embodiment, a pet carrier for containing animals on a vehicle seat includes a body defining an enclosure having an interior within which an animal is receivable. The body includes a cavity. A plurality of rigid latch connectors are mounted to the body for movement between a stowed position and a deployed position. An axial distance defined between the plurality of rigid latch connectors in the deployed position is greater than the axial distance defined between the plurality of rigid latch connectors in the stowed position.

In addition to one or more of the features described above, or as an alternative, in further embodiments the plurality of rigid latch connectors in the stowed position are parallel to the plurality of rigid latch connectors in the deployed position.

In addition to one or more of the features described above, or as an alternative, in further embodiments the plurality of rigid latch connectors are rotatable about an axis between the stowed position and the deployed position.

In addition to one or more of the features described above, or as an alternative, in further embodiments the plurality of rigid latch connectors are translatable about an axis between the stowed position and the deployed position.

In addition to one or more of the features described above, or as an alternative, in further embodiments the plurality of rigid latch connectors are operable to rotate and translate simultaneously between the stowed position and the deployed position.

In addition to one or more of the features described above, or as an alternative, in further embodiments the body includes a first section and a second section. The first section includes a frame and containment materials extending at least partially about the frame and the second section includes a base. The frame is connectable to the base.

In addition to one or more of the features described above, or as an alternative, in further embodiments the body is rectangular in shape and has a longer side and a shorter side. The plurality of rigid latch connectors are extendable from the shorter side.

In addition to one or more of the features described above, or as an alternative, in further embodiments the pet carrier is receivable within an area under the vehicle seat. A size of the base is equal to or less than the area under the vehicle seat when the plurality of rigid latch connectors are in the stowed position. The size of the base exceeds the area under the vehicle seat when the plurality of rigid latch connectors are in the stowed position.

In addition to one or more of the features described above, or as an alternative, in further embodiments at least one storage recess for receiving the plurality of rigid latch connectors is formed in the base.

In addition to one or more of the features described above, or as an alternative, in further embodiments the at least one storage recess includes a first storage recess for receiving a first rigid latch connector of the plurality of rigid latch connectors and a second storage recess for receiving a second rigid latch connector of the plurality of rigid latch connectors. The first storage recess is separate from the second storage recess.

According to an embodiment, a pet carrier for containing animals on a vehicle seat including at least one vehicle seat anchor includes a body defining an enclosure having an interior within which an animal is receivable. At least one rigid latch connector is mounted to the body for movement between a stowed position and a deployed position. A latch deployment mechanism is operably coupled to the at least one rigid latch connector. The latch deployment mechanism is operable to automatically transform the at least one rigid latch connector from the stowed position to the deployed position in response to an input.

In addition to one or more of the features described above, or as an alternative, in further embodiments the at least one rigid latch connector is pivotable between the stowed position and the deployed position.

In addition to one or more of the features described above, or as an alternative, in further embodiments the latch deployment mechanism includes a deployment actuator and a deployment assembly. The deployment assembly operatively couples the at least one rigid latch connector to the deployment actuator. The at least one rigid latch connector is automatically transformable from the stowed position to the deployed position in response to operation of the deployment actuator.

In addition to one or more of the features described above, or as an alternative, in further embodiments the deployment assembly further includes a latch lock slider engageable with the at least one rigid latch connector and a linkage extending between the deployment actuator and the latch lock slider. The latch lock slider is movable out of engagement with the at least one rigid latch connector in response to operation of the deployment actuator.

In addition to one or more of the features described above, or as an alternative, in further embodiments a biasing mechanism operably coupled to the at least one rigid latch connector to bias the at least one rigid latch connector to the deployed position.

In addition to one or more of the features described above, or as an alternative, in further embodiments the at least one rigid latch connector includes a lock feature and in the stowed position, engagement between the lock feature and the latch lock slider restricts rotation of the at least one rigid latch connector from the stowed position.

In addition to one or more of the features described above, or as an alternative, in further embodiments a surface of the lock feature is contoured and engagement between the surface and the lock feature is operable to move the latch lock slider out of a path of rotation of the at least one rigid latch connector.

In addition to one or more of the features described above, or as an alternative, in further embodiments the at least one rigid latch connector has a plurality of latch teeth and the deployment assembly further comprises a gear rotatable about an axis. The gear is intermeshed with the plurality of latch teeth. The deployment assembly additionally includes a latch lock slider engageable with the gear and a linkage extending between the deployment actuator and the latch lock slider. The latch lock slider is movable out of engagement with the gear in response to operation of the deployment actuator.

In addition to one or more of the features described above, or as an alternative, in further embodiments the gear has a first recess and a second recess. The latch lock slider is engaged with the first recess when the at least one rigid latch connector is in the stowed position, and the latch lock slider is engaged with the second recess when the at least one rigid latch connector is in the deployed position.

In addition to one or more of the features described above, or as an alternative, in further embodiments a biasing mechanism is coupled to at least one of the gear and the at least one rigid latch connector. The biasing mechanism is operable to bias the at least one rigid latch connector to the deployed position.

In addition to one or more of the features described above, or as an alternative, in further embodiments the at least one rigid latch connector includes a plurality of rigid latch connectors and the deployment actuator is operably coupled to the plurality of rigid latch connectors such that the plurality of rigid latch connectors are simultaneously transformable between the stowed position and the deployed position in response to operation of the deployment actuator.

In addition to one or more of the features described above, or as an alternative, in further embodiments the body has a first section and a second section. The second section includes a base and the at least one rigid latch connector is mounted to the base.

In addition to one or more of the features described above, or as an alternative, in further embodiments the base includes an upper tray and a lower tray and the deployment assembly is arranged between the upper tray and the lower tray.

In addition to one or more of the features described above, or as an alternative, in further embodiments the deployment actuator is a pull handle arranged at the base.

In addition to one or more of the features described above, or as an alternative, in further embodiments the deployment actuator is a pull handle arranged at a front of the body.

In addition to one or more of the features described above, or as an alternative, in further embodiments a structural member is arranged within the base and the at least one rigid latch connector is receivable within a cavity of the structural member when in the stowed position.

In addition to one or more of the features described above, or as an alternative, in further embodiments at least one reinforcement member connected to the body. The at least one reinforcement member spans the first section and is connected to the base.

In addition to one or more of the features described above, or as an alternative, in further embodiments the at least one reinforcement member extends about a top and at least one sidewall of the body.

In addition to one or more of the features described above, or as an alternative, in further embodiments the at least one reinforcement member includes a first reinforcement member and a second reinforcement member.

In addition to one or more of the features described above, or as an alternative, in further embodiments the base includes an upper tray and a lower tray. The at least one reinforcement member is arranged between the upper tray and the lower tray.

In addition to one or more of the features described above, or as an alternative, in further embodiments the upper tray includes a slot and the at least one reinforcement member extends through the slot.

In addition to one or more of the features described above, or as an alternative, in further embodiments the pet carrier includes an actuator and a release mechanism associated with the actuator and operable to automatically transform the at least one rigid latch connector from the closed configuration to the released configuration. The latch deployment mechanism is associated with the actuator.

In addition to one or more of the features described above, or as an alternative, in further embodiments the latch deployment mechanism and the release mechanism are operably coupled to different connection points of the at least one rigid latch connector.

In addition to one or more of the features described above, or as an alternative, in further embodiments the latch deployment mechanism and the release mechanism are simultaneously operable in response to operation of the actuator.

In addition to one or more of the features described above, or as an alternative, in further embodiments the latch deployment mechanism is operable in response to a first operation of the actuator and the release mechanism is operable in response to a second operation of the actuator.

In addition to one or more of the features described above, or as an alternative, in further embodiments the first operation and the second operation include application of a force to the actuator in the same direction.

In addition to one or more of the features described above, or as an alternative, in further embodiments the first operation includes application of a force to the actuator in a first direction and the second operation includes application of a force to the actuator in a second direction.

In addition to one or more of the features described above, or as an alternative, in further embodiments the latch deployment mechanism includes a deployment assembly including a first linkage operably coupled to the actuator and the release mechanism includes a release assembly including a second linkage operably coupled to the actuator.

In addition to one or more of the features described above, or as an alternative, in further embodiments the body includes a base and the first linkage extends along a first path through the base and the second linkage extends along a second path through the base.

In addition to one or more of the features described above, or as an alternative, in further embodiments the actuator includes a force multiplier.

In addition to one or more of the features described above, or as an alternative, in further embodiments the at least one rigid latch connector is pivotable between the stowed position and the deployed position.

According to an embodiment, a pet carrier for use with a vehicle seat including at least one vehicle seat anchor includes a body including a base, at least one rigid latch connector arranged at the base, a handle coupled to the body for lifting the pet carrier, and an actuator located remotely from the at least one rigid latch connector. The actuator is operatively coupled to the at least one rigid latch connector to transform the at least one rigid latch connector from a closed configuration to a released configuration.

In addition to one or more of the features described above, or as an alternative, in further embodiments in the released configuration, the at least one rigid latch connector is releasable from a vehicle anchor of the vehicle seat.

In addition to one or more of the features described above, or as an alternative, in further embodiments the actuator is located at the body proximate the handle.

In addition to one or more of the features described above, or as an alternative, in further embodiments the actuator is a button or switch that is actuated independently from a force applied to the handle.

In addition to one or more of the features described above, or as an alternative, in further embodiments the actuator is directly connected to the handle such that a force applied to the handle actuates the actuator.

In addition to one or more of the features described above, or as an alternative, in further embodiments the at least one rigid latch connector includes a first rigid latch connector and a second rigid latch connector. The actuator is operatively coupled to the first rigid latch connector via a first transmitter and is operatively coupled to the second rigid latch connector via a second transmitter.

In addition to one or more of the features described above, or as an alternative, in further embodiments the first rigid latch connector and the second rigid latch connector are operably simultaneously via the actuator.

In addition to one or more of the features described above, or as an alternative, in further embodiments the at least one rigid latch connector includes a first rigid latch connector and a second rigid latch connector. The actuator is operatively coupled to the first rigid latch connector and the second rigid latch connector via a single transmitter.

In addition to one or more of the features described above, or as an alternative, in further embodiments the first rigid latch connector and the second rigid latch connector are operably simultaneously via the actuator.

In addition to one or more of the features described above, or as an alternative, in further embodiments the pet carrier includes a second actuator and the at least one rigid latch connector includes a first rigid latch connector and a second rigid latch connector. The actuator is operatively coupled to the first rigid latch connector via a first transmitter and the second actuator is operatively coupled to the second rigid latch connector via a second transmitter.

In addition to one or more of the features described above, or as an alternative, in further embodiments the actuator is directly connected to a first end of the handle and the second actuator is directly connected to a second, opposite end of the handle.

In addition to one or more of the features described above, or as an alternative, in further embodiments the handle is arranged at top of the body.

According to an embodiment, a method of removing a pet carrier from a vehicle including at least one vehicle seat anchor includes releasing at least one rigid latch connector of the pet carrier from engagement with a vehicle anchor via operation of an actuator and wherein the actuator is located remotely from the at least one rigid latch connector.

In addition to one or more of the features described above, or as an alternative, in further embodiments the actuator is located proximate a handle of the pet carrier, the handle being operable to carry the pet carrier.

In addition to one or more of the features described above, or as an alternative, in further embodiments the actuator is directly connected to the handle.

In addition to one or more of the features described above, or as an alternative, in further embodiments releasing at least one rigid latch connector includes releasing a first rigid latch connector and a second rigid latch connector. Both the first rigid latch connector and the second rigid latch connector are released via operation of the actuator.

In addition to one or more of the features described above, or as an alternative, in further embodiments releasing at least one rigid latch connector includes releasing a first rigid latch connector via the actuator and releasing a second rigid latch connector via a second actuator.

According to an embodiment, a pet carrier includes a base, an interior cavity, and a canopy unit operably couplable to the base. The canopy unit includes an openable canopy. The openable canopy at least partially defines the interior cavity.

In addition to one or more of the features described above, or as an alternative, in further embodiments a sidewall fixed to the base and partially defining the interior cavity.

In addition to one or more of the features described above, or as an alternative, in further embodiments the sidewall extends upward about an entire perimeter of the base.

In addition to one or more of the features described above, or as an alternative, in further embodiments the openable canopy is removably coupled to the base.

In addition to one or more of the features described above, or as an alternative, in further embodiments each canopy includes a latch for connecting the canopy to the base.

In addition to one or more of the features described above, or as an alternative, in further embodiments the latch includes a button actuator.

In addition to one or more of the features described above, or as an alternative, in further embodiments the canopy unit includes a canopy bow movably relative to the base between a first position and a second position. The canopy unit is closed when the canopy bow is in the first position and the canopy unit is open when the canopy bow is in the second position.

In addition to one or more of the features described above, or as an alternative, in further embodiments the second position is about 180 degrees from the first position.

In addition to one or more of the features described above, or as an alternative, in further embodiments the second position is about 90 degrees from the first position.

In addition to one or more of the features described above, or as an alternative, in further embodiments the canopy unit includes a second canopy bow. A first end of the openable canopy being connected to the canopy bow, and a second end of the openable canopy being connected to the second canopy bow.

In addition to one or more of the features described above, or as an alternative, in further embodiments the canopy bow and the second canopy bow are movable independently.

In addition to one or more of the features described above, or as an alternative, in further embodiments the canopy unit further comprises a locking mechanism operable to retain the canopy bow in the first position.

In addition to one or more of the features described above, or as an alternative, in further embodiments the locking mechanism is a magnetic lock.

In addition to one or more of the features described above, or as an alternative, in further embodiments the canopy unit includes one or more support bows operably coupled to the openable canopy.

In addition to one or more of the features described above, or as an alternative, in further embodiments a second canopy unit is couplable to the base. The second canopy unit has a second canopy that at least partially defines the interior cavity.

In addition to one or more of the features described above, or as an alternative, in further embodiments the canopy unit and the second canopy unit are removably simultaneously from the base.

In addition to one or more of the features described above, or as an alternative, in further embodiments a center panel is arranged between the openable canopy and the second canopy. The center panel is fixed relative to the base.

In addition to one or more of the features described above, or as an alternative, in further embodiments a retention device is proximate the center panel, the retention device being configured to hold the openable canopy in an open position.

In addition to one or more of the features described above, or as an alternative, in further embodiments at least one rigid latch connector is arranged at the base. The at least one rigid latch connector is couplable to at least one seat anchor of a vehicle seat.

According to an embodiment, a pet carrier for containing animals on a vehicle seat including at least one vehicle seat anchor includes a body defining an enclosure having an interior within which an animal is receivable. The body includes a frame and containment materials extending at least partially about the frame. At least one soft latch connector is mounted to the body. A stiffening component has a rigidity greater than the containment materials. The at least one soft latch connector is affixed to the stiffening component.

In addition to one or more of the features described above, or as an alternative, in further embodiments the at least one soft latch connector is permanently connected to the body.

In addition to one or more of the features described above, or as an alternative, in further embodiments the at least one soft latch connector is removably connectable to the body.

In addition to one or more of the features described above, or as an alternative, in further embodiments the body includes a front and a rear and the at least one soft latch connector is affixed to the rear of the body proximate a midpoint of the pet carrier.

In addition to one or more of the features described above, or as an alternative, in further embodiments the at least one soft latch connector is affixed to the body via a webbing, and the stiffening component is integral with the webbing.

In addition to one or more of the features described above, or as an alternative, in further embodiments the body includes a first section and a second section that cooperate to define the interior. The first section is positioned upwardly adjacent to the second section. The webbing further includes at least one reinforcement member connected to the body. The at least one reinforcement member spans the first section and is connected to the second section.

In addition to one or more of the features described above, or as an alternative, in further embodiments the second section includes a base and an end of the at least one reinforcement member is connected to the base.

In addition to one or more of the features described above, or as an alternative, in further embodiments the at least one soft latch connector is operably coupled to the body via the stiffening component.

In addition to one or more of the features described above, or as an alternative, in further embodiments the stiffening component is a structural member arranged within a base of the body.

In addition to one or more of the features described above, or as an alternative, in further embodiments a cartridge is connectable to the base and the at least one soft latch connector is mounted to the cartridge.

In addition to one or more of the features described above, or as an alternative, in further embodiments the cartridge is positionable within a cavity defined by the structural member.

According to an embodiment, an adapter for use with a pet carrier includes a body having a first body portion associable with a bottom of the pet carrier and a second body portion associable with a secondary component. The second body portion includes soft goods.

In addition to one or more of the features described above, or as an alternative, in further embodiments the first body portion is arranged at an upper surface of the body and the second body portion is arranged at downwardly facing surface of the body.

In addition to one or more of the features described above, or as an alternative, in further embodiments the first body portion includes a surface and at least one sidewall extending from the surface to define an interior. The bottom of the pet carrier is positionable on the surface within the interior.

In addition to one or more of the features described above, or as an alternative, in further embodiments the first body portion includes a surface. The surface is contoured to restrict movement of the pet carrier relative to the body when the pet carrier is arranged in contact with the surface.

In addition to one or more of the features described above, or as an alternative, in further embodiments the soft goods conform to an upper surface of the secondary component positionable in contact therewith.

In addition to one or more of the features described above, or as an alternative, in further embodiments including an affixing mechanism operable to mechanically couple the pet carrier to the body.

In addition to one or more of the features described above, or as an alternative, in further embodiments including an affixing mechanism operable to mechanically couple the pet carrier to the secondary component.

According to an embodiment, a pet carrier for use in a vehicle includes a body defining an enclosure having an interior within which an animal is receivable. The body includes a base and a frame element. At least one rigid latch connector is mounted to the body and a first connection is formed between the at least one rigid latch connector and the base. A locking support is operably couplable with the at least one rigid latch connector. The locking support is engageable with the frame element at a second connection. The second connection is vertically offset from the first connection.

In addition to one or more of the features described above, or as an alternative, in further embodiments the second connection is arranged vertically above the first connection.

In addition to one or more of the features described above, or as an alternative, in further embodiments a first end of the locking support is movably couplable to the frame element and a second end of the locking support is operably couplable to the at least one rigid latch connector.

In addition to one or more of the features described above, or as an alternative, in further embodiments the second end of the locking support is rotatably affixable to the at least one rigid latch connector.

In addition to one or more of the features described above, or as an alternative, in further embodiments the second end of the locking support is slidably affixable to the at least one rigid latch connector.

In addition to one or more of the features described above, or as an alternative, in further embodiments the locking support is movable relative to the frame element between a first position in which the second end of the locking support is arranged proximal to the body and a second position in which the second end of the locking support is spaced away from the body.

In addition to one or more of the features described above, or as an alternative, in further embodiments the locking support is manually movable between the first position and the second position.

In addition to one or more of the features described above, or as an alternative, in further embodiments the at least one rigid latch connector is transformable from a stowed position to a deployed position and the locking support is movable in response to transforming the at least one rigid latch connector between the stowed position and the deployed position.

In addition to one or more of the features described above, or as an alternative, in further embodiments the locking support is formed from a single, rigid member.

In addition to one or more of the features described above, or as an alternative, in further embodiments the locking support is a linkage including a plurality of link members movable relative to one another.

### BRIEF DESCRIPTION OF THE DRAWINGS

The following descriptions should not be considered limiting in any way. With reference to the accompanying drawings, like elements are numbered alike:

FIG. 1 is a front perspective view of a pet carrier according to an embodiment;

FIG. 2 is a perspective view of a frame and a base of a pet carrier according to an embodiment;

FIG. 3 is a perspective view of a frame and a base of a pet carrier according to another embodiment;

FIG. 4 is a detailed perspective view of an interface between a frame and a base of a pet carrier according to an embodiment;

FIG. 5 is a perspective view of a portion of a base of a pet carrier according to an embodiment;

FIG. 6 is a top view of the base of FIG. 5 with an intermediate component shown in transparent according to an embodiment;

FIG. 7A is a schematic diagram of a pet carrier including the base of FIG. 5 according to an embodiment;

FIG. 7B is a schematic diagram of the pet carrier of FIG. 7A in response to a crash event according to an embodiment;

FIG. 8 is a perspective view of a portion of a base of a pet carrier according to another embodiment;

FIG. 9 is a top view of the base of FIG. 8 with an intermediate component shown in transparent according to an embodiment;

FIG. 10A is a schematic diagram of a pet carrier including the base of FIG. 8 according to an embodiment;

FIG. 10B is a schematic diagram of the pet carrier including the base of FIG. 10A in response to a crash event according to an embodiment;

FIG. 11 is a perspective view of a portion of a base of a pet carrier according to another embodiment;

FIG. 12 is a top view of the base of FIG. 8 with an intermediate component shown in transparent according to an embodiment;

FIG. 13A is a schematic diagram of a pet carrier including the base of FIG. 11 according to an embodiment;

FIG. 13B is a schematic diagram of the pet carrier including the base of FIG. 13A in response to a crash event according to an embodiment;

FIG. 14 is a cross-sectional view of a pet carrier including a structural member arranged within the base according to an embodiment;

FIG. 15 is a perspective view of a pet carrier including a reinforcement assembly according to an embodiment;

FIG. 16 is a plan view of the base of the pet carrier of FIG. 15 including a reinforcement assembly according to an embodiment;

FIG. 17 is a cross-sectional view of a pet carrier including a reinforcement assembly according to an embodiment;

FIG. 18 is a detailed cross-sectional view of an interface between the reinforcement assembly and a structural member arranged within the base according to an embodiment;

FIG. 19 is a perspective view of a pet carrier having a release mechanism including a release actuator located remotely from a latch connector according to an embodiment;

FIG. 20 is a perspective view of a pet carrier having a release mechanism including a release actuator located remotely from a latch connector according to an embodiment;

FIG. 21 is a perspective view of a pet carrier having a release mechanism including a release actuator located remotely from a latch connector according to an embodiment;

FIG. 22 is a perspective view of a pet carrier having a release mechanism including a release actuator located remotely from a latch connector according to an embodiment;

FIG. 23A is a perspective view of a pet carrier having a plurality of rigid latch connectors in a stowed position according to an embodiment;

FIG. 23B is a perspective view of the pet carrier of FIG. 23A having a plurality of rigid latch connectors in a deployed position according to an embodiment;

FIG. 24A is a perspective view of a pet carrier having a plurality of rigid latch connectors in a stowed position according to an embodiment;

FIG. 24B is a perspective view of the pet carrier of FIG. 24A having a plurality of rigid latch connectors in a deployed position according to another embodiment;

FIG. 25A is a detailed perspective view of a rigid latch connector in a stowed position according to an embodiment;

FIG. 25B is a detailed perspective view of the rigid latch connector of FIG. 25A in a deployed position according to another embodiment;

FIG. 26A is a perspective view of a pet carrier having a plurality of rigid latch connectors in a stowed position according to an embodiment;

FIG. 26B is a perspective view of the pet carrier of FIG. 26A having a plurality of rigid latch connectors in a deployed position according to another embodiment;

FIG. 27A is a perspective view of a latch deployment mechanism associated with the plurality of rigid latch connectors of FIGS. 26A and 26B according to an embodiment;

FIG. 27B is a detailed perspective view of a portion of the latch deployment mechanism of FIG. 27A according to an embodiment;

FIG. 28 is a plan view of a latch deployment mechanism associated with a pivotable rigid latch connector according to an embodiment;

FIG. 29 is a detailed view of a portion of the latch deployment mechanism of FIG>28 according to an embodiment;

FIG. 30A is a detailed view of an interface between a latch connector and a latch lock slider of a latch deployment mechanism when the latch connector is in a stowed position according to an embodiment;

FIG. 30B is another detailed view of the interface between the latch connector and the latch lock slider of a latch deployment mechanism of FIG. 30A when the latch connector is in a stowed position according to an embodiment;

FIG. 31A is a detailed view of an interface between a latch connector and a latch lock slider of a latch deployment mechanism when the latch connector is in a deployed position according to an embodiment;

FIG. 31B is another detailed view of the interface between the latch connector and the latch lock slider of a latch deployment mechanism of FIG. 31A when the latch connector is in a deployed position according to an embodiment;

FIG. 32 is a plan view of a base including a latch deployment mechanism and a release mechanism operably coupled to the same actuator according to an embodiment;

FIG. 33 is a plan view of latch deployment mechanism when the latch connector is in a stowed position according to an embodiment;

FIG. 34 is a plan view of latch deployment mechanism when the latch connector is in a deployed position according to an embodiment;

FIG. 35A is a plan view of a portion of a release mechanism operatively coupled to the latch connectors according to an embodiment;

FIG. 35B is a plan view of a portion of a release mechanism operatively coupled to the latch connectors when a release actuator has been operated according to an embodiment;

FIG. 36 is a perspective view of a pet carrier having a soft latch connector according to an embodiment;

FIG. 37 is a perspective view of a pet carrier having soft latch connectors according to another embodiment;

FIG. 38 is a perspective view of a pet carrier having soft latch connectors according to another embodiment;

FIG. 39 is a perspective view of a pet carrier having soft latch connectors according to another embodiment;

FIG. 40 is a perspective view of a pet carrier having soft latch connectors according to another embodiment;

FIG. 41 is a perspective view of a pet carrier having a removable cartridge including soft latch connectors according to another embodiment;

FIG. 42 is a perspective view of a pet carrier having a tether according to an embodiment;

FIG. 43 is a perspective view of a pet carrier having a tether according to another embodiment;

FIG. 44 is a perspective view of a pet carrier having a tether according to another embodiment;

FIG. 45 is a perspective view of a pet carrier having a pocket for receiving a vehicle seat belt according to an embodiment;

FIG. 46 is a perspective view of a pet carrier having a canopy in a closed state according to an embodiment;

FIG. 47 is a perspective view of the pet carrier of FIG. 46 having a canopy in an open state according to an embodiment;

FIG. 48A is a front perspective view of the pet carrier of FIG. 46 with the canopy shown as transparent according to an embodiment;

FIG. 48B is another front perspective view of the pet carrier of FIG. 46 with the canopy shown as transparent according to an embodiment;

FIGS. 49A, 49B, and 49C are front views of the pet carrier of FIG. 48A arranged respectively in a closed state, partially open state, and fully open state according to an embodiment;

FIG. 50A is a perspective view of a lock mechanism in a disengaged position according to an embodiment;

FIG. 50B is a perspective view of a lock mechanism in an engaged position according to an embodiment;

FIG. 51 is a front view of the pet carrier of FIG. 46 having the canopy separated from the base according to an embodiment;

FIG. 52A is a perspective view of a pet carrier having a plurality of canopies in a closed state according to an embodiment;

FIG. 52B is a front view of a pet carrier having a plurality of canopies in a closed state open state;

FIG. 53 is a perspective view of a pet carrier having a plurality of canopies in an open state according to an embodiment;

FIG. 54A is a perspective view of the pet carrier of FIG. 46 with the canopies shown as transparent according to an embodiment;

FIG. 54B is a front view of the pet carrier of FIG. 46 with the canopy shown as transparent according to an embodiment;

FIGS. 55A, 55B, and 55C are front views of the pet carrier of FIG. 52B, arranged in a partially open state, arranged in another partially open state, and arranged in a fully open state according to an embodiment;

FIG. 56 is a front view of the pet carrier of FIG. 52B having the plurality of canopies separated from the base according to an embodiment;

FIG. 57 is an adapter for mounting a pet carrier to a body other than a vehicle seat according to an embodiment;

FIG. 58 is a perspective view of a pet carrier mounted to a body via the adapter according to an embodiment;

FIG. 59 is an exploded view of the pet carrier mounted to the body shown in FIG. 58;

FIG. 60A is a perspective view of a pet carrier having locking supports operably coupled to the rigid latch connectors in a deployed position according to an embodiment;

FIG. 60B is a perspective view of the pet carrier of FIG. 60A as the rigid latch connectors are rotated towards a stowed position according to an embodiment;

FIG. 61 is a perspective view of a pet carrier having locking supports operably coupled to the rigid latch connectors according to another embodiment;

FIG. 62A is a perspective view of a pet carrier having linkage locking supports operably coupled to the rigid latch connectors in a deployed position according to an embodiment;

FIG. 62B is a perspective view of the pet carrier of FIG. 62A as the rigid latch connectors are rotated towards a stowed position according to an embodiment;

FIG. 63 is a perspective view of a pet carrier having independent locking supports operably coupled to the rigid latch connectors according to another embodiment;

FIG. 64 is a perspective view of a pet carrier having joined locking supports operably coupled to the rigid latch connectors according to another embodiment;

FIG. 65 is a perspective view of a pet carrier having locking supports operably coupled to the rigid latch connectors according to another embodiment; and

FIG. 66 is a perspective view of another pet carrier having movable rigid latch connectors according to another embodiment.

### DETAILED DESCRIPTION

A detailed description of one or more embodiments of the disclosed apparatus and method are presented herein by way of exemplification and not limitation with reference to the Figures.

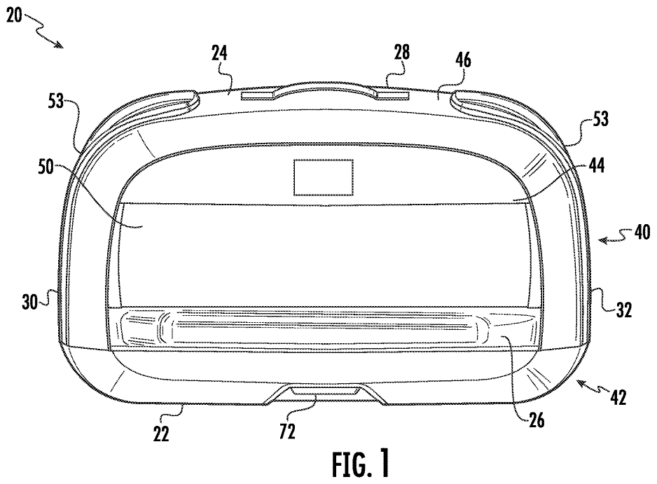

With reference now to FIG. 1, an example of a pet carrier 20 is illustrated. As shown, the pet carrier 20 may be an enclosed containment device or crate having a bottom 22, top 24, front 26, rear 28, left side 30, and right side 32. In an embodiment, the pet carrier 20 includes a first section 40 and a second section 42. In some embodiments, the first section 40 may be considered an upper section and the second section 42 may be considered a lower section such that the first section 40 is positioned vertically above or on top of the second section 42. In an embodiment, the first section 40 and the second section 42 are removably connectable to one another. However, in other embodiments, the first section 40 and the second section 42 are permanently connected. As used herein the term “permanently connected” represents embodiments where the first section 40 is not intended to be disassembled from the second section 42 by a user.

The first section 40 may include at least one sidewall 44 and a top 46 connected to an end or edge of the at least one sidewall 44. Accordingly, the first section 40 may define the top 24 of the pet carrier 20 and at least a portion of one or more of the front 26, rear 28, left side 30, and right side 32 of the pet carrier 20. In an embodiment, the first section 40 defines the top 24 and the substantial entirety of the front 26, rear 28, left side 30, and right side 32 of the pet carrier 20.

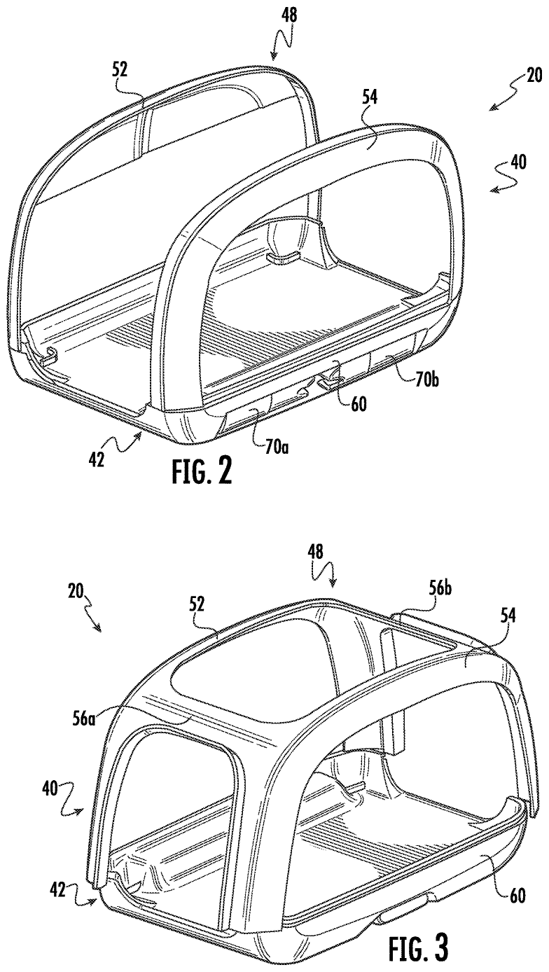

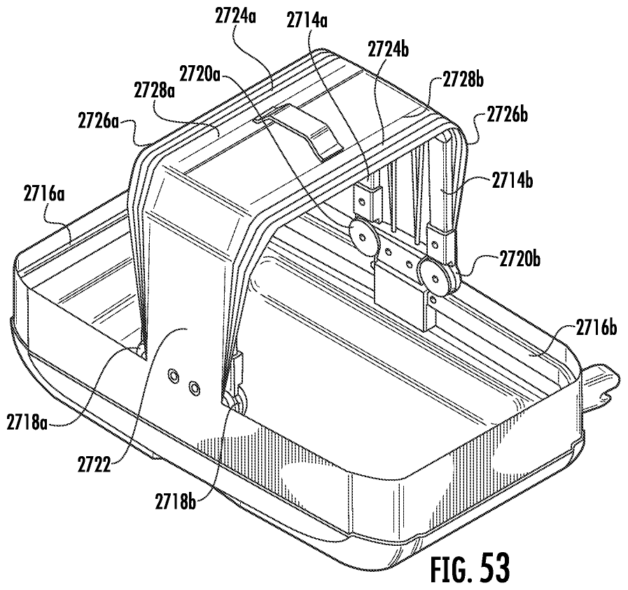

The first section 40 may include a structural frame 48 (see FIGS. 2 and 3) that defines a space in which a pet is contained within the interior of the pet carrier 20 during normal use and a covering 50 (see FIG. 1) associated with the frame 48. Examples of the covering 50 include but are not limited to containment materials or soft goods like nylon fabric or a semi-rigid material. The covering 50 may be removably connected to the frame 48, such as positionable in overlapping arrangement with the frame 48. In other embodiments, the covering 50 may be permanently attached to the frame 48, such as by sewing the covering 50 about one or more portions of the frame 48 for example. The pet carrier 20 may include one or more doors 52 (see FIG. 53) transformable between an open position and a closed position to selectively provide access to the interior of the pet carrier 20. In an embodiment, the one or more doors 52 are formed in the first section 40, such as within a portion of the covering 50 for example.

With reference to FIG. 2, the frame 48 includes one or more frame members, such as a first frame member 52 and a second frame member 54 spaced from the first frame member 52 along an axis. As shown, the first and second frame members 52, 54 may be substantially identical and/or in some embodiments have an upside-down u-shaped configuration. It should be understood that embodiments where a frame member, such as frame member 52 or 54 for example, defines at least one entire side (front, rear, left, and/or right side) of the first section 40, rather than only a portion thereof, are also within the scope of the disclosure. Although the first frame member 52 is illustrated as being generally parallel to the front 26 of the pet carrier 20 and the second frame member 54 is illustrated as being generally parallel to the rear 28 of the pet carrier 20, embodiments where one or more frame members has another orientation are also contemplated herein. For example, in an embodiment, one or more frame members may be oriented substantially parallel to the right side 32 and the left side 30 of the pet carrier 20.

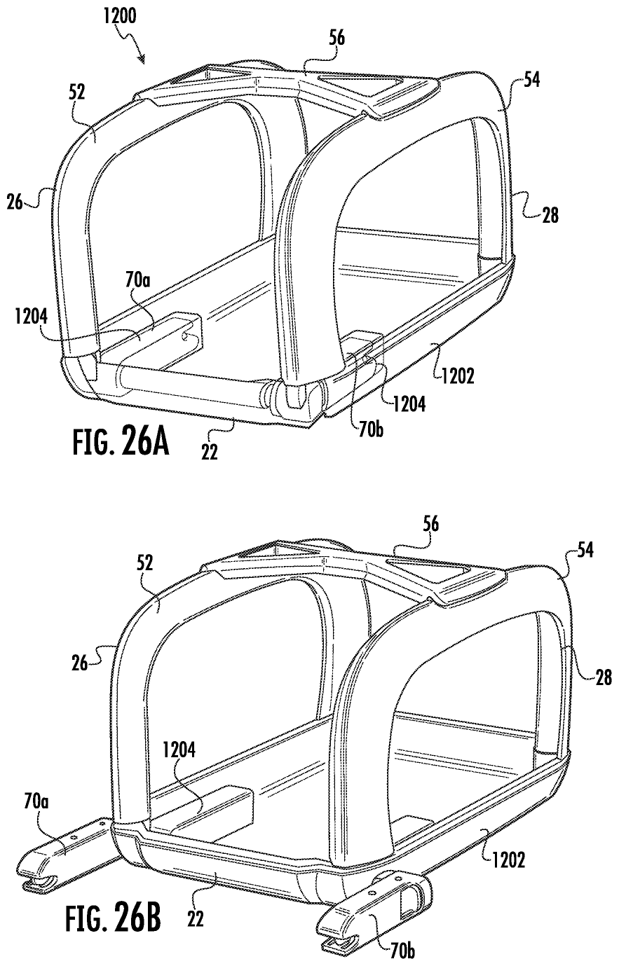

In some embodiments, such as shown in FIG. 2, the first and second frame members 52, 54 are not connected to one another. Rather, the covering 50 of the upper section 40 may be respectively connected to both frame members 52, 54. In other embodiments, one or more connecting frame members 56 extend between and connect the first and second frame members 52, 54, to one another. For example, as shown in FIG. 3, a first connecting frame member 56a may be arranged near a first side of the first and second frame members 52, 54 and a second connecting frame member 56b may be arranged near a second, opposite side of the first and second frame members 52, 54. In other embodiments, such as shown in FIGS. 26A and 26B, a single connecting frame member 56 extends between the first and second frame members 52, 54, such as at a central portion of the top thereof. It should be understood that the frame 48 illustrated and described herein is intended as an example only and that a frame 48 having any suitable construction is within the scope of the disclosure.

At least one frame member of the frame 48 may be movable relative to the second or lower section 42, while remaining connected thereto, such as to allow the frame to collapse for storage or to absorb forces during a crash event. In such embodiments, the at least one frame member may also be movable relative to other frame members of the frame 48. However, in other embodiments, the plurality of frame members may be integrally formed as a single body.

The frame 48 may be formed from any suitable material, such as plastic, or metal. For example, a frame member may be formed from tubing, wiring, or another suitable material. In the non-limiting embodiment of FIGS. 2-4, at least a portion of the frame 48 is formed from a thermoformed material and may include soft goods laminated thereon. In other embodiments, the substantial entirety of the frame 48 is formed from thermoformed materials and soft goods may be laminated over a portion or substantially all of the frame 48. In such embodiments, the frame 48 may form a semi-rigid envelope that can be at least partially collapsed, such as to adapt the upper section 40 to a space for receiving the pet carrier 20. Such a frame 48 may also create a soft restraint for a pet within the pet carrier 20 in the event of a vehicle crash or accident.

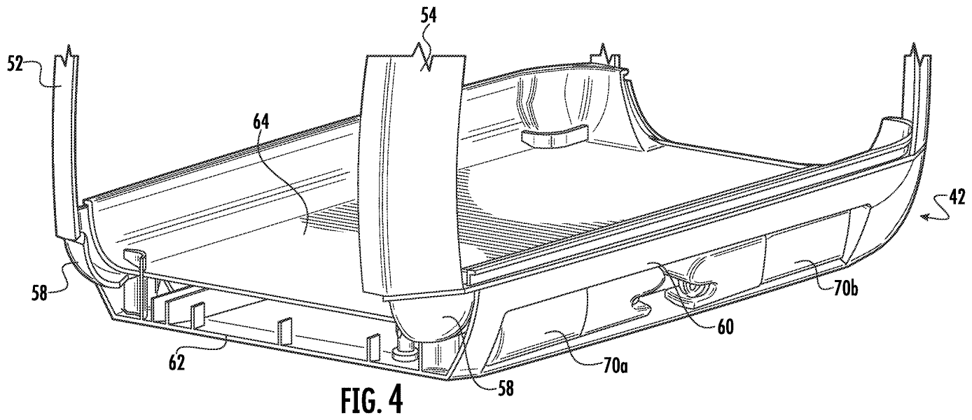

In embodiments where the first section 40 is separable from the second section 42, one or more of the plurality of frame members 52, 54 may be releasably connectable to the second section 42 to restrict unintended movement of the first section 40 relative to the second section 42. In an embodiment, as shown in FIG. 4, one or more of the plurality of frame members includes a frame connector 58 alignable with and operable to engage a corresponding interlock feature (not shown) formed in an adjacent portion of the second section.

The second section 42 of the pet carrier 20 may include a base 60, and in some embodiments, the base 60 may define the general shape of the pet carrier. Although the base 60 illustrated in the FIGS. is generally rectangular in shape, it should be appreciated that a base 60 having another shape is also contemplated herein. The second section 42 forms the bottom 22 of the pet carrier 20, and in some embodiments may additionally form at least a portion of one or more of the front 26, rear 28, left side 30, and right side 32 of the pet carrier 20.

In an embodiment, the base 60 includes a lower tray 62 and an upper tray 64 mounted in overlapping arrangement with the lower tray 62. The lower tray 62 may form the bottom surface 22 of the pet carrier 20 and the upper tray 64 may form the surface of the base 60 facing the interior of the pet carrier 20 and on which an animal is positioned. As will be discussed in more detail herein, the various embodiments of a pet carrier illustrated and described herein include one or more extendable latch connectors 70a and 70b operable to engage with a corresponding anchor of a vehicle seat.

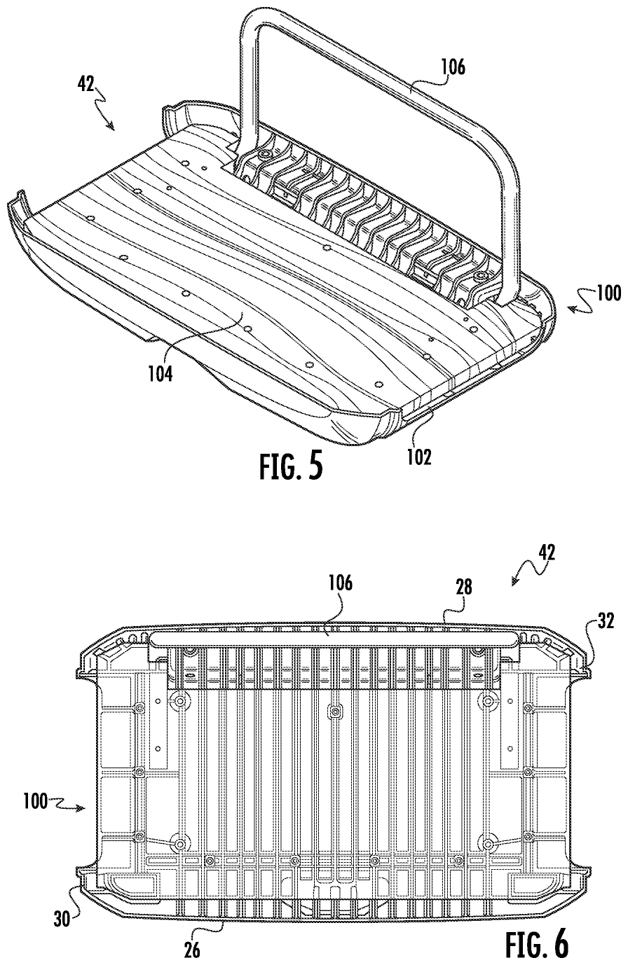

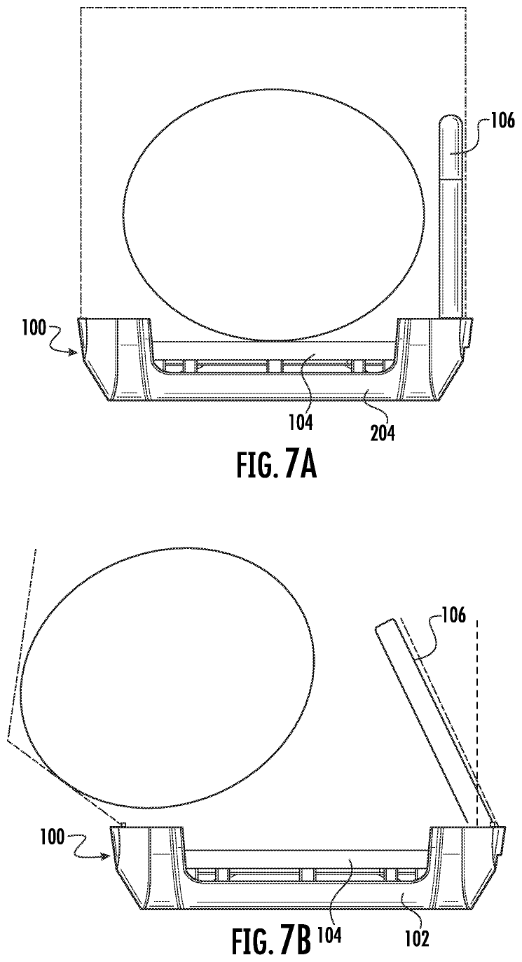

An example of a base 100 of a pet carrier 20 is illustrated in more detail in FIGS. 5-7B. In the illustrated, non-limiting embodiment, the base 100 has an intermediate component 104, such as formed from a plywood material for example, positioned between an upper tray (not shown), similar to tray 64 of FIG. 4 and the lower tray 102, similar to tray 62 shown in FIG. 4, such as to provide structural rigidity to the base for example. However, embodiments where an intermediate component 104 is arranged at another location, such as in overlapping arrangement with an upper surface of the upper tray for example, are also contemplated herein. The base 100 may have one or more crash-resistant elements 106 connected thereto. The one or more crash-resistant elements 106 may remain connected to the second section 42 even when the first section 40 is separated therefrom. Further, the one or more crash-resistant elements 106 may be connectable to a portion of the first section 40, such as the soft goods 50 of the first section 40 for example, when the first section 40 is attached to the base 100. In the illustrated, non-limiting embodiment, a single crash-resistant element 106 is connected to the base 100. An end of the crash-resistant element 106 may be mounted or attached to the base 100 at a position between the intermediate component 104 and the lower tray 102. As shown, the crash-resistant element 106 may be a bent piece of tubing extending generally perpendicularly from the intermediate component 104. In an embodiment, the crash-resistant element 106 is oriented generally parallel with the rear 28 of the pet carrier 20. Accordingly, the crash-resistant element 106 will deform in one direction in response to a crash force. The shape, material, and thickness of the crash-resistant element 106 may be selected to deflect less than or equal to a specific amount in response to application of a predetermined load. FIG. 7A illustrates the base 100 having the crash-resistant element 106 in a normal configuration and FIG. 7B illustrates the deflection of the crash-resistant element 106 in response to the predetermined load such as from, for example, a crash force.

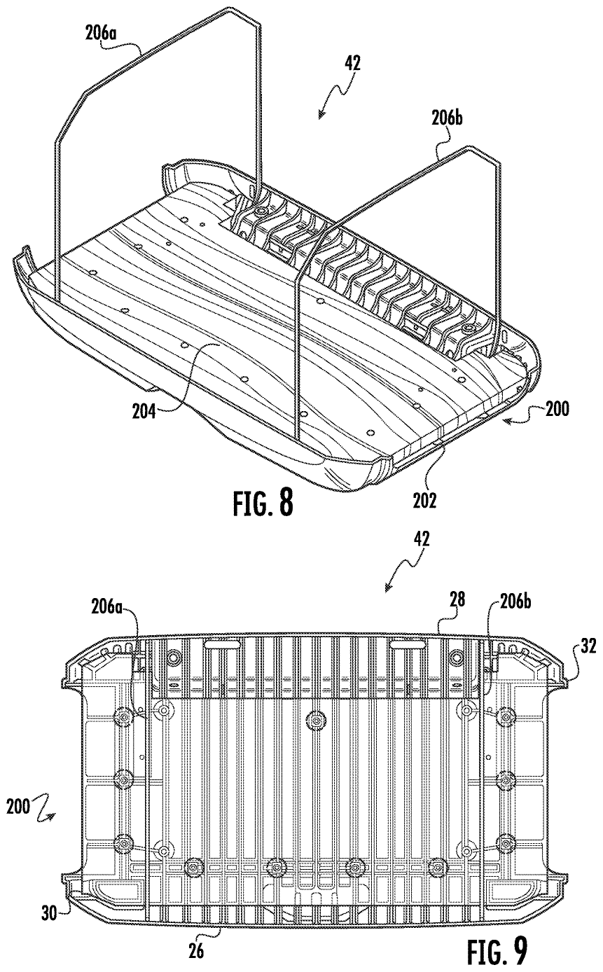

An embodiment of a base 200 of the second section 42 is illustrated in FIGS. 8-10B. The base 200 may be similar to the previous embodiment. As shown, the base 200 has an intermediate component 204, such as formed from a plywood material for example, positioned between the upper tray (not shown) and the lower tray 202. The base 200 additionally includes a plurality of crash-resistant elements, such as a first crash-resistant element 206a and a second crash-resistant element 206b. The plurality of crash-resistant elements 206a, 206b may be mounted to the base 200 in any suitable manner. In the illustrated, non-limiting embodiment, the first crash-resistant element 206a is arranged generally adjacent to the left side 30 of the pet carrier 20 and the second crash-resistant element 206b is arranged generally adjacent to the right side 32 of the pet carrier 20. The crash-resistant elements 206a, 206b, may be arranged substantially perpendicular to the intermediate component 204 such that the crash-resistant elements 206a, 206b are oriented substantially parallel to the left and right sides 30, 32 of the pet carrier, respectively.

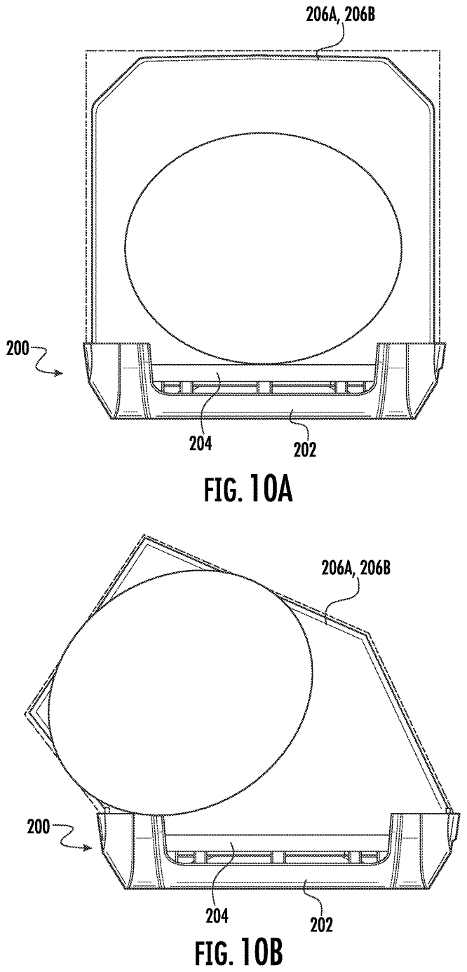

Although the plurality of crash-resistant elements 206a and 206b are illustrated as being substantially identical in configuration, embodiments where the crash-resistant elements vary are also contemplated herein. For example, construction of a crash-resistant element may depend on the position of the crash-resistant element and the expected forces to act thereon. In the illustrated, non-limiting embodiment, the crash-resistant elements are formed from a metal wire. However, it should be understood that any suitable material may be used to form the crash-resistant elements. FIG. 10A illustrates the base 200 having the crash-resistant elements 206a, 206b in a normal configuration and FIG. 10B illustrates the deflection of the crash-resistant elements 206a, 206b in response to the predetermined load. As shown, accordingly, the crash-resistant elements 206a, 206b are configured to deform in two directions in response to a crash force.

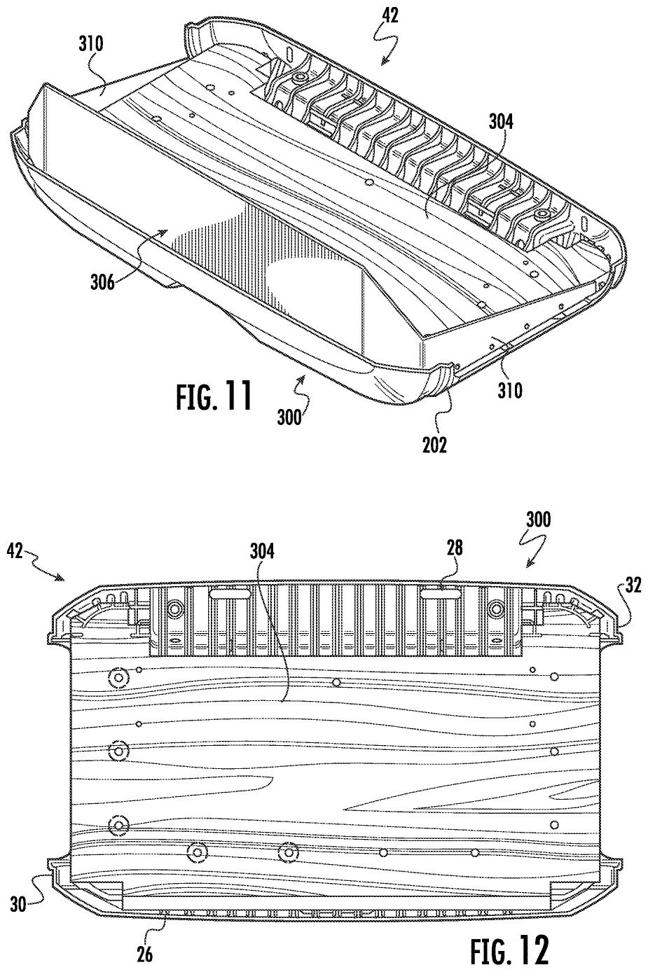

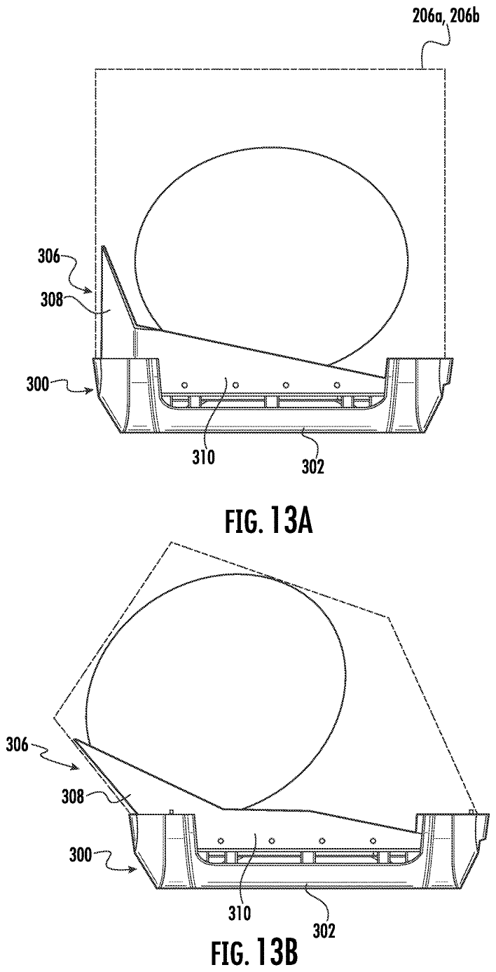

With reference to FIGS. 11-13B, another embodiment of a base 300 of a second section 42 of the pet carrier 10 is illustrated. The base 300 an intermediate component 304, such as formed from a plywood material for example, positioned between the upper tray (not shown) and the lower tray 302. The base 300 may additionally include a plurality of crash-resistant elements 306. In the illustrated non-limiting embodiment, the crash-resistant element 306 is a substantially solid barrier extending upwardly from a portion of the base 300. In an embodiment, the barrier 306 is mounted to the base 300 at a position between the lower tray 302 and the intermediate component 304. As shown, the barrier 306 may include a main portion 308 positioned adjacent to the front 26 of the pet carrier 20 and may include arms 310 that are oriented generally parallel to the left and right sides 30, 32 for example. A height of the arms 310 of the barrier 306, measured vertically from the upper surface of the intermediate component 304, may gradually increase towards the front 26 of the pet carrier 20. Alternatively, or in addition, the height of the main portion 308 of the barrier 306 may be uniform over the front 26 of the pet carrier 20 or may include one or more variations therein. The barrier 306 may be made from any suitable semi-rigid material, such as a plastic for example. The barrier 306 is designed to deform to absorb energy, thereby reducing the crash force exerted on an animal within the pet carrier 20. In each of the embodiments disclosed in FIGS. 5-13, a test dummy sized and weighted to approximate an animal within the interior of the pet carrier, is illustrated as being positioned atop the base 100, 200, 300 adjacent to the one or more crash-resistant elements 106, 206, 306. The test dummy and the crash-resistant elements 106, 206, 306 are shown in both a normal position and during a crash event.

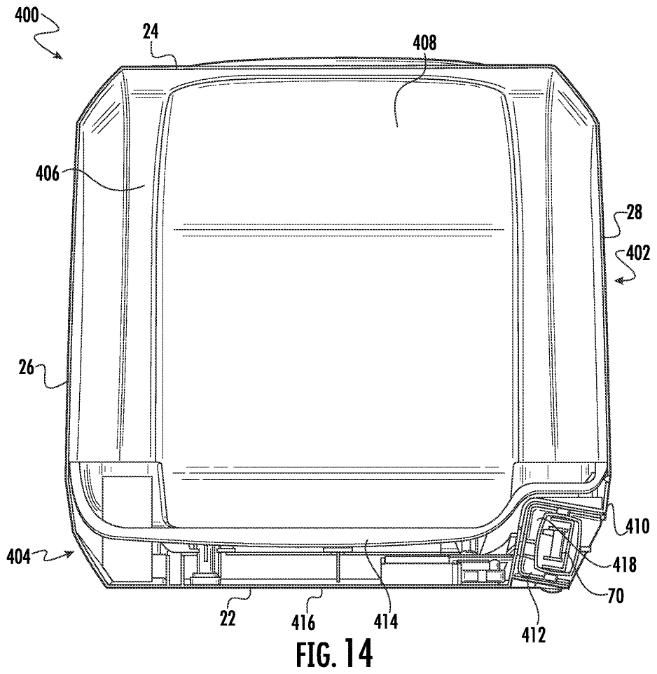

With reference now to FIG. 14, a pet carrier 400 according to an embodiment is shown. The illustrated pet carrier 400 has a first section 402 and a second section 404. The first section 402 is generally illustrated including a frame 406 and a covering 408 and the second section 404 includes a base 410. As shown, a structural member 412, such as C-channel for example, may be arranged within the base 410, such as between the upper and lower trays 414, 416 for example. The structural member 412 may be formed from any suitable material, such as an aluminum or steel sheet metal for example. The structural member 412 may be positioned relative to the base 410 such that a hollow interior 418 of the structural member 412 may define a cavity accessible at an exterior surface of the pet carrier 400. In the illustrated, non-limiting embodiment the structural member 412 is arranged at the rear 28 of the base 410 and extends parallel thereto. As will be described in more detail below, one or more latch connectors 70a, 70b of the pet carrier 400 operable to engage with a corresponding anchor of a vehicle seat may be mounted within the cavity 418 of the structural member 412. Further, the at least one latch connector 70 may be stowed within the cavity 418 when not in use.

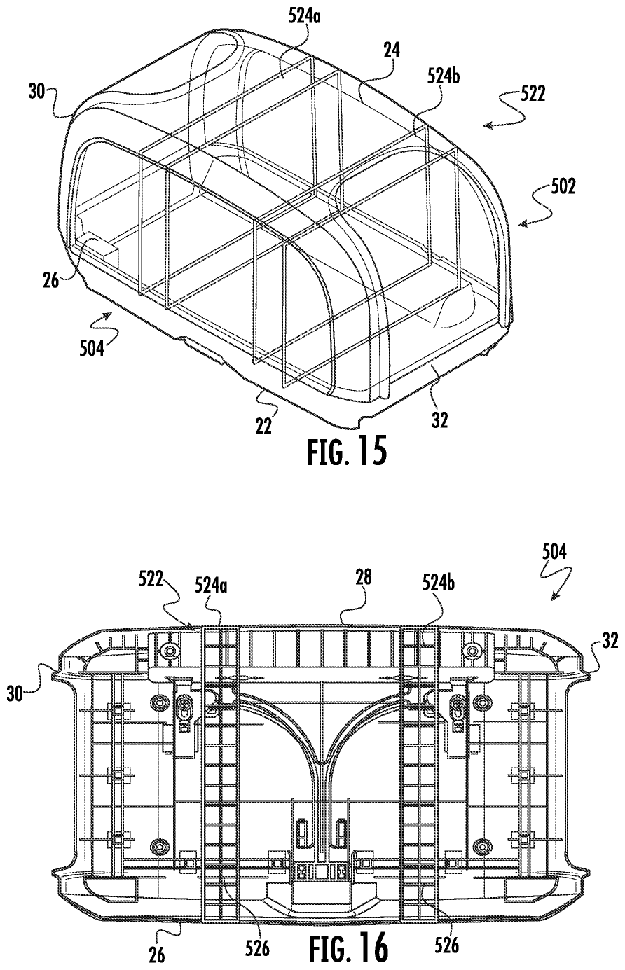

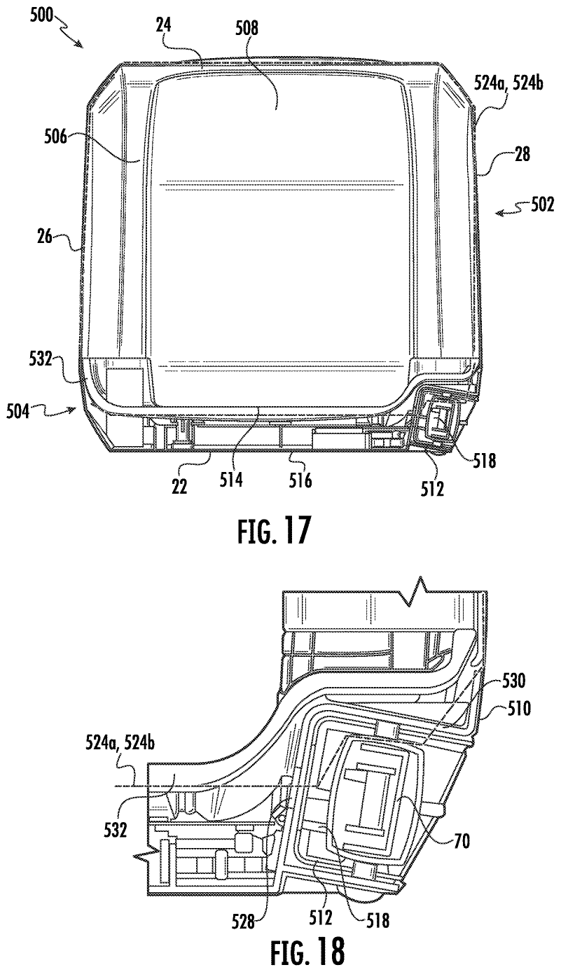

With reference now to FIGS. 15-18, in an embodiment, a pet carrier 500 includes a first section 502 and a second section 504. The first section 502 is generally illustrated including a frame 506 and a covering 508 (FIG. 17) and the second section 504 includes a base 510 of the pet carrier 500. As shown, a structural member 512 may be arranged within the base 510, such as between the upper and lower trays 514, 516 for example. The structural member 512 may be formed from any suitable material, such as an aluminum or steel sheet metal for example. The structural member 512 may be positioned relative to the base 510 such that a hollow interior 518 of the structural member 512 may define a cavity (for latch connectors 70a, 70b) accessible at an exterior surface of the pet carrier 500.

The pet carrier 500 may include a reinforcement subassembly 522 extending around one or more sides thereof. The reinforcement subassembly 522 includes at least one reinforcement member that encircle the pet carrier 500 around the first upper section 502 and the base 510. In other embodiments, the reinforcement subassembly 522 may span the first upper section, such as wrap about the front 26, top 24, and rear 28 for example, and the two opposing ends of the reinforcement subassembly 522 may be affixed to distinct portions of the base 510.

In the illustrated, non-limiting embodiment, the reinforcement subassembly 522 includes a first reinforcement member 524a and a second reinforcement member 524b; however, embodiments having a single reinforcement member, or alternatively, more than two reinforcement members are also contemplated herein. In an embodiment, the reinforcement members 524a, 524b are formed of, e.g., nylon webbing with a relatively high tensile strength relative to other components of the pet carrier 500. The reinforcement subassembly 522 may provide crash safety performance by transferring crash forces from vehicle anchors around the body of the pet carrier 500 while minimizing any point loads and preventing collapse of the pet carrier 500.

As shown, the reinforcement members 524a, 524b may be routed between the upper and lower trays 514, 516 of the base 510. The upper tray 514 may have one or more slots formed therein through which the reinforcement members 524a, 524b are routed to the interior of the base. Further, one or both of the upper and lower trays 514, 516 may have guides or supporting ribs 526 to properly position the reinforcement members 524a, 524b. In an embodiment, the reinforcement members 524a, 524b may be routed about the surface of the structural member 512. In other embodiments, such as shown in FIGS. 17 and 18, the reinforcement members 524a, 524b engage and are coupled to the structural member 512. For example, the structural member 512 may have one or more slots for receiving each individual reinforcement member 524a, 524b. In the illustrated, non-limiting embodiment, the structural member 512 has a slot 528, formed in the surface facing toward the interior of the base 51, associated with each reinforcement members 524a, 524b, respectively. Further, the structural member 512 may have an additional slot 530 extending through the portion furthest the bottom 22, to allow the reinforcement member to pass through an interior of the base 510.

Accordingly, the continuous loop formed by each reinforcement member 524a, 524b may pass through the structural member 512 and may be anchored by a latch connector 70.

As previously noted, soft goods, illustrated at 532 in FIGS. 17 and 18, may be provided to enclose the pet carrier 20 and provide various features such as ventilation, visibility, UV protection, etc. In an embodiment, soft goods may enclose the reinforcement subassembly 522 while following substantially the same path as the reinforcement members 524a, 524b. For example, soft goods may extend underneath the upper tray 514, such as between the upper tray 514 and the lower tray 516. In such embodiments, attachment features of the upper tray 514, such as ribs or feet for example, may extend below the upper tray 514 and through the soft goods to engage the lower tray 516. The rigid connection between the upper and lower trays 514, 516 results in a unitary base 510. However, in some embodiments, soft goods are not arranged within the structural member 512.

As previously noted, the various embodiments of a pet carrier illustrated and described herein include at least one latch connector operable to engage with a corresponding anchor of a vehicle seat. In the illustrated, non-limiting embodiments, such as shown in FIGS. 1-5, the pet carrier 20 has a plurality of latch connectors including a first latch connector 70a and a second latch connector 70b. However, embodiments having only a single latch connector or more than two latch connectors are also contemplated herein. The at least one latch connector 70a, 70b may be integral with the pet carrier. For example, the at least one latch connector may be permanently connected to the pet carrier 20. Alternatively, the at least one latch connector may be removably connected to the pet carrier 20.

In the illustrated, non-limiting embodiments, the at least one latch connector 70a, 70b is arranged at the second section 42 or the base 60 of the pet carrier 20. It should be understood that embodiments where a latch connector is arranged at another suitable location about the pet carrier 20 are also within the scope of the disclosure. Further, although the latch connectors 70a, 70b in several embodiments are illustrated as being positioned adjacent to the rear 28 of the pet carrier 20, in other embodiments one or more latch connectors 70a, 70b may be arranged at another side of the pet carrier 20, such as at the right side 32, the left side 30, or the front 26 of the pet carrier for example.

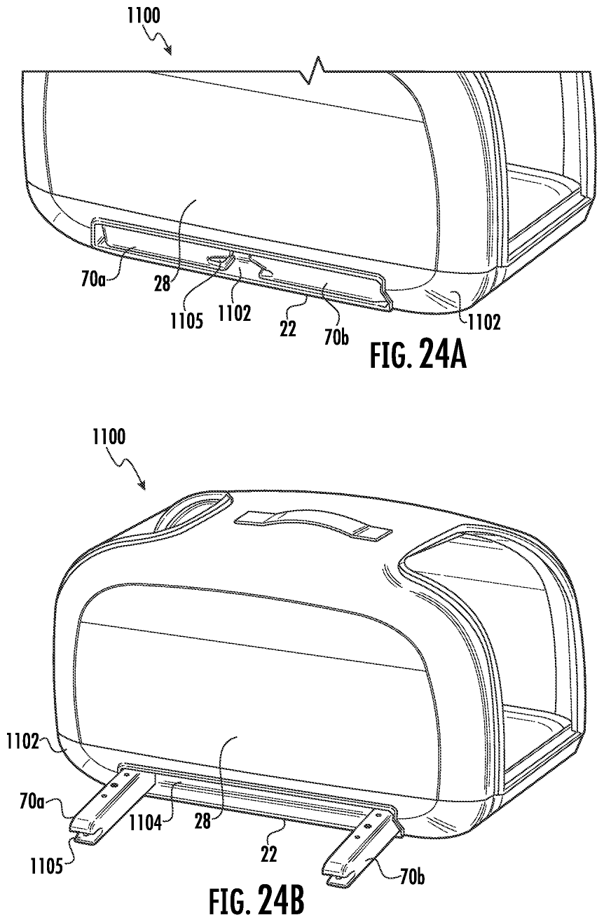

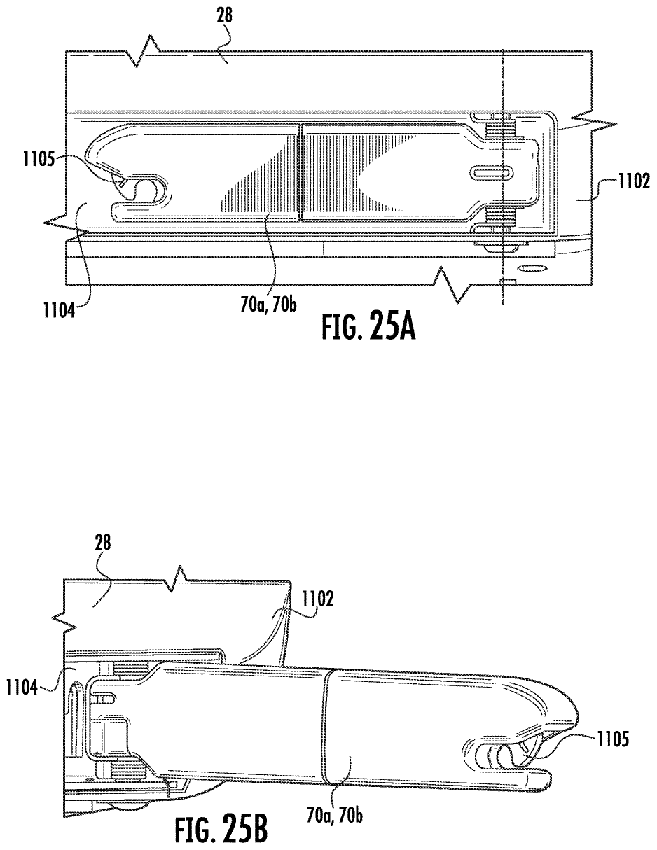

A latch connector 70a, 70b may be transformable, such as via a release actuator, from a closed or engaged configuration in which a catch member 1105 (see FIGS. 24A and 25A) of the latch connector 70a, 70b is closed or extended, and an open or released configuration in which a catch member of the latch connector 70a, 70b is open or retracted (not shown) and therefore separable from a vehicle anchor. Although not shown, in some embodiments, the release actuator is located directly at the latch connector 70a, 70b. In such embodiments, a user operates the release actuator of each respective latch connector to separate the pet carrier from corresponding vehicle anchors.

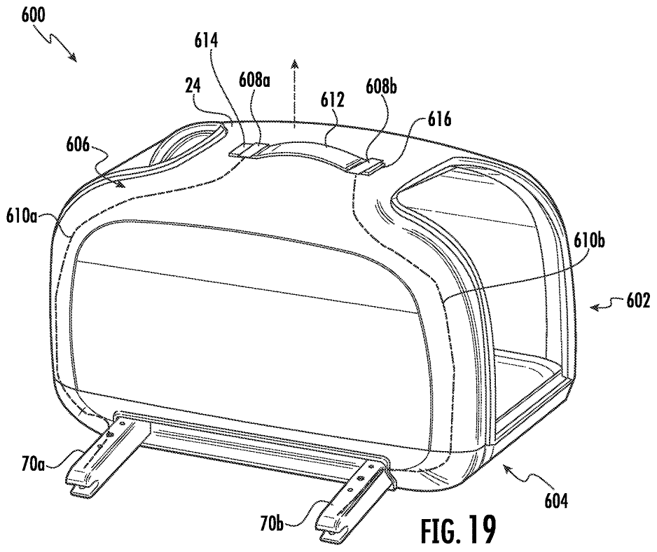

In other embodiments, as shown in FIGS. 19-22, a pet carrier as described herein may include a latch release mechanism having a release actuator arranged at a location remote from at least one of latch connector. With reference now to FIG. 19, another embodiment of a pet carrier 600 having a first section 602 and a second section 604 is illustrated. As shown, the pet carrier 600 may also have a latch release mechanism 606 including a remote release actuator and at least one linkage or transmitter 610 operably coupling the release actuator to at least one latch connector 70a, 70b. In the illustrated, non-limiting embodiment, each transmitter 610 is operatively connected to a separate actuator. A first transmitter 610a forms a linkage between and operably couples the first latch connector 70a to the first release actuator 608a and a second transmitter 610b forms a linkage between and operably couples a second latch connector 70b to the second release actuator 608b.

In response to operation of a release actuator 608a, 608b, a force may be transmitted to a latch connector 70a, 70b via a transmitter 610a or 610b, respectively, causing the latch connector 70a, 70b to open for disengagement from a vehicle anchor.

Although the at least one transmitter 610 is described as providing a mechanical connection, in other embodiments, a transmitter 610 may provide an electrical connection to the latch connectors. For example, a transmitter 610 may be one or more wires configured for transmitting electric or electronic signals to a supplemental actuator (not shown) within a LATCH connector to release the latch connector. In alternative embodiments, a transmitter 610 may represent wireless signals between a release actuator 608 and a supplemental actuator (not shown) for the latch connectors 70a, 70b.

The release actuator 608a, 608b may be arranged at the first or upper section 602 of the pet carrier 600. As shown, a handle 612 may be attached at opposite ends 614, 616 thereof to the top 24 of the pet carrier 600. In an embodiment, the first release actuator 608a is arranged adjacent to a first end 614 of the handle 612 and a second release actuator 608b is arranged adjacent to a second end 616 of the handle 612. Embodiments where a release actuator 608 is integrated into or is associated with the handle 612 may provide for automatic release of at least one of the plurality of latch connectors 70a, 70b in response to a user pulling the handle 612 in an upward direction, away from the top 24. Application of a force near an end 614, 616 of the handle 612 may operate an individual latch connector 70a, 70b. Alternatively, or in addition, application of a force to a central portion of the handle 612 may operate both the first and second latch connectors 70a, 70b simultaneously.

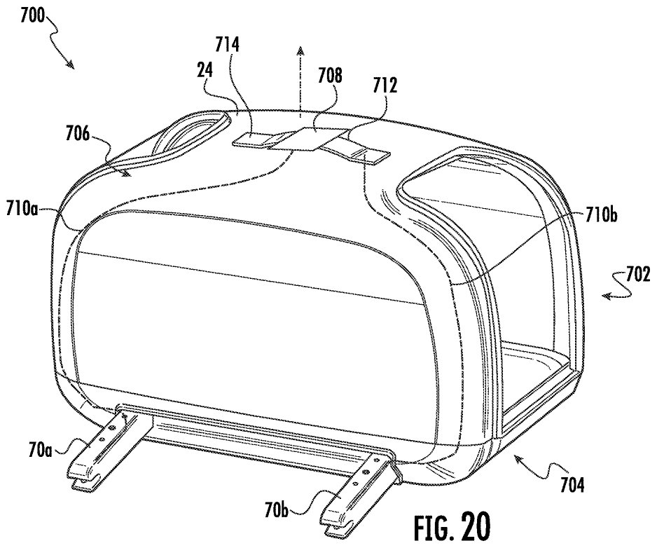

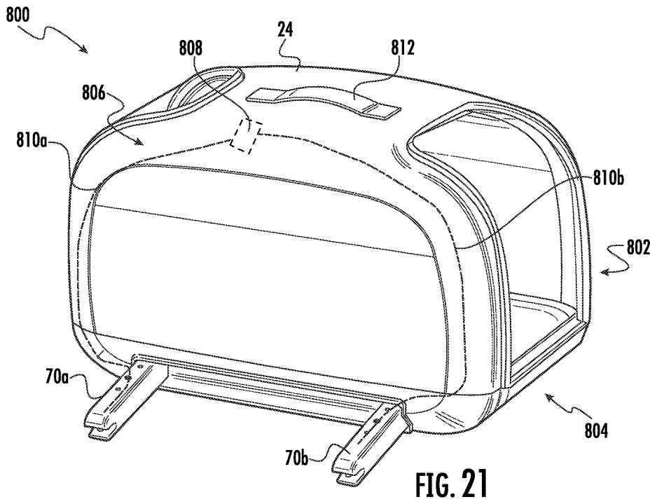

In the non-limiting embodiment of FIG. 20, a pet carrier 700 similar to that of FIG. 19 is illustrated. As shown, the pet carrier 700 includes a latch release mechanism 706 including a linkage or transmitter 710a, 710b extending from each latch connector 70a, 70b, respectively. In the illustrated, non-limiting embodiment, the plurality of latch connectors 70a, 70b are operatively connected to the same release actuator 708 via the transmitters 710a, 710b. In the illustrated, non-limiting embodiment, the release actuator 708 associated with a plurality of latch connectors 70a, 70b is located at the handle 712. However, in other embodiments, such as shown in FIG. 21, a release actuator 808 may be located at another position about the pet carrier 800, such as at either a first section 802 or a second section 804. As described in the previous embodiment, the pet carrier 800 includes a latch release mechanism 806 having a remote release actuator 808 operably coupled to at least one latch connector 70a, 70b. A respective transmitter 810a, 810b extends between and operably couples each latch connector 70a, 70b to the same release actuator 808. As shown, the release actuator 808 is not arranged at a handle 812 of the pet carrier 800. In such embodiments, the latch connectors 70a, 70b are released in response to an action separate and distinct from lifting the handle 812, such as pressing a button for example.

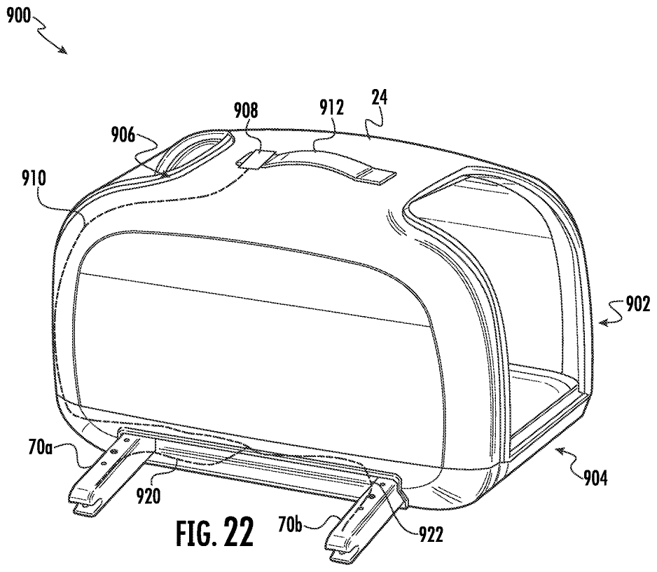

With reference to FIG. 22, another embodiment of a pet carrier 900 having a latch release mechanism 906 associated with the latch connectors 70a, 70b is illustrated. In the illustrated, non-limiting embodiment, a single linkage or transmitter 910 is used to operatively couple the plurality of latch connectors 70a, 70b to a single release actuator 908. The single actuator 908 may be located at the handle 912 or at another location about the pet carrier 900 (such as any one of the locations shown at FIGS. 19-21). As shown in FIG. 22, an end of the transmitter 910 is bifurcated into a first branch 920 and a second branch 922, the first branch 920 being connected to the first latch connector 70a and the second branch 922 being connected to the second branch connector 70b. When the release actuator 908 is operated, the force or signal is transmitted from the release actuator 908 to both branches 920, 922 of the transmitter 910.

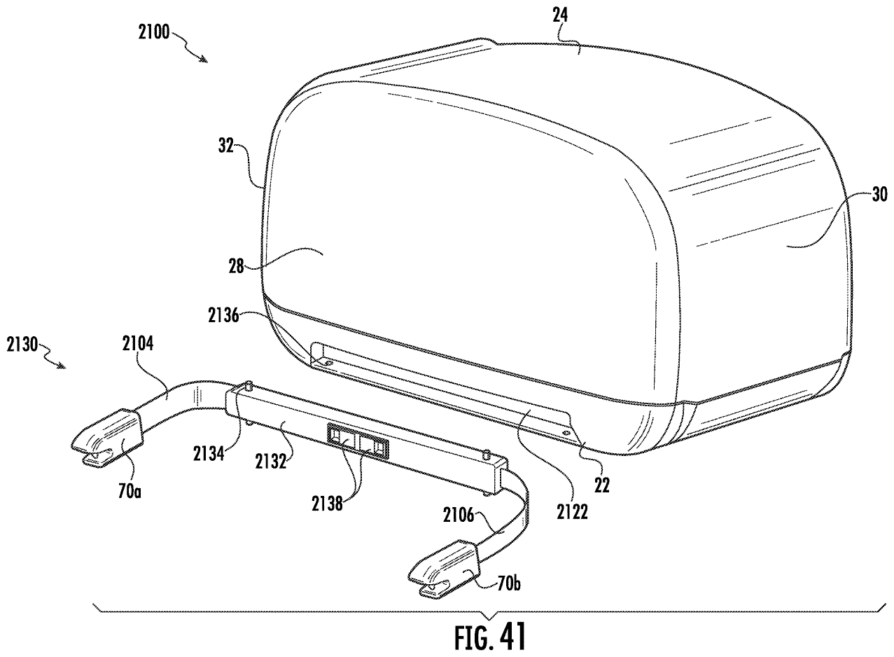

It should be appreciated that a transmitter 610, 710, 810, 910 may be hidden within (or under) the hardware of the pet carrier (e.g., within or under the frame and/or base, such that the transmitter is not visible at the exterior of the pet carrier. In an embodiment, the transmitter 610, 710, 810, 910 may be routed at least partially through the frame, such as through a top member or a hollow portion of the frame for example. Additionally, or alternatively, with reference to FIG. 41, a transmitter 610, 710, 810, 910 may be operable for the function discussed below regarding the retraction actuator 2138 being operable to selectively release the cartridge 2130 from the pet carrier 2100.

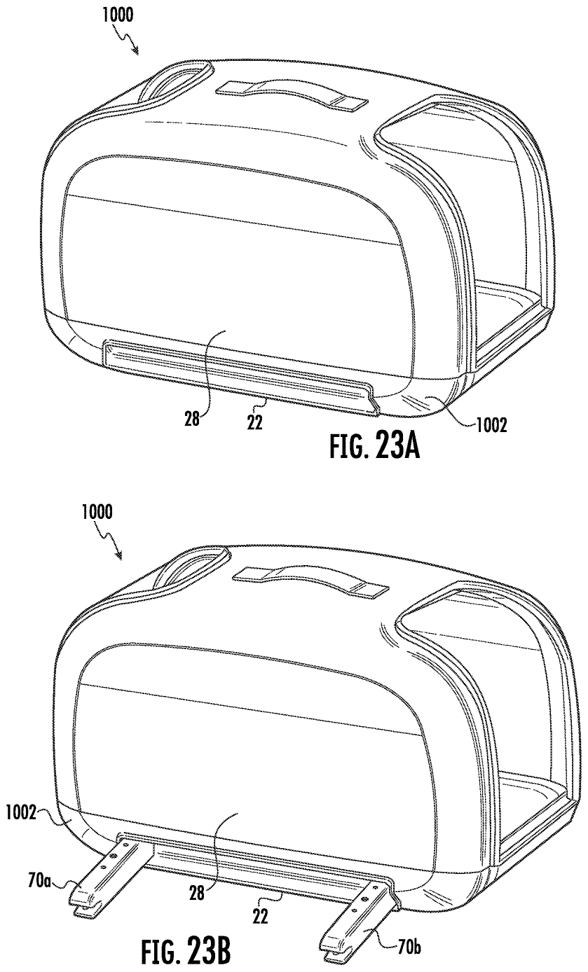

In an embodiment, the at least one latch connector 70a, 70b is a rigid latch connector movable between a first, retracted or stowed position (FIGS. 23A, 24A, 25A, 26A) in which the at least one latch connector 70a is not connectable to a vehicle anchor and a second, deployed or extended position (FIGS. 23B, 24B, 25B, 26B) in which the at least one latch connector 70a, 70b protrudes from the pet carrier for connection to a vehicle anchor. As previously noted, a rigid structural member arranged within the base may define a cavity within which the latch connectors 70a, 70b are receivable in a stowed position.

Various types of movement of the latch connectors 70a, 70b during transformation between the stowed position and the deployed position are contemplated herein. In the non-limiting embodiment of a pet carrier 1000 illustrated in FIGS. 23A and 23B, the at least one rigid latch connector 70 a, 70 b is slidable between the stowed position and the deployed positioned. For example, a first and second latch connector 70a, 70b may be associated with a base 1002 of the pet carrier 1000, such as the rear 28 thereof, and are translatable within a plane oriented generally parallel to the bottom 22 of the pet carrier 1000. As the latch connectors 70a, 70b translate between the stowed position and the deployed position, an orientation of the latch connectors 70a, 70b relative to the plurality of sides 22, 24, 26, 28, 30, 32 may remain generally constant. In the stowed position, at least a portion, and in some embodiments a substantial entirety, of the latch connectors 70a, 70b may be arranged within a cavity formed in a base 1002, such as by the structural member 412 (see FIG. 14) or may be positioned in overlapping arrangement with a surface of the base 1002. In an embodiment, the catch 1105 (see FIG. 25) of the latch connectors 70a. 70b is arranged within the cavity or is in overlapping arrangement with the base when stowed. In the deployed position, all or at least a portion of the latch connectors 70a. 70b, including the catch 1105 may extend or protrude beyond a surface of the base 1002. Movement of the latch connectors 70a, 70b between the stowed and deployed positions may be defined via a track, such as formed in a portion of the base for example.

Another embodiment of a pet carrier 1100 is illustrated in FIGS. 24A-25B. As shown, each latch connector 70a ,70b is rotatable about an axis relative to the pet carrier 1100. In the illustrated, non-limiting embodiment, the first latch connector 70a and the second latch connector 70b are rotatably mounted at the rear 28 of the pet carrier 1100, such as within a cavity 1104 formed in the base 1102 by the structural member. The latch connectors 70a,70b may be pivotable independently or in unison about respective axes. The axes may be oriented generally parallel to the rear 28 of the pet carrier 1100 for example.

Alternatively, the latch connectors 70a,70b may be configured to perform a plurality of movements when transitioning between the stowed position and the deployed position. With reference now to FIGS. 26A and 26B, another embodiment of a pet carrier 1200 is shown. In the illustrated, non-limiting embodiment, the latch connectors 70a,70b are operable to both rotate and translate relative to the pet carrier 1200. As shown, the latch connectors 70a, 70b are stowable within at least one storage recess 1204 formed in a base 1202 of the pet carrier 1200, such as the bottom of the base 1202 for example. The latch connectors 70a. 70b are illustrated as being arranged generally located adjacent to and extendable from a short side of the rectangular base, such as near the front 26 of the pet carrier 1200 and the rear 28 of the pet carrier 1200 for example. Accordingly, the first latch connector 70a may be receivable within a first storage recess 1204 and a second latch connector 70b may be receivable within a second storage recess 1204. As shown, the first storage recess is separate from the second storage recess.

The base 1202 of the pet carrier 1200 may be sized for receipt within the storage space underneath a vehicle seat, such as an airline seat for example, when the latch connectors 70a,70b are stowed. In an embodiment, when transforming to the extended position, the latch connectors 70a, 70b are configured to first translate laterally outwardly from the sides of the pet carrier 1200, beyond the envelope of the pet carrier 1200. This lateral movement, to be described in more detail below, separates the latch connectors 70a, 70b. As a result, the axial distance defined between the plurality of rigid latch connectors 70a, 70b in the deployed position is greater than the axial distance defined between the plurality of rigid latch connectors 70a, 70b in the stowed position. In some embodiments, the axial distance or spacing between the deployed latch connectors 70a, 70b is equal to the axial distance or spacing between corresponding vehicle anchors. The dimensions of a base 1202 having laterally expanded latch connectors 70a, 70b may exceed the dimensions of the storage space underneath a vehicle seat. Once laterally expanded, the latch connectors 70a, 70b may further rotate about a respective axis to the deployed position. In the illustrated, non-limiting embodiment, the axis of rotation is a horizontal axis extending generally parallel to one of the left side 30 and the right side 32 of the pet carrier 1200.

The latch connectors 70a, 70b of the example embodiments disclosed above may be considered “rigid latches” in that the latch connectors 70a, 70b are not mounted to the pet carrier 1000, 1100, 1200 by a flexible structure (e.g., a strap) and, when deployed, the latch connectors 70a, 70b extend a fixed distance from the pet carrier 1000, 1100, 1200. In this manner, when installed in a vehicle and connected to vehicle anchor points, any relative movement between the pet carrier 1000, 1100, 1200 and the vehicle seat is minimized or eliminated.

The movement of the one or more rigid latch connectors 70a, 70b, may be manually performed by an operator. Alternatively, the pet carrier may include a latch deployment mechanism operable to automatically transform the at least one latch connector 70a, 70b from a stowed position to a deployed position in response to an input from a user.

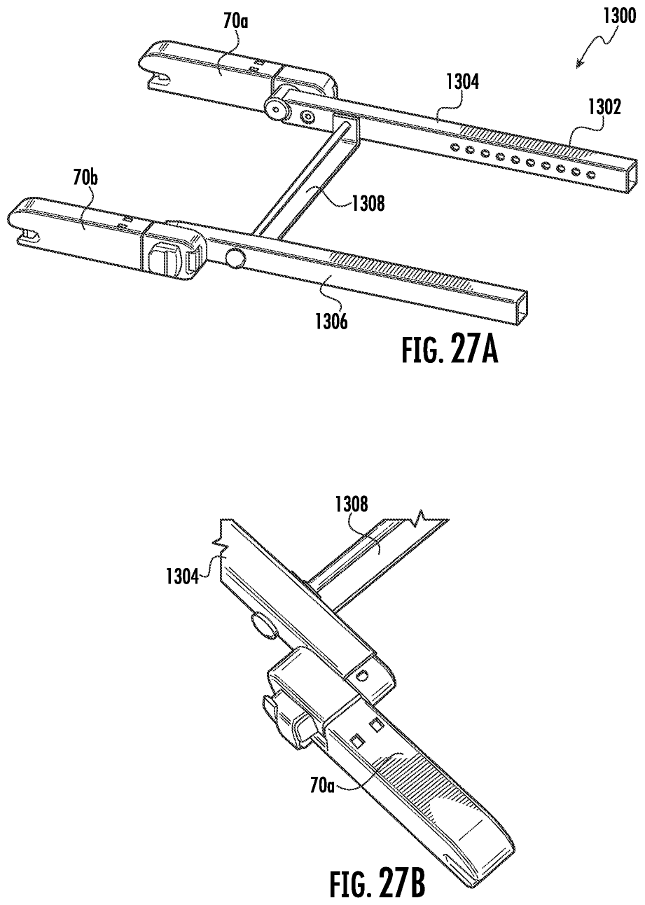

With reference to FIGS. 27A and 27B, an example of a latch deployment mechanism 1300 associated with the two-stage movement illustrated and described above with respect to FIGS. 26A and 16B is shown. The latch deployment mechanism 1300 may but need not form a portion of the structure supporting the base of the pet carrier. As shown, the latch deployment mechanism 1300 includes a frame 1302 having a first leg 1304 and a second leg 1306 connected together by a crossbar 1308. Accordingly, in an embodiment, the frame 1302 may have a generally H-shaped configuration. As shown, a latch connector 70a, 70b is secured to the first leg 1304 and the second leg 1306 of the frame 1302, respectively, such as at or near an end thereof. Although the first and second latch connectors 70a, 70b are illustrated as being positioned at an outwardly facing surface of the legs 1304, 1306 of the frame 1302, it should be appreciated that in other embodiments, the latch connectors 70a, 70b may be positioned at an inwardly facing surface of the legs 1304, 1306. In the illustrated, non-limiting embodiment, the latch connectors 70a, 70b are pivotally connected to the legs 1304, 1306. At least one biasing mechanism (not shown), such as a torsion spring for example, may be operably coupled to the latch connectors 70a, 70b to bias each of the latch connectors 70a, 70b to the deployed position.

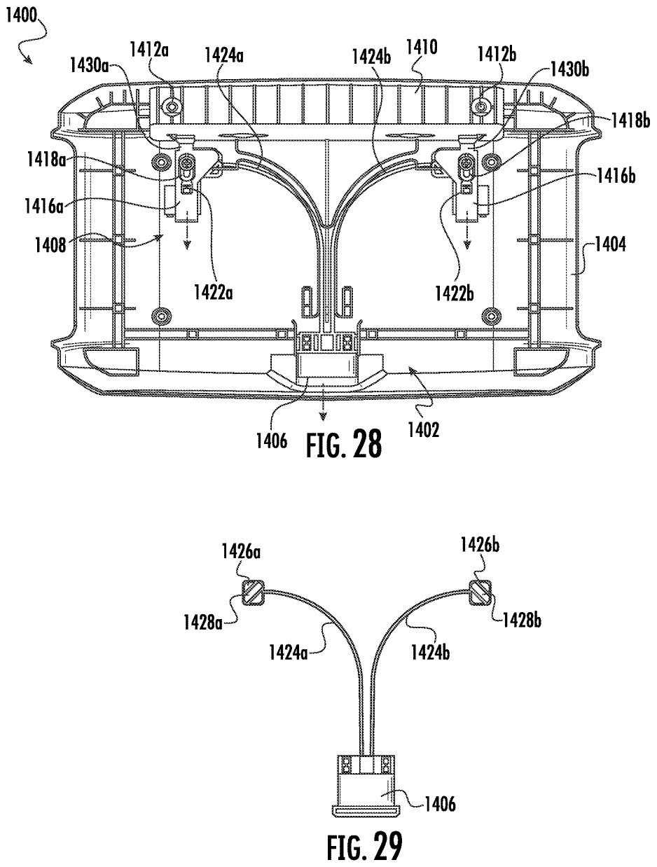

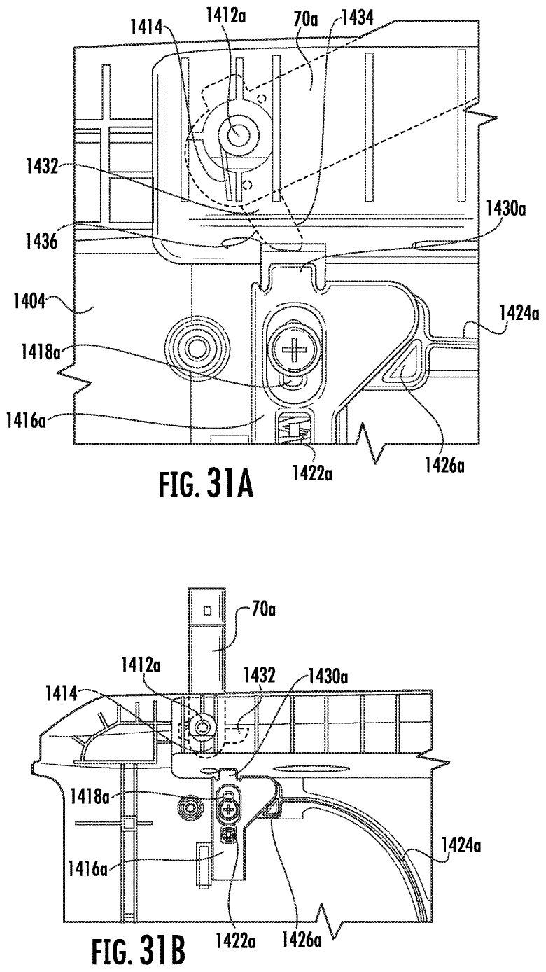

With reference to FIG. 28-32, another example of a latch deployment mechanism 1402 operable to automatically move the at least one latch connector 70a, 70b from the stowed position to the extended position relative to a pet carrier 1400 is illustrated. As shown, the latch deployment mechanism 1402 may be embedded within a portion of a base 1404 of the pet carrier 1400, such as between the upper and lower trays for example. The latch deployment mechanism 1402 includes a deployment actuator 1406 and a deployment assembly 1408 operatively coupled to the at least one latch connector 70a, 70b and to the deployment actuator 1406. Configuration of the deployment assembly 1408 may depend on the type of movement desired of the latch connectors 70a, 70b between the stowed and extended positions. In the illustrated, non-limiting embodiment of FIGS. 28-32, the latch connectors 70a, 70b are rotatable outwardly, away from each other toward the extended position, and are rotatable inwardly into an interior of the pet carrier 1400 when the latch connectors 70a, 70b are in the stowed position, similar to described above with respect to FIGS. 24A-25B. In an embodiment, the latch connectors are rotatable into the interior of a structural member 1410 arranged within the base 1404 and may be coaxial when in the stowed position. Each of the latch connectors 70a, 70b is rotatably mounted to the base 1404 of the pet carrier 1400 via a pin 1412a, 1412b. A biasing mechanism 1414 (see also FIGS. 25A & 25B), such as a torsion spring for example, may be operably coupled to a respective latch connector 70a, 70b. In an embodiment, the biasing force of the biasing mechanism 1414 is operable to bias the latch connector 70a, 70b to the extended position.

In the illustrated, non-limiting embodiment, the deployment assembly 1408 includes a first latch lock slider 1416a and a second latch lock slider. The first latch lock slider 1416a is movably mounted, such as via along a first track 1418a defined by a slotted engagement, generally adjacent to the first latch connector 70a and the second latch lock slider 1416b is movably mounted, such as along a second track 1418b defined by a slotted engagement, generally adjacent to a second latch connector 70b. Each of the first latch lock slider 1416a and the second latch lock slider 1416b is translatable along an axis defined by the first track 1418a and the second track 1418b, respectively. In some embodiments, one or more of the upper and lower trays of the base having features, such as ribs of guides formed therein to define the track along which the latch lock sliders are movable. A movable portion 1420a, 1420b, such as a pin or post for example, protrudes from a surface of each of the first and second latch lock sliders 1416a, 1416b. In an embodiment, a respective latch biasing mechanism 1422a, 1422b, such as a coil spring for example, is associated with each latch lock slider 1416a, 1416b. The latch biasing force of the latch biasing mechanism 1422a, 1422b biases a corresponding latch lock slider 1416a, 1416b towards the first and second latch connectors 70a, 70b.

A first linkage or tension member 1424a operably couples the deployment actuator 1406 to the first latch connector 70a via the first latch lock slider 1416a and a second linkage 1424ab operably couples the deployment actuator 1406 to the second latch connector 70b via the second latch lock slider 1416b. Although both linkages 1424a, 1424b are illustrated as being connected to the same deployment actuator 1406, in other embodiments, each linkage 1424a, 1424b may be operably coupled to a separate deployment actuator. In an embodiment, the first linkage 1424a includes a first engagement member 1426a and the second linkage 1424b includes a second engagement member 1426b. In the illustrated, non-limiting embodiment, the first engagement member 1426a and the second engagement member 1426b are translatable in response to operation of the deployment actuator 1406. The first engagement member 1426a and the first latch lock slider 1416a and the second engagement member 1426b and the second latch lock slider 1416b are connected such that movement of the engagement members 1426a, 1426b in a first direction results in movement of the latch lock sliders 1416a, 1416b in a second direction. In an embodiment each of the first and second engagement members 1426a, 1426b includes a slot 1428a, 1428b and the movable portion 1420a, 1420b extending from the latch lock sliders 1416a, 1416b is receivable within a corresponding slot 1428a, 1428b. Each slot 1428a, 1428b may be oriented at a non-parallel angle to the axis of the track 1418a, 1418b of a respective first latch lock slider 1416a and second latch lock slider 1416b.

In an embodiment, each latch lock slider 1416a, 1416b includes an extended arm 1430a, 1430b that selectively cooperates with a portion of the adjacent latch connector 70a, 70b. The extended arm 1430a, 1430b may be arranged coaxially with the axis of the track 1418a, 1418b of the latch lock slider 1416a, 1416b. In an embodiment, a lock feature 1432 protrudes at an angle from each latch connector 70a, 70b. When the latch connector 70a, 70b is in the stowed position, the lock feature 1432 is arranged in contact with the extended arm 1430a, 1430b. The engagement between the lock feature 1432, such as a first surface 1434 thereof, and the extended arm 430a, 1430b opposes the bias of the biasing mechanism 1414 to restrict rotation of the latch connector 70a, 70b about its respective axis.

To deploy the latch connectors 70a, 70b, a user operates the deployment actuator 1406. This operation transmits a force to the first and second linkages 1424a, 1424b causing the first and second engagement members 1426a, 1426b to move, for example translate inwardly. Because of the orientation of the slot 1428a, 1428b, the movement of the engagement members 1426a, 1426b causes the latch lock sliders 1416a, 1416b to move within their respective tracks 1418a, 1418b, away from the latch connectors 70a, 70b such that the extended arm 1430a, 1430b is no longer within the path of rotation of the lock feature 1432. Accordingly, the biasing force of the biasing mechanisms 1414 will bias the latch connectors 70a, 70b about their axes to the deployed position. Once the force is removed from the deployment actuator 1406, the first and second latch lock sliders 1416a, 1416b are biased back to their original position.

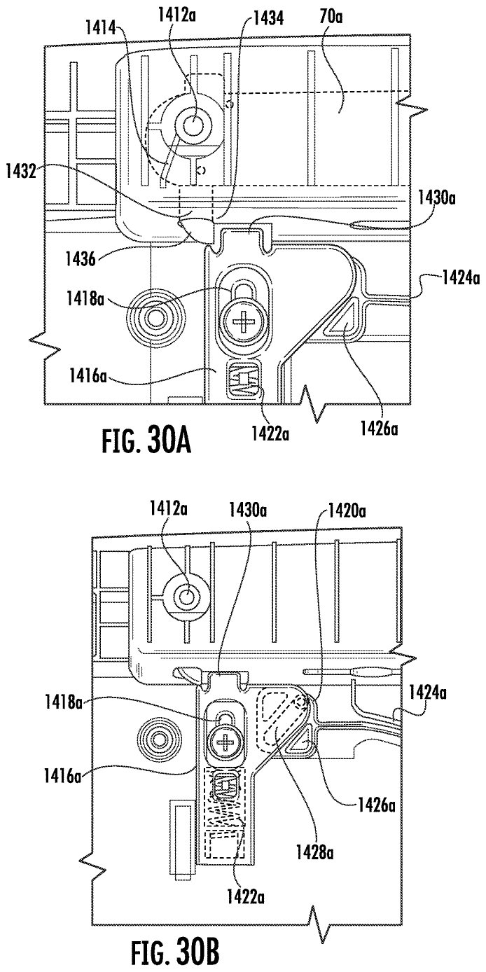

The latch connectors 70a, 70b may be manually transformable from the deployed position to the stowed position. In an embodiment, a surface 1436 (FIG. 30A) of the lock feature 1432 is sloped or curved. As the latch connector 70a, 70b rotates inwardly, the surface 1436 of the lock feature 1432 approaches and engages the extended arm 1430a, 1430b of the latch lock slider 1416a, 1416b. The engagement between the extended arm 1430a, 1430b and the surface 1436 opposes the biasing force of the latch biasing mechanism 1422a, 1422b, causing the latch lock slider 1416a, 1416b to translate within its track 1418a, 1418b. The latch lock slider 1416a, 1416b is retained in this retracted position until the lock feature 1432 moves out of engagement with the extended arm 1430a, 1430b. Once separated, the biasing force of the latch biasing mechanism 1422a, 1422b will bias the latch lock slider 1416a, 1416b towards the latch connector 70a, 70b and the biasing force of the biasing mechanism 1414 will bias the first surface 1434 of the lock feature 1432 into engagement with the extended arm 1430a, 1430b.

Although the latch lock sliders 1416a, 1416b are illustrated and described herein as being translatable relative to the latch connectors 70a, 70b, embodiments where the latch lock sliders 1416a, 1416b are movable in another manner, for example rotatable, are also contemplated herein. Further, although the deployment assembly 1408 is illustrated and described with respect to simultaneous operation of a first and second latch connector 70a, 70b, it should be appreciated that the deployment assembly 1408 may be adapted for use with a single latch connector 70a, 70b, or alternatively, more than two latch connectors.

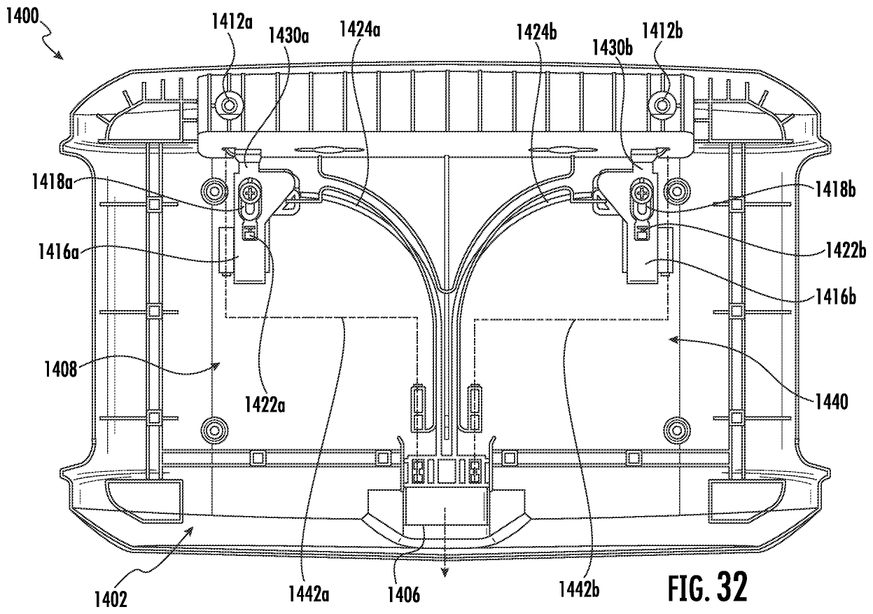

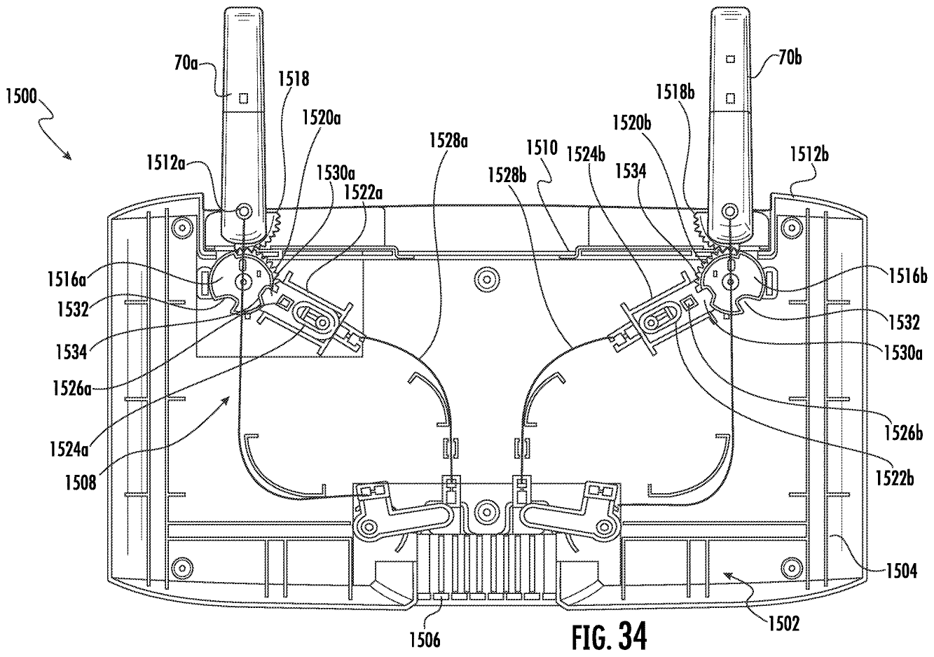

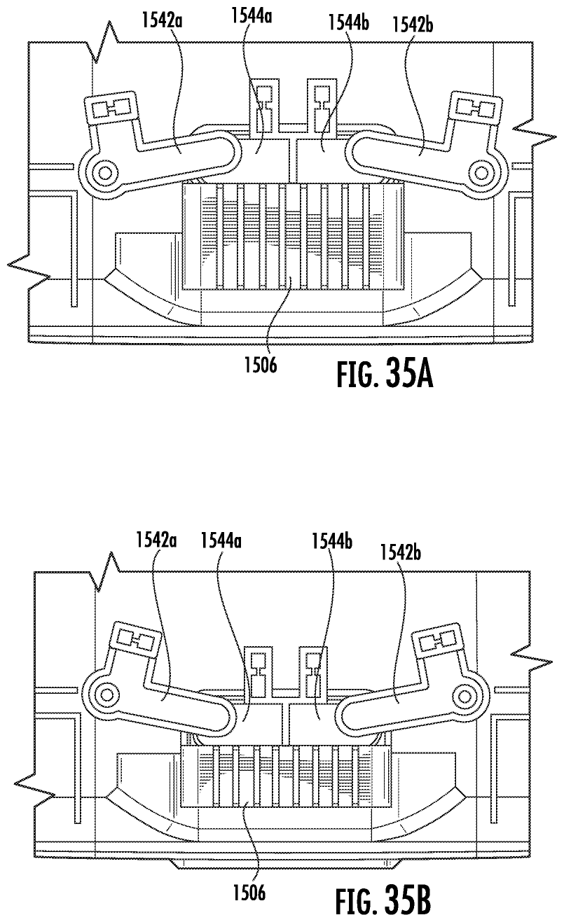

With reference now to FIGS. 32-35, another example of a latch deployment mechanism 1502 having a deployment assembly 1508 operably coupling a deployment actuator 1506 and at least one latch connector 70a, 70b is illustrated. Similar to the previous embodiment, the latch connectors 70a, 70b are rotatable outwardly, away from each other toward the extended position, and are rotatable inwardly into the interior of the base 1504 of the pet carrier 1500, such as into the interior of a structural channel 1510 for example, when the latch connectors 70a, 70b are in the stowed position.

In the illustrated, non-limiting embodiment, the deployment assembly 1508 includes a first rotatable gear 1516a associated with the first latch connector 70a and a second rotatable gear 1516b associated with the second latch connector 70b. As shown, the first latch connector 70a and the second latch connector 70b may each have a plurality of latch teeth 1518 arranged at a portion thereof, such as near the pivot axis of the latch connectors 70a, 70b for example. The latch teeth 1518 may be formed directly in the latch connector 70a, 70b, or may be formed by another component connected to the latch connector 70a, 70b. At least some of the latch teeth 1518 of the first latch connector 70a are intermeshed with a plurality of teeth 1520a of the first gear 1516a. Similarly, at least some of the latch teeth 1518 of the second latch connector 70b are intermeshed with a plurality of teeth 1520b of the second gear 1516b. It should be appreciated that in some embodiments, a respective gear biasing mechanism 1521a, 1521b may be operably coupled to each gear 1516a, 1516b in place of or in addition to the biasing mechanisms operably coupled to each latch connector 70a, 70b. In such embodiments, the biasing force of the biasing mechanism is operable to bias the first gear 1516a and the second gear 1516b to rotate in a direction resulting in deployment of the latch connectors 70a, 70b.

The deployment assembly 1508 additionally includes a first latch lock slider 1522a and a second latch lock slider 1522b. The first latch lock slider 1522a is movably mounted within a first track 1524a generally adjacent to the first gear 1516a and the second latch lock slider 1522b is movably mounted within a second track 1524b generally adjacent to the second gear 1516b. Each of the first latch lock slider 1522a and the second latch lock slider 1522b may be translatable along an axis defined by the first track 1524a and the second trac 1524b, respectively. In an embodiment, a respective latch biasing mechanism 1526a, 1526b, such as a coil spring for example, is associated with each latch lock slider 1522a, 1522b. The latch biasing force of the latch biasing mechanism 1526a, 1526b biases a corresponding latch lock slider 1522a, 1522b towards the first latch connector 70a and the second latch connectors 70b.

A first linkage or tension member 1528a operably couples the deployment actuator 1506 to the first latch lock slider 1522a and a second linkage 1528b operably couples the deployment actuator 1506 to the second latch lock slider 1522b. Although both linkages 1528a, 1528b are illustrated as being connected to the same deployment actuator 1506, in other embodiments, each linkage 1528a, 1528b may be operably coupled to a separate deployment actuator.

In an embodiment, each latch lock slider 1522a, 1522b includes an extended arm 1530a, 1530b that selectively cooperates with a portion of the adjacent gear 1516a, 1516b. As shown, each gear 1516a, 1516b may have a first recess 1532 and a second recess 1534 formed therein, the first recess 1532 and the second recess 1534 being spaced about the periphery of the gear 1516a, 1516b. The contour of the first recess 1532 and the second recess 1534 may be generally complementary to, and in some embodiments may be identical to, the contour of the extended arm 1530a, 1530b. Engagement between the extended arm 1530a, 1530b and a respective recess 1532a, 1532b restricts rotation of a gear 1516a, 1516b about its axis, and therefore retains the latch connector 70a, 70b is its current position.

In the illustrated, non-limiting embodiment, when the latch connectors 70a, 70b are in the stowed position, the extended arm 1530a, 1503b of the first latch lock slider 1522a is received within the first recess 1532 of the first gear 1516a and the extended arm 1530b of the second latch lock slider 1522b is received within the first recess 1532 of the second gear 1516b. To deploy the latch connectors 70a, 70b, a user operates the deployment actuator 1506. This operation transmits a force to the first and second linkages 1528a, 1528b causing the first and second latch lock sliders 1522a, 1522b to move within their respective tracks 1524a, 1524b. This movement of the latch lock sliders 1522a, 1522b separates the extended arm 1530a, 1530b from the first recess 1532. Accordingly, the biasing force of the biasing mechanisms of the gears 1516a, 1516b will cause the gears 1516a, 1516b, and the latch connectors 70a, 70b intermeshed therewith, to rotate about their respective axes. When the latch connectors 70a, 70b are in the extended position, and the force is released form the deployment actuator 1506, the biasing force acting on the latch lock sliders 1522a, 1522b will bias the extended arm 1530a, 1530b into the second recesses 1534 of the first and second gear 1516a, 1516b, respectively.

The latch connectors 70a, 70b may be manually transformable from the deployed position to the stowed position. Similar to the process for deploying the latch connectors 70a, 70b, a user may apply a force to the deployment actuator 1506 causing the extended arms 1530a, 1530b to separate from the first and second gear 1516a, 1516b. With the extended arms 1530a, 1530b disengaged, the first and second latch connectors 70a, 70b are freely rotatable to the stowed position. Once in the stowed position, the force is removed from the deployment actuator 1506 causing the extended arms 1530a, 1530b to bias into engagement with the first recess 1532 of the first and second gears 1516a, 1516b, respectively. In other embodiments, the extended arm 1530a, 1530b includes a ramped surface 1536 that cooperates with the second recess 1534 to allow a user to rotate the latch connectors 70a, 70b to the stowed position without operating the deployment actuator 1506.

It should be understood that the deployment assemblies 1408, 1508 of the latch deployment mechanisms 1402, 1502 illustrated and described herein are intended as an example only, and that a deployment assembly having any suitable configuration to allow a desired movement of a latch connector 70a, 70b between a stowed position and a deployed position in response to operation of a deployment actuator 1406, 1506 is contemplated herein.

The deployment actuator 1406, 1506 may be located at any suitable position about the pet carrier 1400, 1500. For example, the deployment actuator 1406, 1506 may be located at a handle of the pet carrier, such as handle 612, 712, 812, 912, intended for carrying the pet carrier. However, in other embodiments, the deployment actuator 1406, 1506 may be arranged at a secondary handle 72 (see FIG. 1) of the pet carrier. In the illustrated, non-limiting embodiment, the secondary handle 72 is mounted to the base 60, such as at or near the front 26 of the pet carrier 20 for example.

The release actuator 608, 708, 808, 908 and the deployment actuator 1406, 1506 as described herein may be separate actuators. However, in some embodiments, a single actuator may be operable as both the release actuator and the deployment actuator. In such embodiments, operation of the actuator may cause the latch connectors 70a, 70b to both deploy and release or unlock simultaneously. However, embodiments where different operations of the same actuator are required to perform the deployment and the release of the latch connectors 70a, 70b are also contemplated herein. In such embodiments, application of a first force to the actuator in a first direction may perform either the release operation of the deployment operation, and application of a second force to the actuator in the first direction, or alternatively, in a second opposite direction, may perform the other of the release operation of the deployment operation. Further, it should be understood that in any of the embodiments of an actuator described herein, the actuator may include a force multiplier.

With reference to FIG. 32, an example of a release assembly 1440 and a deployment assembly 1408 operably coupled to the same actuator 1406 is illustrated. In the illustrated, non-limiting embodiment, the release assembly 1440 includes a first release linkage or cable 1442a operably coupled to the first latch connector 70a and a second release linkage or cable 1442b operably coupled to the second latch connector 70b. Operation of the actuator 1406, such as by applying a pulling force thereto, transmits a force to the first and second linkages 1442a, 1442, thereby causing the latch connectors 70a, 70b to open or unlock.

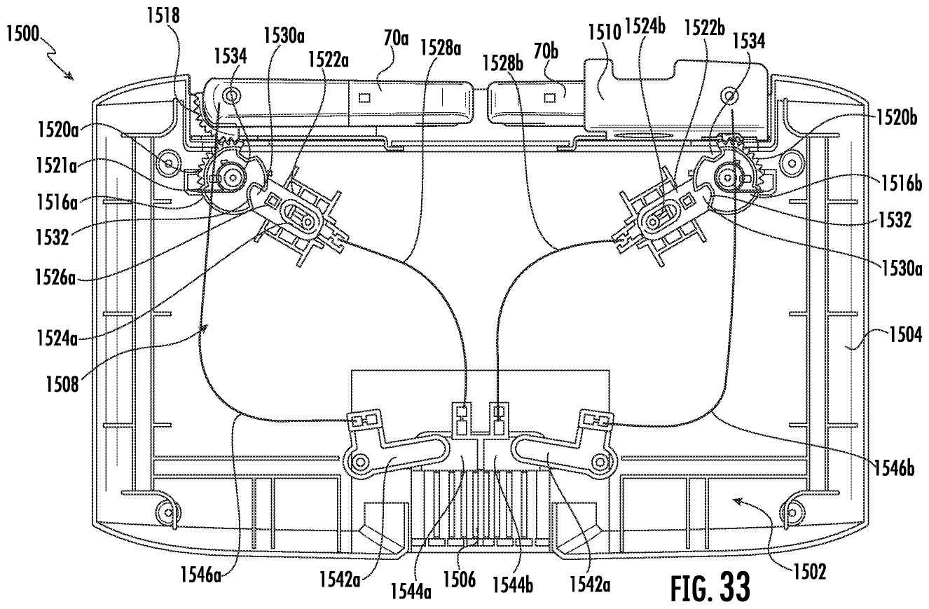

Another example of a release assembly 1540 and a deployment assembly 1508 operably coupled to the same actuator 1506 is illustrated in FIG. 33-35B. As shown, the release assembly 1540 includes a first cable pull 1542a and a second cable pull 1542b, each being pivotally mounted about a respective axis. A movable portion, such as a pin or post (not shown) for example, protrudes from a surface of each of the first and second cable pulls 1542a, 1542b. In the illustrated, non-limiting embodiment, the movable portions are received within a corresponding slot or opening 1544a, 1544b of the actuator 1506. As shown, a first release linkage or cable 1546a operably couples the first cable pull 1542a to the first latch connector 70a and a second release linkage or cable 1546b operably couples the second cable pull 1542b to the second latch connector 70b. Operation of the actuator 1506, such as by applying a pulling force thereto, causes the first and second cable pulls 1542a, 1542b to pivot about their axes. This rotation of the cable pulls 1542a, 1542b transmits the force to the first release linkage 1546a and the second release linkage 1546b to release the catch of the latch connectors 70a, 70b.

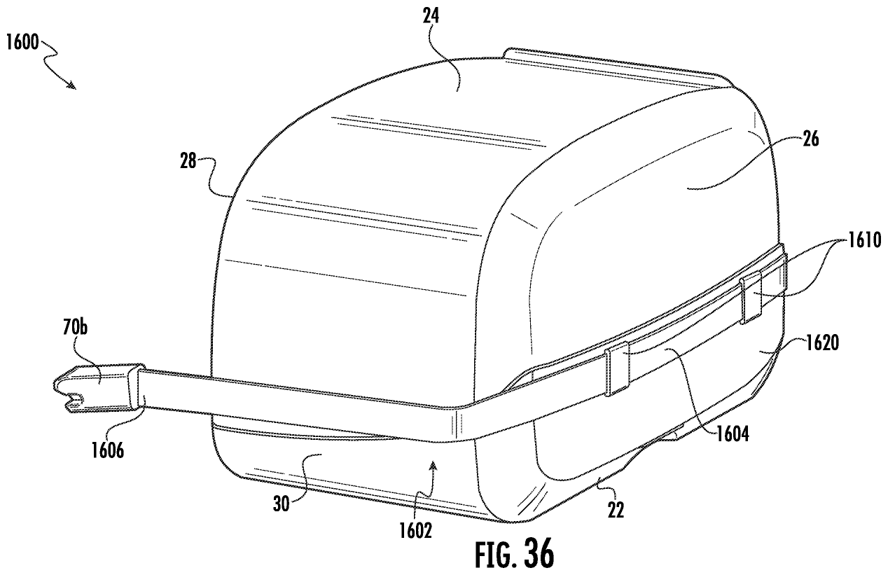

In other embodiments, such as shown in FIGS. 36-43 the latch connectors 70a, 70b of the pet carrier may be “soft” latch connectors. In such embodiments, the at least one latch connector 70a, 70b is mounted to the pet carrier using a flexible structure, such as one or more straps or pieces of webbing for example. Soft latch connectors may be substantially similar devices to rigid latch connectors discussed above, and in some embodiments may include a release actuator (not shown) located at each connector. However, in other embodiments, the latch connectors may be various other types of clips and hooks, such as a carabiner or other clip biased toward a closed position and manually openable for attachment to vehicle anchors.

With reference to FIG. 36, a pet carrier 1600 having at least one soft latch connector is illustrated. As shown, the pet carrier has a plurality of soft latch connectors 70a 70b, is illustrated. In the illustrated, non-limiting embodiment, the webbing 1602 used to mount the plurality of latch connectors 70a, 70b to the pet carrier 1600 includes a single strap 1604. However, embodiments where the webbing 1602 may include a plurality of straps connected to one another to form a single, continuous strap are also contemplated herein. A first latch connector, such as latch connector 70a for example may be mounted to a first end (not shown) of the strap 1604 and a second latch connector 70b may be mounted to a second, opposite end 1606 of the strap 1604. In some embodiments, such as shown in FIG. 36, the webbing 1602 may be removably connectable to the pet carrier 1600. In the illustrated, non-limiting embodiment, the webbing 1602 may be extendable through one or more loops or openings 1610 arranged at a surface of the pet carrier 1600 to couple the webbing to the pet carrier 1600.

The webbing 1602 may be connected to the pet carrier 1600 via one or more anchor points. As used herein, the term “anchor point” is intended to define a location where the webbing, such as webbing 1602 for example, is mechanically or chemically connected to the pet carrier. The total number of anchor points and their respective locations may be dependent on the configuration of the webbing and its positioning about the pet carrier. With continued reference to FIG. 36, the single strap 1604 is affixed to the pet carrier 1600 via one or more anchor points located at a central or intermediate area of the strap 1604, such as spaced from the ends thereof. In some embodiments, the single strap 1604 is connected to the pet carrier 1600 via a plurality of anchor points. In an embodiment, each of the loops or openings 1610 that couples the webbing 1602 to the pet carrier 1600 may be considered an anchor point. In the illustrated, non-limiting embodiment, the strap 1604 is configured to wrap about the front 26, left side 30, and right side 32 of the pet carrier 1600, and a plurality of anchor points of the strap 1604 are formed at the front 26 of the pet carrier 1600. However, embodiments where at least one anchor point is alternatively or additionally arranged at another side of the pet carrier 1600, such as the left side 30 and/or the right side 32 are also contemplated herein. In other embodiments, at least a portion of the strap 1604 may be positioned in contact with the rear 28 of the pet carrier 1600 such that one or more anchor points may be formed at the rear 28 of the pet carrier 1600.

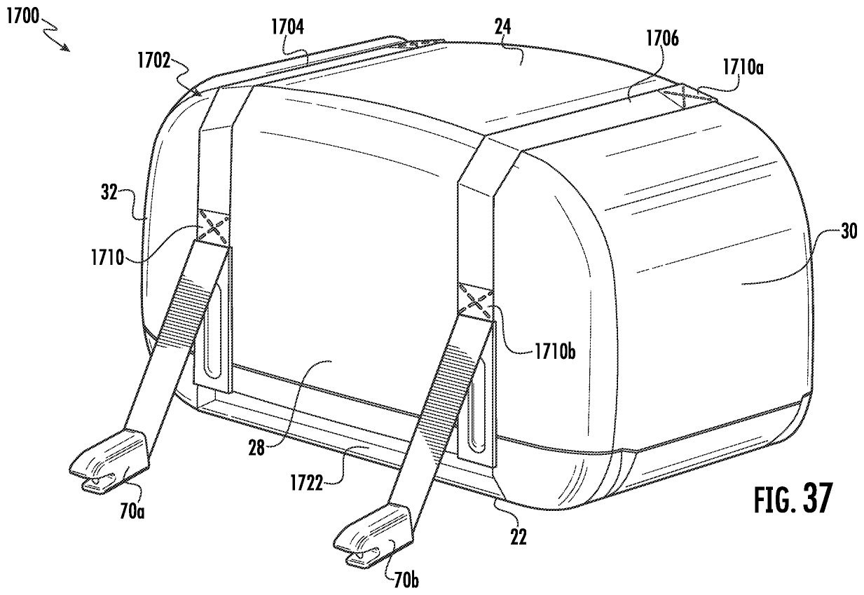

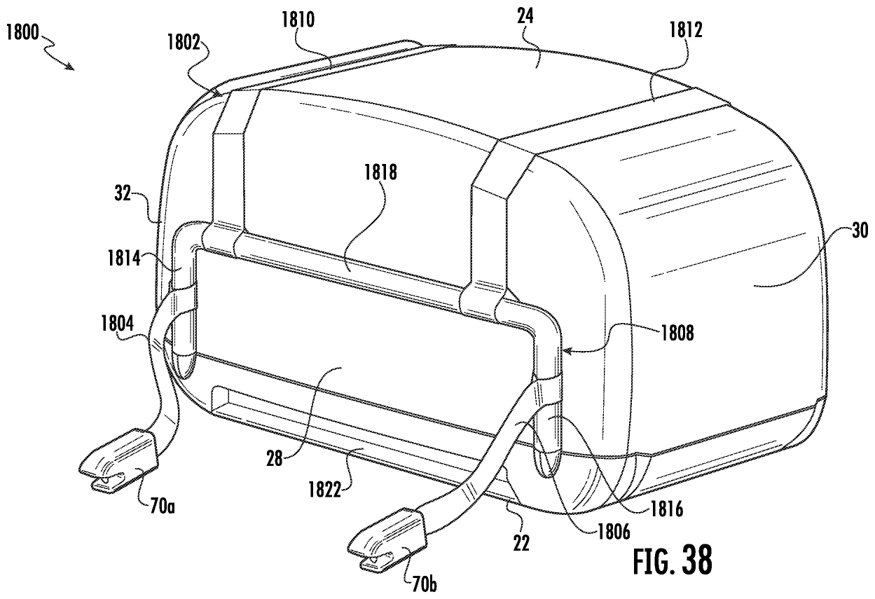

In other embodiments, the webbing may be permanently attached to the pet carrier. With reference to FIG. 37, each latch connector 70a, 70b may be connected to the pet carrier 1700 via a respective strap. In the illustrated, non-limiting embodiment of FIG. 37, the webbing 1702 for mounting the latch connectors 70a, 70b to the pet carrier 1700 includes a first strap 1704 and a second strap 1706 spaced apart from one another. The spacing between the first strap 1704 and the second strap 1706 may but need not be equal to the spacing between adjacent vehicle anchors. A first latch connector 70a may be connected to a portion of the first strap 1704 and a second latch connector 70b may be connected to a portion of the second strap 1706. In an embodiment, the first strap 1704 and the second strap 1706 may be reinforcement members of a reinforcement assembly as described above. In such embodiments, the first and second straps 1704, 1706 may encircle the pet carrier 1700. However, embodiments where the first and second straps 1704, 1706 do not completely encircle the pet carrier 1700 are also contemplated herein. In certain embodiments, the first and second straps 1704, 1706 span the first section 40 of the pet carrier (wraps about the front 26, top 24, and back 28) and have ends that are anchored to the base 22.

The webbing 1702 may be permanently connected to the pet carrier 1700 at one or more locations. These locations may also be considered anchor points, identified generally at 1710. In such embodiments, the webbing 1702 may be chemically bonded, such as via an adhesive for example, or may be mechanically attached, such as via stitching for example, to a corresponding surface of the pet carrier 1700 at each anchor point. In the non-limiting embodiments of FIG. 37, the first strap 1704 and the second strap 1706 of the webbing 1702 are affixed to the pet carrier 1700 via at least one anchor point, and in some embodiments via a plurality of anchor points spaced over the length of the straps 1704, 1706. In embodiments having a single anchor point, the strap 1704, 1706 may completely encircle the pet carrier 1700 such that both ends of the strap 1704, 1706 are connected to the pet carrier 1700 at the anchor point. Strap 1704 is illustrated as having a single anchor point 1710 for illustrative purposes only. However, a strap 1704, 1706 that completely encircles the pet carrier 1700 may also be attached thereto via a plurality of anchor points. Such anchor points may be located in the soft goods of the first section, at the base 22, or both.

In embodiments where the straps 1704, 1706 do not extend about the entire periphery of the pet carrier 1700, such as where the straps 1704, 1706 extend about the top 24 and the rear 28 of the pet carrier 1700 for example, each strap 1704, 1706 may be attached to the pet carrier 1700 via a plurality of anchor points. Strap 1706 is illustrated as extending about only a portion of the pet carrier 1700 for illustrative purposes only. For example, a first anchor point 1710a may be located at or near a first end of the strap 1706. However, embodiments where the first anchor point 1710a is arranged at another location about the strap 1706 is also contemplated herein. In an embodiment, a secondary anchor point 1710b is located at an intermediate area portion of the strap 1706, such as at a location between the first anchor point 1710a and the end of the strap 1706 connected to a latch connector, such as latch connector 70b for example.

In other embodiments, the webbing may include a plurality of straps that are indirectly connected via an intermediate component. With reference to FIG. 38, a webbing 1802 of another pet carrier 1800 is illustrated in more detail. As shown, the webbing 1802 includes a first strap 1804 and a second strap 1806 having a first end connected to a first latch connector 70a and a second latch connector 70b, respectively, and a second end connected to an intermediate component 1808, such as a frame element for example. The webbing 1802 may further include at least one mounting strap for mounting the intermediate component 1808 to the pet carrier 1800. In the illustrated, non-limiting embodiment, the webbing 1802 includes a first mounting strap 1810 and a second mounting strap 1812, each having a first end connected to the intermediate component 1808. A portion of each mounting strap 1810, 1812, such as a second end thereof, is connected to the pet carrier 1800 via one or more anchor points. As shown, the intermediate component 1808 may be formed from a tubular structure or frame. In the illustrated, non-limiting embodiment, the intermediate component 1808 has a first leg 1814, a second leg 1816, and a connecting member 1818 such that the intermediate component 1808 has a generally U-shaped configuration, with the connecting member 1818 being positioned further from the bottom 22 of the pet carrier 1800 than the legs 1814, 1816. The first strap 1804 may be connected to the first leg 1814, the second strap 1806 may be connected to the second leg 1816, and the at least one mounting strap 1810, 1812 may be connected to the connecting member 1818. As shown, the ends of each of the straps 1804, 1806, 1810, 1812 associated with the intermediate component 1808 may have a loop or opening formed therein and the intermediate component 1808 is receivable within the loop. In embodiments where the loops may be permanently formed in the straps 1804, 1806, 1810, 1812, or alternatively, may be removable therefrom, such as via Velcro™ or a hook and loop fastening for example.

In an embodiment, the intermediate component 1808 is separable from the webbing 1802 and the pet carrier 1800. For example, the straps 1804, 1806, 1810, 1812 may be configured to allow movement of the intermediate component 1808 to selectively couple and decouple the intermediate component thereto. In other embodiments, the intermediate component 1808 may be permanently attached to the pet carrier 1800 via the webbing 1802. For instance, each of the straps may include an anchor point directly adjacent to the interface with the intermediate component 1808, thereby limiting movement of the intermediate component 1808 when connected to the straps 1804, 1806, 1810, 1812.

The soft latch connectors 70a, 70b may be mounted to a stiffening member associated with the pet carrier. In an embodiment, the anchor points of the webbing may be arranged at a portion of the pet carrier having an increased stiffness. For example, in the non-limiting embodiment of FIG. 36, the anchor points formed via the loops 1610 are attached to a stiffening panel 1620 arranged at a surface of the pet carrier 1600, such as the front 26 thereof. In other embodiments, a stiffening component is integrated into the webbing used to couple the latch connectors to the pet carrier. For example, with reference to FIG. 37, the portion of the straps 1704, 1706 extending between an anchor point 1710b and the base of the pet carrier 1700, identified at 1712, may be configured as a stiffening component. Although this stiffening component is shown as being integrated with the strap 1704, 1706, in other embodiments, a separate component, affixed to or separate from the straps 1704, 1706 may be provided as a stiffening component.

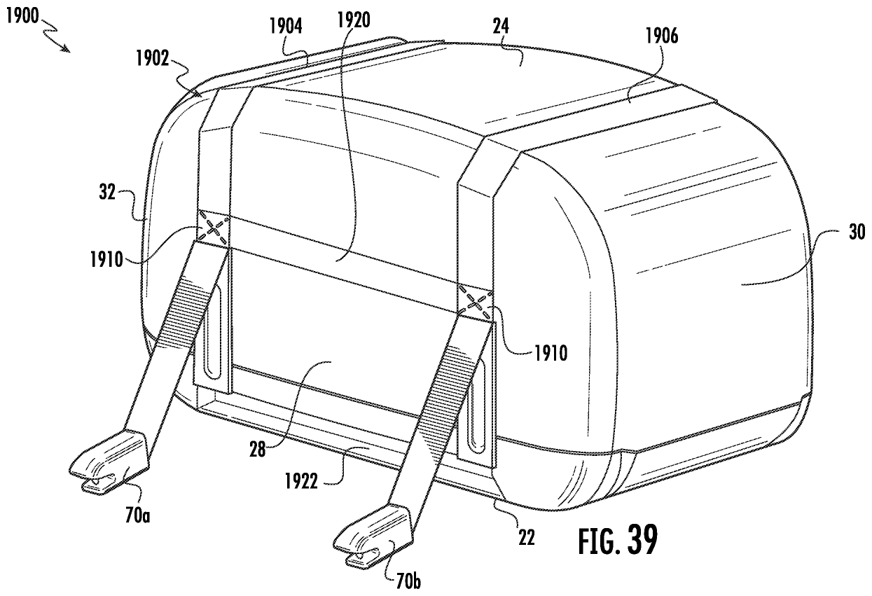

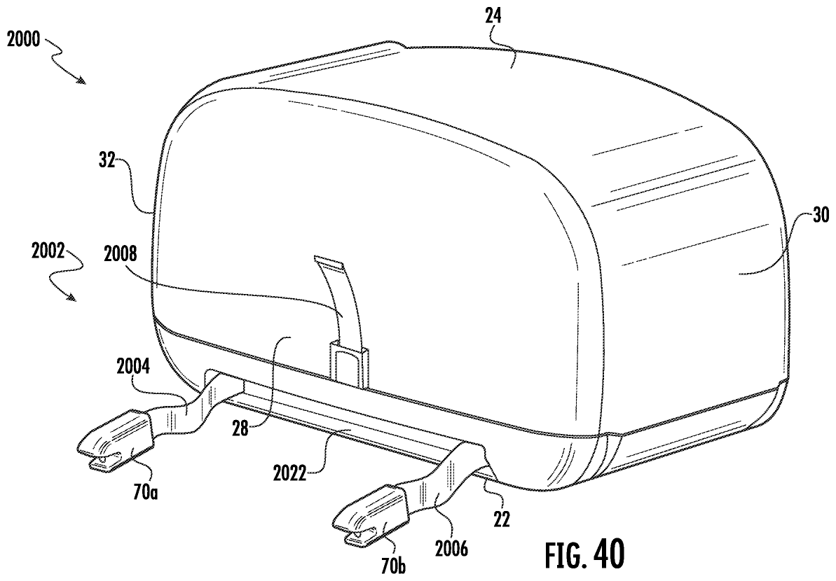

With reference to FIG. 39, the illustrated pet carrier 1900 has a webbing 1902 substantially identical to that shown in FIG. 37. A first strap 1904 is connected to a first latch connector 70a and a second strap 1906 is connected to a second latch connector 70b. Further, each strap 1904, 1906 is affixed to the pet carrier 1900 at at least one anchor point 1910, and a stiffening component 1912 may be arranged at or integral with the portion of the strap 1904, 1906 extending between the anchor 1910 and the base of the pet carrier 1900. As shown in FIG. 39, the difference is that the webbing 1902 includes a stiffening component 1920 connected to the first strap 1904 and the second strap 1906 such that tension is shared between the straps 1904, 1906 via the stiffening component 1920. In the illustrated, non-limiting embodiment of FIG. 39, the stiffening component 1920 is another strap extending between and is connected to the first strap 1904 and the second strap 1906 at anchor points 1910, respectively. However, in the embodiment shown in FIG. 38, the intermediate component 1818, is a subframe operable as a stiffening component.

It should be understood that the stiffening components illustrated and described herein are intended as an example only. Further, more than one stiffening component may be integrated into the pet carrier. Such stiffening components or stiffening structures may provide benefits such as improving crash performance by providing a rigid connection with the body of the pet carrier, maintaining the shape/integrity of the carrier volume, and the like. Further, a stiffening component or structure may extend along a portion of a side, a whole side, or along multiple sides in one or more directions.

In an embodiment, a structural member as previously described herein, such as a c-channel for example, is integrated into the pet carrier to form a cavity (illustrated at 1722, 1822, 1922, 2022, 2122 in FIGS. 37-40) at an exterior of the pet carrier. Such a structural member may also be considered a stiffening component. However, a cavity formed in another manner is also contemplated herein. In embodiments including a cavity, the soft latch connectors 70a, 70b may be receivable therein when not in use. In some embodiments, such as shown in FIG. 40, the soft latch connectors 70a, 70b of a pet carrier 2000 may extend from the interior of such a cavity 2022 formed within the pet carrier 2000. In the non-limiting embodiment of FIG. 40, a webbing 2002 includes a first strap 2004 connected to the first latch connector 70a and a second strap 2006 connected to the second latch connector 70b. The straps 2004, 2006 may extend outwardly from the interior of the cavity 2022. Although the ends of the first and second straps 2004, 2006 associated with the latch connectors 70a, 70b are illustrated as being separate, in an embodiment, the second opposite end of the straps 2004, 2006 may be connected together. As shown, the joined second end, illustrated at 2008, may extend from the pet carrier 2000 at a location remote from the cavity 2022, such as above the cavity for example. In an embodiment, the application of a force to the second end 2008 of the straps 2004, 2006, is operable to retract at least a portion of the straps 2004, 2006 into the interior of the cavity 2022.

In other embodiments, such as shown in FIG. 41, the at least one latch connector 70a, 70b is integrated into a cartridge 2130 removably connectable to a pet carrier 2100. The cartridge 2130 includes a housing 2132 and a first strap associated with the first latch connector 70a and a second strap associated with the second latch connector 70b is receivable within the housing 2132. In an embodiment, the cartridge 2130 is receivable within a cavity 2122 formed in the pet carrier 2100. The cavity 2122 may be formed by a structural member as previously described. The housing 2132 may include one or more engagement features 2134 that cooperate with a corresponding feature 2136 of the cavity 2122 to retain the cartridge 2130 in position within the cavity 2122. In the illustrated, non-limiting embodiment, the engagement features 2134 are pins that extend from one or more surfaces of the housing 2132 and the features 2136 formed in the cavity 2122 are complementary holes or recesses. However, any suitable mechanism for releasably connecting the cartridge 2130 to the pet carrier is contemplated herein. Further, it should be understood that embodiments where the cartridge 2130 is connectable to another location of the pet carrier 2100, such as to an exterior surface of the pet carrier 2100 for example, are also within the scope of the disclosure. By having the cartridge 2130 removable couple to the pet carrier 2100, a user may remove the pet carrier from a vehicle by separating the pet carrier 2100 from the cartridge 2130 while the latch connectors 70a, 70b of the cartridge 2130 remain connected to vehicle anchors.

In an embodiment, the strap 2104, 2016 supporting the at least one latch connector 70a, 70b is extendable and retractable relative to the housing 2132. In such embodiments, at least one retraction actuator 2138 may be operably coupled to a mechanism (not shown) associated with the strap, such as a retractor or wheel about which the strap 2104, 2106 may be wound for example. Accordingly, operation of the retraction actuator 2138 may draw a portion of the length of the strap 2104, 2106 into the interior of the housing 2132, thereby reducing the distance between the housing 2132 and a corresponding latch connector 70a, 70b. Additionally, or alternatively, the retraction actuator 2138 may be operable to selectively release the cartridge 2130 from the pet carrier 2100. For example, the retraction actuator 2138 may be operably coupled with the one or more engagement features 2134 to retract the engagement features into the housing 2132 to disengage from the corresponding feature 2136.

As described with respect to the embodiments illustrated in FIGS. 36-42, the one or more latch connectors 70a, 70b may be either rigid or soft connectors. However, it is also contemplated herein that, in some embodiments, the one or more rigid latch connectors 70a, 70b may be mounted directly or indirectly to a pet carrier at least partially via a flexible or soft structure, such as one or more straps or pieces of webbing for example. For example, the rigid latches may be associated with an intermediate structure mounted to the pet carrier via webbing. In such embodiments, an attachment point of the rigid latch connectors 70a, 70b to the pet body may be raised, such as to a location at the upper section of the pet carrier from the lower section thereof.

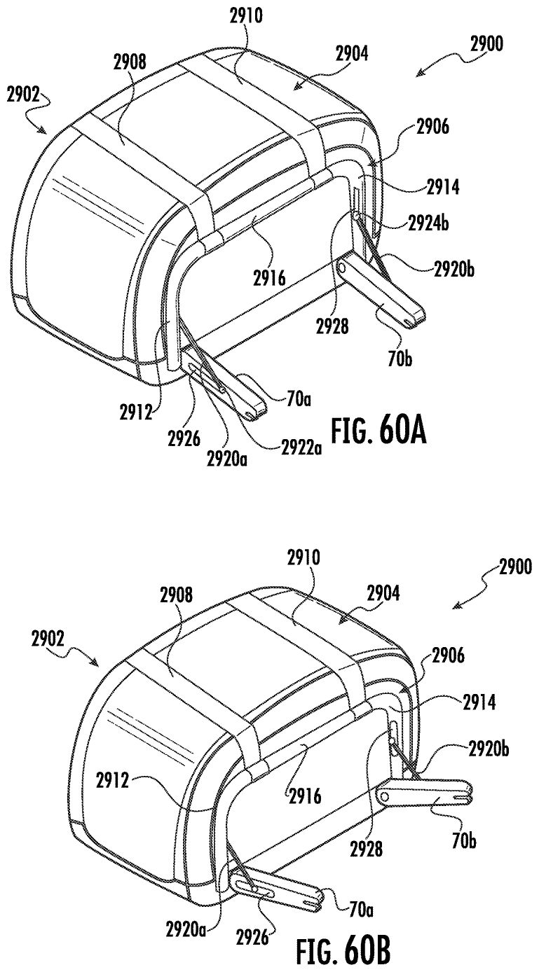

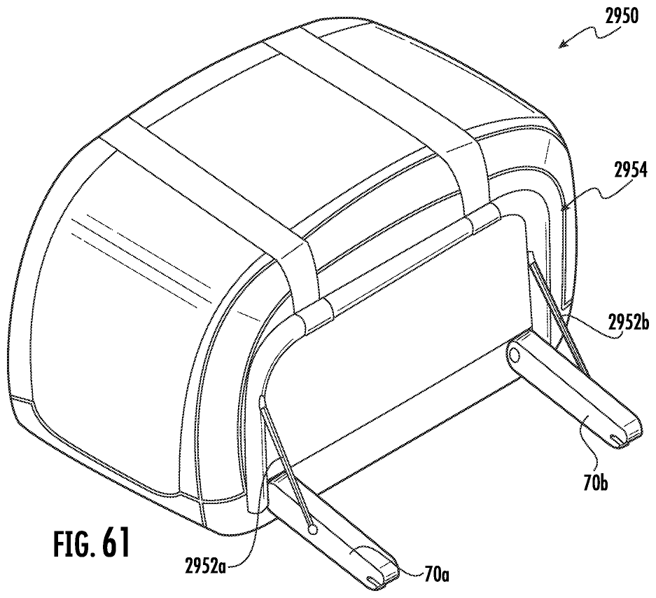

With reference to FIGS. 60A-60B, a pet carrier 2900 is illustrated having webbing 2904 operable to mount an intermediate component 2906 to the body 2902 of the pet carrier 2900. In the illustrated, non-limiting embodiment, the webbing 2904 includes a first mounting strap 2908 and a second mounting strap 2910. A portion of each mounting strap 2908, 2910 such as a first end thereof, may be connected to the body 2902 of the pet carrier 2900 at one or more anchor points. The mounting straps 2908, 2910 of the webbing 2904 may be chemically bonded, such as via an adhesive for example, or may be mechanically attached, such as via stitching for example, to a corresponding surface of the pet carrier 2900 at each anchor point. The second, opposite ends of the mounting straps 2908, 2910 may be connected to the intermediate component 2906, such as a frame element for example. The intermediate component 2906 may be formed from a metal, such as steel or aluminum, or any other suitable material. Similar to the embodiment shown in FIG. 38, the intermediate component 2906 may have a first leg 2912, a second leg 2914 and a connecting member 2916 that form a generally U-shaped configuration with the connecting member 2916 being positioned further from a bottom 22 of the pet carrier 2900 than the legs 2912, 2914. In the illustrated, non-limiting embodiment, the mounting straps 2908, 2910 are affixed to the connecting member 2916 of the intermediate component 2906. However, embodiments where one or more of the mounting straps 2908, 2910 couples to the intermediate component 2906 at another location are also contemplated herein. The end of each mounting strap 2908, 2910 associated with the intermediate component 2906 may have a loop or opening formed therein and the intermediate component 2906 is receivable within the loop.

The pet carrier 2900 further includes a pair of rigid latch connectors 70a, 70b. In an embodiment, an end of the rigid latch connectors 70a, 70b is pivotably coupled to the pet carrier 2900 at a first location. Although the rigid latch connectors 70a, 70b are illustrated as being pivotably mounted to a portion of the body 2902, such as the lower section thereof, embodiments where the rigid latch connectors 70a, 70b are mounted to another portion of the pet carrier 2900, such as to the legs 2912, 2914, respectively, of the intermediate component 2906 for example, are also within the scope of the disclosure. In the illustrated, non-limiting embodiment, the rigid latch connectors 70a, 70b are coaxially mounted. However, embodiments where the rigid latch connectors 70a, 70b are not coaxially mounted are also contemplated herein.

In the illustrated, non-limiting embodiment, each rigid latch connector 70a, 70b is operably coupled the pet carrier 2900 via a locking support. A respective locking support 2920a, 2920b may be associated with each rigid latch connector 70a, 70b. As shown, a first end 2922a, 2922b of a locking support 2920a, 2920b may be movably coupled to the rigid latch connectors 70a, 70b and a second, opposite end 2924a, 2924b of a locking support 2920a, 2920b may be movably coupled to the intermediate component 2906. The connection between the second end 2924a, 2924b of the locking supports 2920a, 2920b and the legs 2912, 2914 of the intermediate component 2906 is spaced from the connection between each respective rigid latch connector 70a, 70b and the body 2902 of the pet carrier 2900. In an embodiment, the location of the second connection is vertically above the location of the first connection formed between a rigid latch connector 70a, 70b and the body 2902.

In the illustrated, non-limiting embodiment, the ends 2922a, 2922b, 2924a, 2924b of the locking support 2920a, 2920b are positioned within latch slots 2926 arranged at the rigid latch connectors 70a, 70b, and legs slots 2928 of the intermediate component, respectively. Each slot 2926, 2928 defines a track of path of movement of the locking support 2920a, 2920b, and the sliding movement between the ends 2922a, 2922b, 2924a, 2924b of the locking supports 2920a, 2920b and each respective slot 2926, 2928 defines an allowed rotation of the rigid latch connectors 70a, 70b about their axes. In the illustrated embodiment, the rigid latch connectors 70a, 70b are rotatable within a vertically oriented plane. As shown, the locking supports 2920a, 2920b may be arranged at a first, lowermost end of the leg slots 2928 when the rigid latch connectors 70a, 70b, are in an extended position, and the locking supports 2920a, 2920b may be arranged at a second, uppermost end of the leg slots 2928 when the rigid latch connectors 70a, 70b, are in a retracted or stowed position. Similarly, the locking supports 2920a, 2920b may be arranged at a first end of the latch slots 2926, closest to the catch, when the rigid latch connectors 70a, 70b, are in an extended or deployed position, and when the rigid latch connectors 70a, 70b, are in a retracted position, the locking supports 2920a, 2920b may be arranged at a second, opposite end of the latch slots 2926. Accordingly, the end of the locking supports 2920a, 2920b associated with the rigid latch connectors 70a, 70b may be considered proximal the body 2902 when the rigid latch connectors 70a, 70b are in the stowed position, and may be considered spaced from the body 2902 when the rigid latch connectors 70a, 70b are in the deployed position.

In another embodiment, shown in FIG. 61, a pet carrier 2950 has similar locking supports 2952a, 2952b coupling respective rigid latch connectors 70a, 70b to an intermediate component 2954. In both this embodiment and the previous embodiment, the locking supports 2952a, 2952b are illustrated as being formed from a single rigid member. In the illustrated, non-limiting embodiment, the locking supports 2952a, 2952b are fixedly attached to the rigid latch connectors 70a, 70b, and each rigid latch connector 70a, 70b, is rotatable about a separate axis such that the rigid latch connectors 70a, 70b, rotate horizontally between a stowed configuration and a deployed configuration.

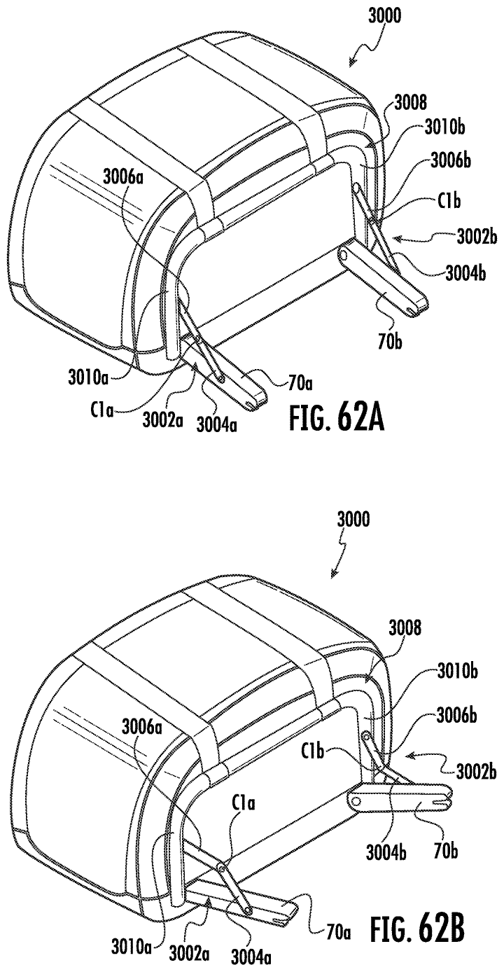

In other embodiments, such as shown in FIGS. 62A-62B, a pet carrier 3000 may have locking supports 3002a, 3002b formed as linkages including a plurality of link members movably coupled to one another. As shown, each linkage 3002a, 3002b includes at least a first link member 3004a, 3004b and a second link member 3006a, 3006b. At least one rotational connection, illustrated at C1a and C1b, respectively, is formed at an interface between first respective link members 3004a, 3004b and second respective link members 3006a, 3006b. In such embodiments, distal ends of the first link members 3004a, 3004b may be pivotably connected to a respective leg 3010a, 3010b of an intermediate component 3008, and distal ends of the second link members 3006a, 3006b may be pivotably coupled to a respective rigid latch connector 70a, 70b. As the rigid latch connectors 70a, 70b transform between extended and retracted positions, the link members 3004a, 3004b, 3006a, 3006b of the linkage are configured to extend or collapse about the rotational connection. The connection between the first link member 3004a, 3004b and the leg 3010a, 3010b may be at a first location, and the pivotable connection between the body of the rigid latch connector 70a, 70b and the body 3012 of the pet carrier 3000 may be arranged at a second location, the first location being offset, such as vertically raised for example, relative to the second connection.

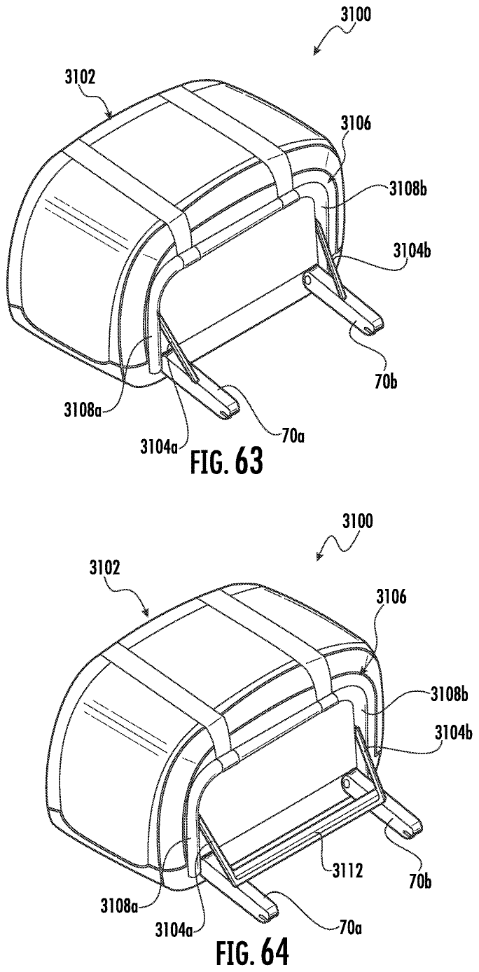

With reference to FIGS. 63 and 64, another embodiment of a pet carrier 3100 is illustrated. Similar to the previous embodiments, at least one rigid latch connector 70a, 70b, is rotatably coupled to the body 3102 of the pet carrier 3100, such as to the base thereof for example, at a first location, and locking supports 3104a, 3104b associated with each rigid latch connector 70a, 70b are rotatably coupled to an intermediate component 3106 of the pet carrier 3100, such as a frame element, at a second location, offset from the first location. As shown, a first end of each locking support 3104a, 3104b is pivotably coupled to a respective leg 3108a, 3108b of the intermediate component 3106. A second opposite end of the locking supports 3104a, 3104b, positioned closest to the rigid latch connectors 70a, 70b are engageable with but are not fixedly connected to the rigid latch connectors 70a, 70b.

The locking supports 3104a, 3104b are movable between a first collapsed position and a second extended position. In the collapsed position, the distal ends of the locking supports 3104a, 3104b are positioned proximate to the body 3102. In the extended position, the locking supports 3104a, 3104b are arranged at a non-parallel angle relative to corresponding legs 3108a, 3108b of the intermediate component 3106. As shown, the second ends of the locking supports 3104a, 3104b are spaced away from the body 3102. When rotated to the extended position, the second ends of the locking supports 3104a, 3104b may abut a surface of the latch connector 70a, 70b, such as a top surface for example. This engagement may restrict unintended rotation of the latch connector 70a, 70b from a deployed position toward a stowed position.

Although not shown, in some embodiments, a biasing mechanism may be operably coupled to each locking support 3104a, 3104b to bias the respective locking supports 3104a, 3104b to the extended position. In such embodiments, the rigid latch connectors 70a, 70b, when stowed, may be positioned within the path of movement of the locking supports 3104a, 3104b. Accordingly, the stowed rigid latch connectors 70a, 70b may oppose the biasing force of the biasing mechanism, thereby retaining the locking supports 3104a, 3104b in the first, collapsed position. In such embodiments, a locking support 3104a, 3104b may be biased to the rotated position in response to deployment of the rigid latch connector 70a, 70b. However, in other embodiments, the locking supports 3104a, 3104b may be configured to move between the collapsed and extended positions in response to manual application of a force thereto by a user when the latch connectors 70a, 70b are in the deployed position.

In the illustrated, non-limiting embodiment of FIG. 63, each locking support 3104a, 3104b is a single, rigid body aligned with a respective rigid latch connector 70a, 70b. Although two separate, independently operable locking supports 3104a, 3104b are illustrated in FIG. 64, in other embodiments, a connector 3112 may extend between and operably couple the locking supports 3104a, 3104b to form a single unit associated with both latch connectors 70a, 70b.

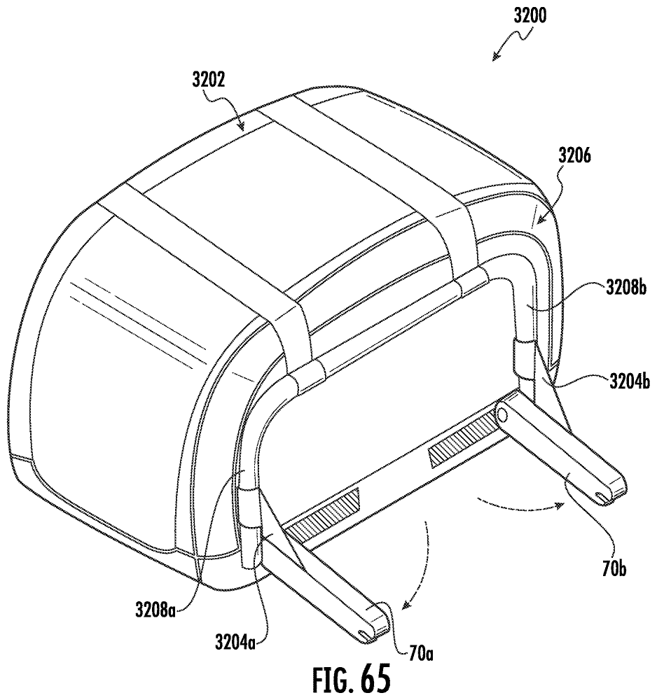

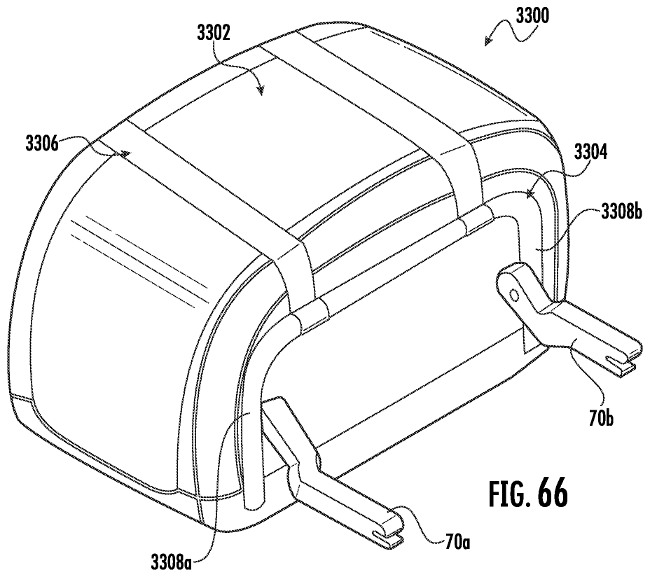

In the non-limiting embodiment of a pet carrier 3200 shown in FIG. 65, at least one rigid latch connector 70a, 70b is rotatably coupled to the body 3202 of the pet carrier 3200, such as to the base thereof for example, at a first location, and a locking support 3204a, 3204b associated with each rigid latch connector 70a, 70b may be coupled to an intermediate component 3206 of the pet carrier 3200, such as a frame element, at a second location. In the illustrated, non-limiting embodiment, the rigid latch connectors 70a, 70b are not mounted coaxially. As shown, each of the rigid latch connectors 70a, 70b is rotatable within a horizontally oriented plane, and in some embodiments the rigid latch connectors 70a 70b are rotatable within the same horizontally oriented plane. As shown, the locking support 3204a, 3204b may be brackets having a first end operably coupled to a respective leg 3208a, 3208b of the intermediate component and a second end connected to a corresponding rigid latch connectors 70a, 70b. The first end of each locking support 3204a, 3204 may have a shape complementary to an outer periphery of each leg 3208a, 3208b. In an embodiment, the first end of each locking support 3204a, 3204 is rotatable about a longitudinal axis of each leg 3208a, 3208b as the rigid latch connectors 70a, 70b rotate between the stowed and deployed positions.

Similar to the previous embodiments, the pet carrier 3300 illustrated in FIG. 66 has a plurality of rigid latch connectors 70a, 70b, and the rigid latch connectors 70a, 70b may be movably coupled to the body 3302 of the pet carrier 3300. In the illustrated, non-limiting embodiment, the rigid latch connectors 70a, 70b have a curved configuration. Accordingly, the opposing ends of the rigid latch connectors 70a, 70b are arranged in different planes. For example, when in a deployed configuration, the end of each rigid latch connector 70a, 70b connected to the body 3202 may be vertically offset from the distal end of the latch connector 70a, 70b. Alternatively, or in addition, the latch connectors 70a, 70b may be mounted to the upper section of the body 3302. In some embodiments, the pet carrier 3300 includes an intermediate component 3304, such as a frame element, coupled thereto, such as via webbing 3306. In such embodiments, the latch connectors 70a, 70b may be coupled directly to the legs 3308a, 3308b of the intermediate component 3304, rather than to the body 3302 itself. A pet carrier 3300 having latch connectors 70a, 70b with such a configuration are connectable to vehicle anchors that are arranged at a position vertically beneath the connection between the latch connectors 70a, 70b and the pet carrier 3300.

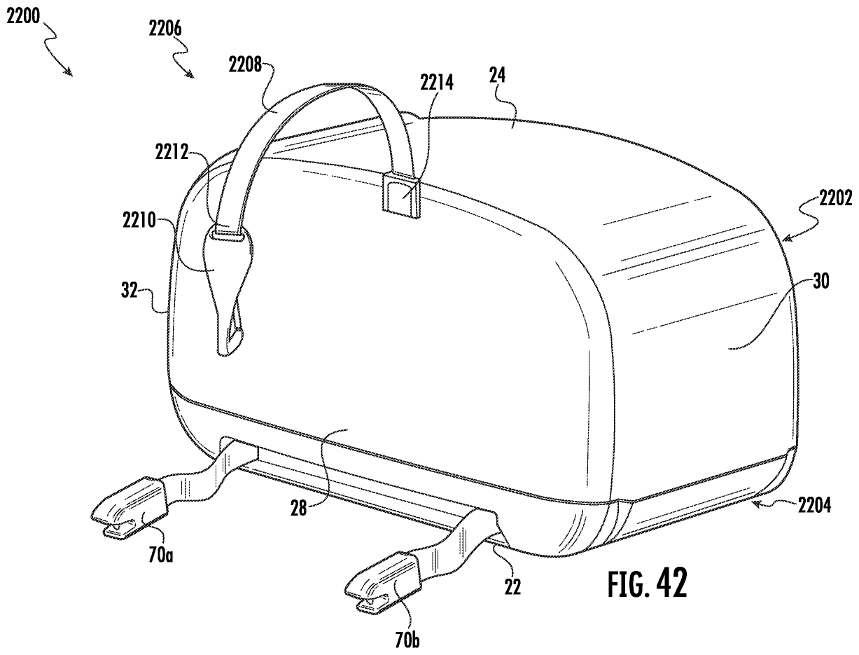

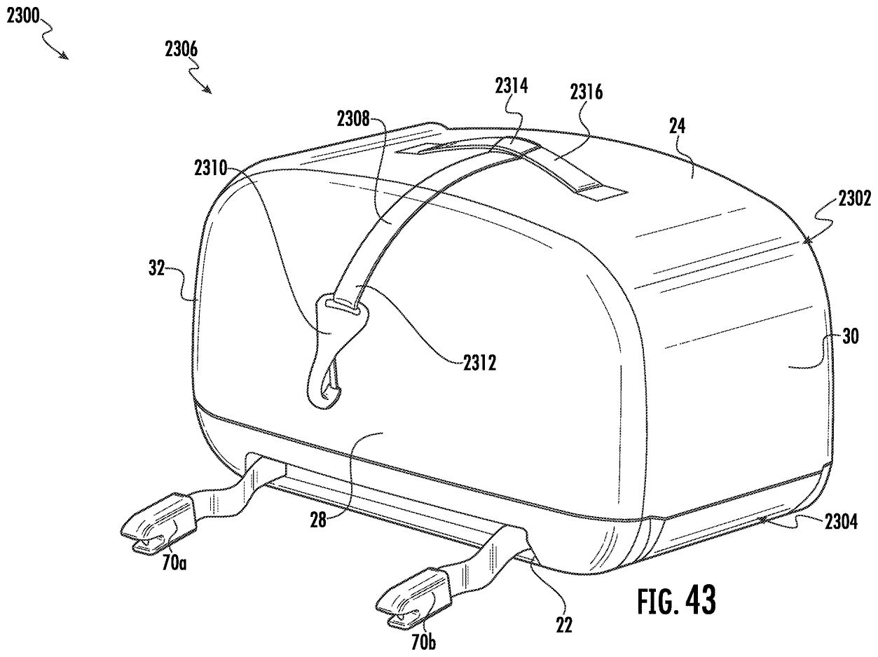

With reference now to FIGS. 42-44, a pet carrier 2200 may include a tether assembly operable to couple to pet carrier 2200 to a portion of an adjacent vehicle seat. The pet carrier 2200 illustrated in FIG. 42 includes a first section 2202 and a second section 2204 as previously described herein. In the illustrated non-limiting embodiment, the pet carrier includes a tether assembly 2206 having a tether strap 2208 having a tether anchor 2210 affixed to an end 2212 thereof. An opposite end 2214 of the tether strap 2208 may be affixed or coupled to the pet carrier 2200, such as to a surface of a first section 2202 of the pet carrier 2200 for example. The tether strap 2208 may be movable relative to the pet carrier. In an embodiment, the tether strap 2208 is operably coupled to a retraction mechanism. A similar tether assembly 2306 is illustrated in the embodiment of a pet carrier 2300 shown in FIG. 43. The tether assembly 2306 of the pet carrier 2300 has a tether strap 2308 having a tether anchor 2310 affixed to an end 2312 thereof and a second opposite end 2314 of the tether strap 2308 may be coupled to the pet carrier 2300. As shown, the second end 2314 of the tether strap 2308 may be wrapped about a handle 2316, such as located at the top 24 of the pet carrier 2300. However, embodiments where the handle 2316 is located at another are about the first section 2302 or the second section 2304 are also contemplated herein.

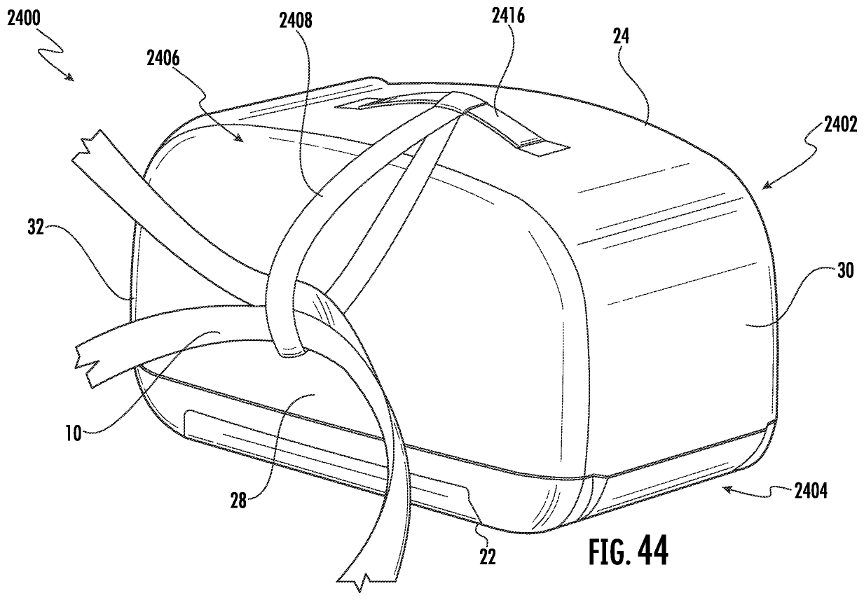

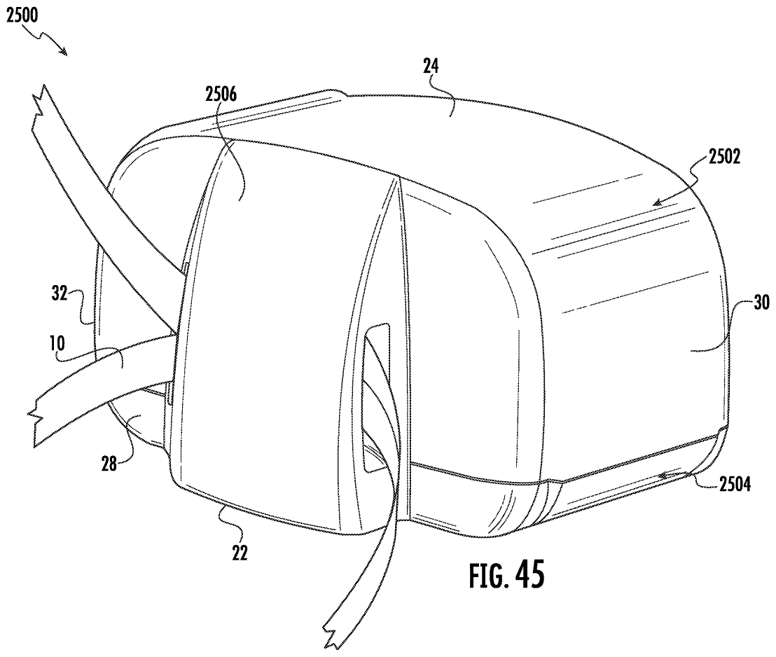

Although the tether assemblies 2206, 2306 of the pet carriers 2200, 2300 shown in FIGS. 41 and 42 are connectable to a portion of a vehicle seat, in other embodiments, the pet carrier may include an assembly operably to couple the pet carrier to the vehicle seat via the vehicle seat belt. Such a pet carrier 2400 is illustrated in FIG. 44. As shown, the pet carrier 2400 includes a first section 2402 and a second section 2204, and a tether assembly 2406 is operably coupled to the first section 2402. In the illustrated, non-limiting embodiment, the tether assembly 2406 includes a tether strap 2408 arranged to form a continuous loop and is anchored to a handle 2416 at the first section 2402. The loop is sized to receive at least a portion of a vehicle seat belt, illustrated at 10, therein to further secure the pet carrier 2400 to the vehicle seat. A pet carrier 2500 shown in the embodiment illustrated in FIG. 45, includes an additional panel 2506 arranged at an exterior surface of the body of the pet carrier 2500, such as at a rear of the pet carrier 2500 for example. The panel 2506 includes an opening 2508 through which the vehicle seat belt 10 may be threaded to affix the pet carrier to the vehicle seat. It should be appreciated that in embodiments of the pet carrier including a tether assembly or panel suitable to connect the pet carrier to the vehicle seat, the pet carrier may but need not have latch connectors 70a, 70b for affixing the pet carrier to a vehicle seat in addition to the tether assembly and/or panel.

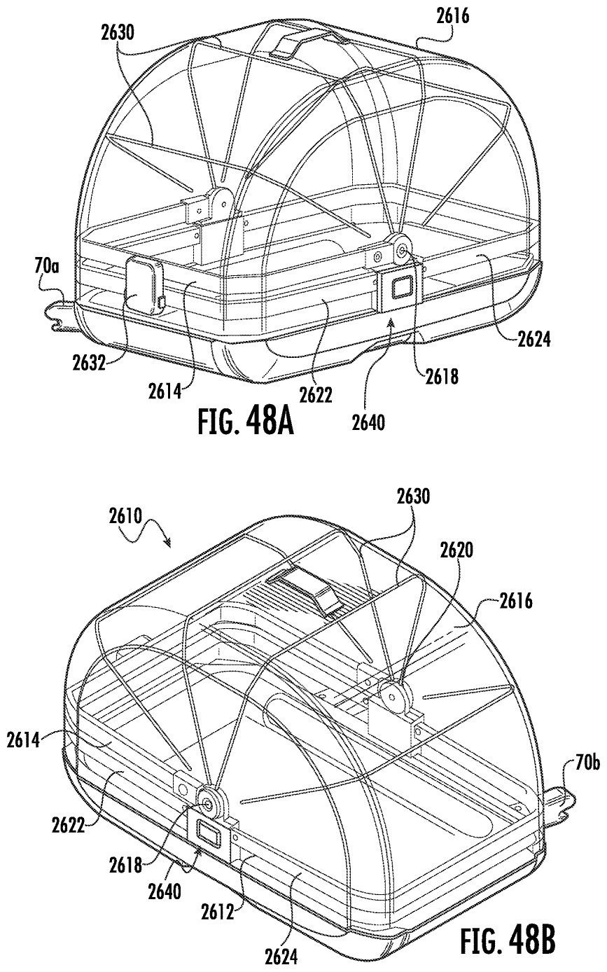

With reference now to FIGS. 46-51, another embodiment of a pet carrier 2600 is illustrated. As shown, the pet carrier 2600 has a front side, rear side, left side, right side, and a top formed by a first section 2602 and a second section 2604 in combination. The first section 2602 and the second section 2604 may but need not be separable.

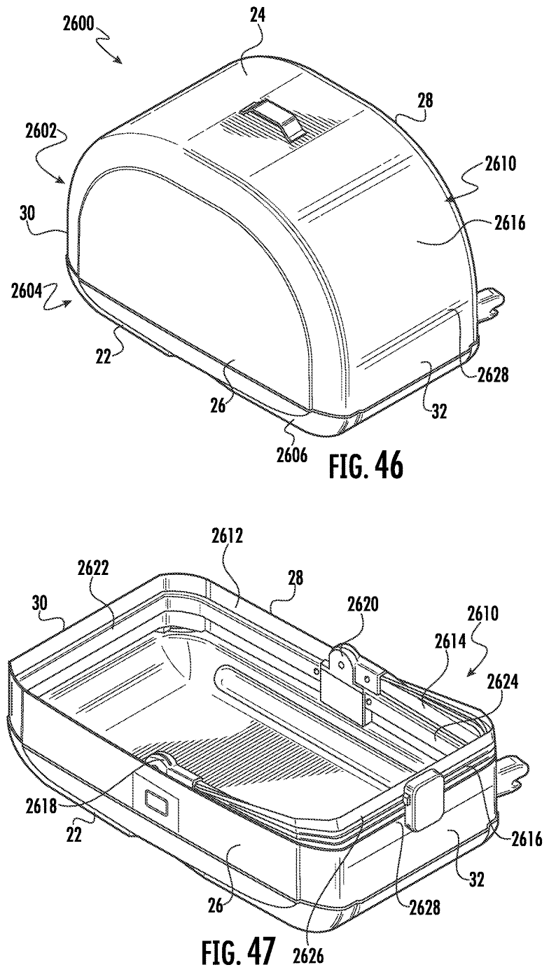

The pet carrier 2600 may include a canopy unit 2610. The canopy unit 2610 includes a canopy frame 2612, a canopy bow 2614 movable relative to the canopy frame 2612, and a canopy 2616. The canopy bow 2614 may have a first positioning end 2618 and a second positioning end 2620 respectively mounted to the canopy frame 2612. The canopy bow 2614 may be rotatable relative to the canopy frame 2612 about a mounting axis extending through the first and second positioning ends 2618, 2620. In an embodiment, the canopy bow 2614 is mounted near a center of the front 26 and rear 28 of the pet carrier 2600, respectively, such that a first frame portion 2622 of the canopy frame 2612 is arranged at a first side of the mounting axis and a second frame portion 2624 of the canopy frame 2612 is arranged at a second, opposite side of the mounting axis. In the illustrated, non-limiting embodiment, the canopy bow 2614 is rotatable between a first position (FIG. 46) in which the canopy bow 2614 is positioned generally adjacent to and in vertical alignment with the first frame portion 2622 and a second position (FIG. 47) in which the canopy bow 2614 is positioned generally adjacent to and in vertical alignment with the second frame portion 2624. In an embodiment, the canopy bow 2614 is rotatable about 180 degrees between the first position and the second position. Further, it should be understood that the canopy bow 2614 may be arranged at and retained or held in one or more positions between the first position and the second position. Any suitable type of positioning mechanism may be employed to retain the canopy bow 2614 at any position along the path of rotation at or between the first position and the second position.

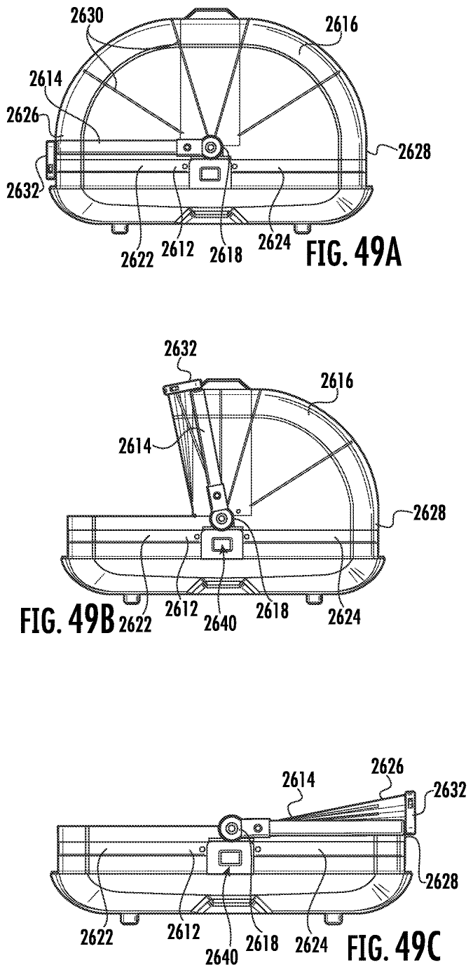

The canopy 2616 has a body including a first end 2626 and a second end 2628. In the illustrated, non-limiting embodiment, one or more support bows 2630 are associated with, and in some embodiments integrated into, the body of the canopy 2616. The structural supports 2830 may be rigid, semi-rigid, and/or resilient and are movable about the mounting axis in response to rotation of the canopy bow 2614. As shown, the first end 2626 of the canopy 2616 may be affixed to the canopy bow 2614 and the second end 2628 of the canopy 2616 may be connected to the second frame portion 2624 of the canopy frame 2612. Accordingly, when the canopy bow 2614 is in the first position, the canopy 2616 extends from a position generally adjacent to the first frame portion 2622 to the second frame portion 2624 about the mounting axis. When the canopy bow 2614 is in the first position, the pet carrier 2600 may be considered to be in a closed configuration. Similarly, when the canopy bow 2614 is in the second position, the first end 2626 of the canopy 2616 is positioned generally adjacent to the second frame portion 2624 and the second end 2628 of the canopy 2616. When the canopy bow 2614 is in the second position, the pet carrier 2600 may be considered to be in a fully open configuration. When the canopy bow 2614 is located between the first position and the second position, such as shown in FIG. 49B. for example, the pet carrier 2600 may be considered to be in a partially open position.

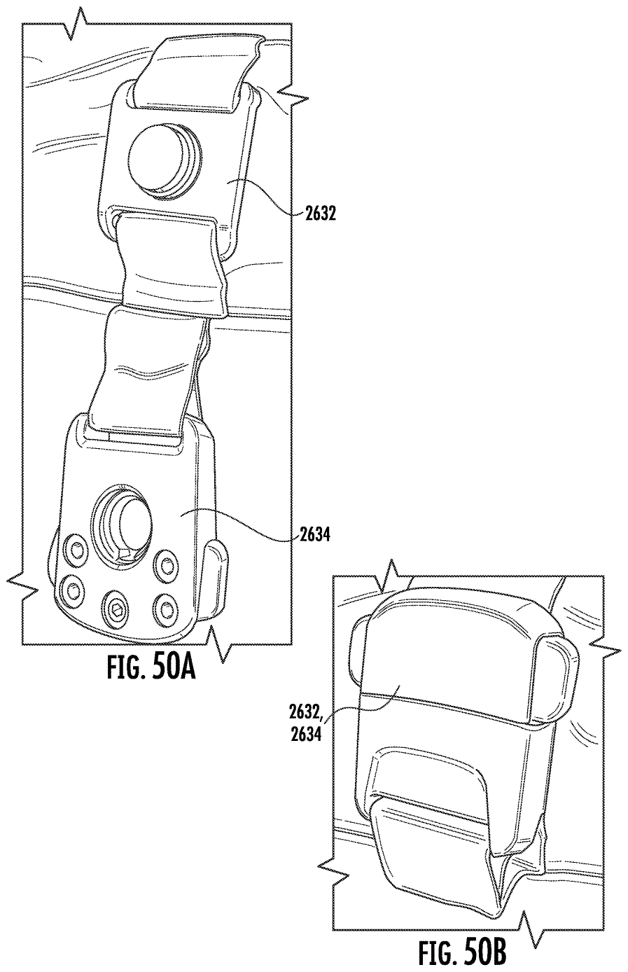

In an embodiment, the canopy bow 2614 may have a first portion 2632 of locking mechanism or other coupling device located thereat and a second portion 2634 of the locking mechanism or closure may be arranged at an the base 2606 for example (see FIG. 50A). The first portion 2632 of the locking mechanism is engageable with the second portion 2634 of the locking mechanism (FIG. 50B) when the when the canopy bow 2614 is in the first position. This engagement is operable to retain the canopy bow 2614 in the first position. The locking mechanism formed by the first and second portions 2632, 2634 may provide a positive mechanical interlock and, in some embodiments, may be a magnetic latch. However, it will be appreciated that any suitable mechanism for coupling the canopy bow 2614 to an adjacent portion of the pet carrier 2600 is within the scope of the disclosure.

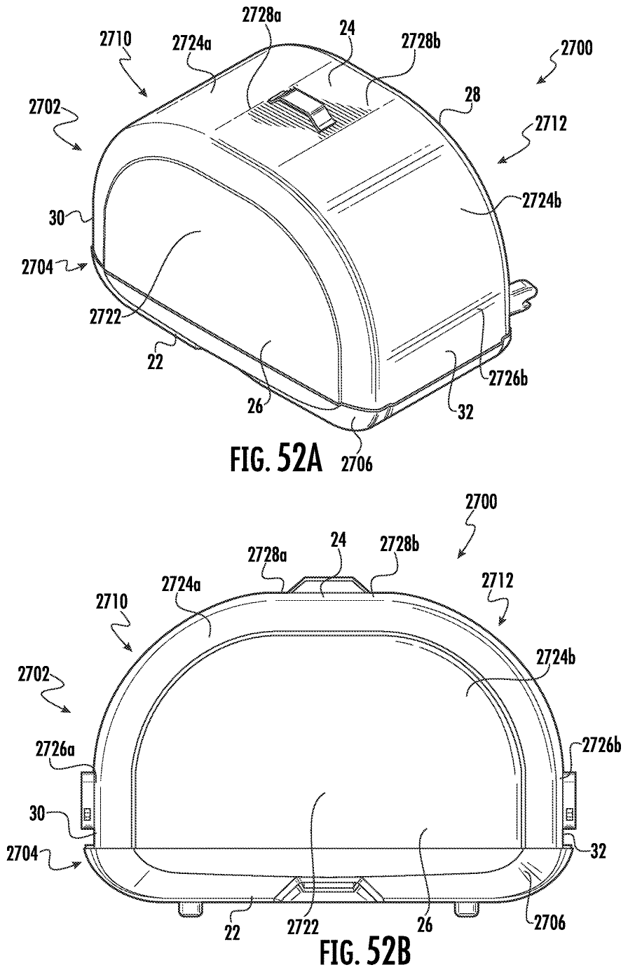

In other embodiments, the pet carrier may include a plurality or canopy units. For example, in the non-limiting embodiment of FIGS. 52A-56, the illustrated pet carrier 2700 includes a first canopy unit 2710 positioned adjacent to a first side of the pet carrier 2700, such as the left side 30 for example, and a second canopy unit 2712 located adjacent to a second, opposite side of the pet carrier 2700, such as the right side 32 for example. In such embodiments, each canopy unit 2710, 2712 includes a canopy bow 2714a, 2714b rotatable relative to a canopy frame 2716a, 2716b about a respective mounting axis. As shown, the mounting axes may be parallel to one another, arranged within the same plane, and separated from one another by a distance.

The mounting ends 2718a, 2718b, 2720a, 2720b of the canopy bow 2714a, 2714b of each canopy unit 2710 may similarly be mounted near a center of the front 26 and rear 28 of the pet carrier 2700. In the illustrated, non-limiting embodiment, the first canopy bow 2714a of the first canopy unit 2710 is rotatable between a first position in which the canopy bow 2714a is positioned generally adjacent to and in vertical alignment with the canopy frame 2716a and a second position in which the first canopy bow 2714a is arranged at a non-parallel angle relative to the canopy frame 2716a. In the illustrated, non-limiting embodiment, the second position of the first canopy bow 2714a is oriented substantially perpendicular to the first position. In such embodiments, the first canopy bow 2714a is rotatable about 90 degrees between the first position and the second position. However, embodiments where the second position is at another angle relative to the first position are also within the scope of the disclosure. Further, it should be understood that the first canopy bow 2714a may be arranged at and retained or held in one or more positions between the first position and the second position.

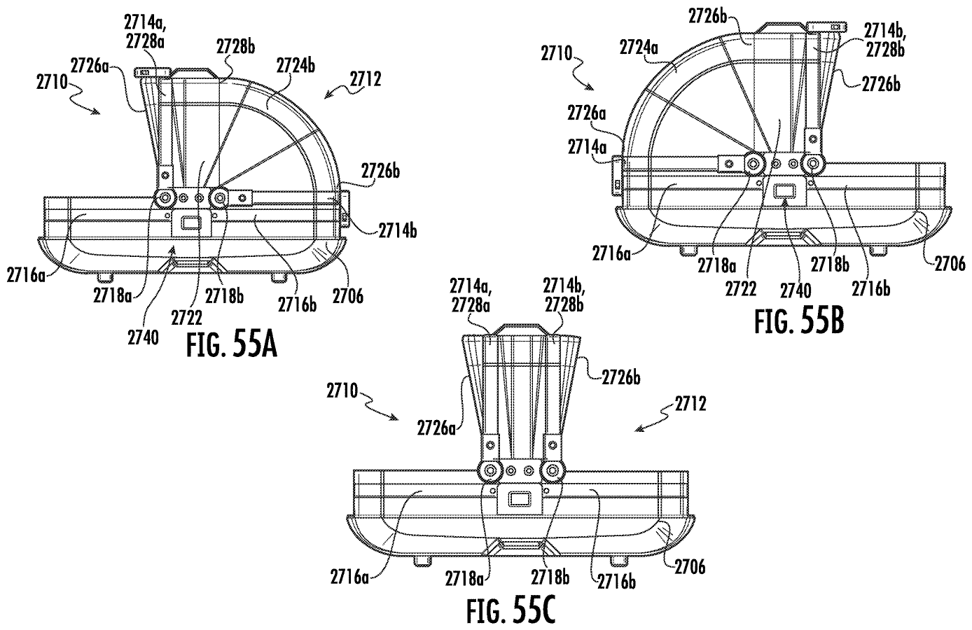

A center panel 2722 may be arranged between and coupled to the first canopy unit 2710 and the second canopy unit 2712, respectively. In an embodiment, the center panel 2722 is fixed relative to the pet carrier 2700 and the base 2706. The first canopy 2724a of the first canopy unit 2710 may have a first end 2726a connected to the first canopy bow 2714a and a second, opposite end 2728a connected to the center panel 2722, such as an edge thereof. Further, the first canopy 2710 may include one or more first structural supports or support bows 2730a operable to retain the shape of the first canopy unit 2710 when closed. When the first canopy bow 2714a is in the first position, the first canopy 2724a extends from a position generally adjacent to the canopy frame 2716a to the center panel 2722. When the first canopy bow 2714a is in the first position, the first canopy unit 2710 of the pet carrier 2700 may be considered to be in a closed configuration. Similarly, when the first canopy bow 2714a is in the second position, the first end 2726a of the first canopy 2724a is positioned generally adjacent to the center panel 2722, and therefore the second end 2728a of the first canopy 2724a. When the first canopy bow 2714a is in the second position (FIGS. 53, 55A), the first canopy unit 2710 of the pet carrier 2700 may be considered to be in a fully open configuration. When the first canopy bow 2714a is located at position between the first position and the second position, the first canopy 2724a of the pet carrier 2700 may be considered to be in a partially open position. In an embodiment, the center panel 2722 or the canopy may include a retention device (not shown) operable to retain the first canopy bow 2714a in the second position.

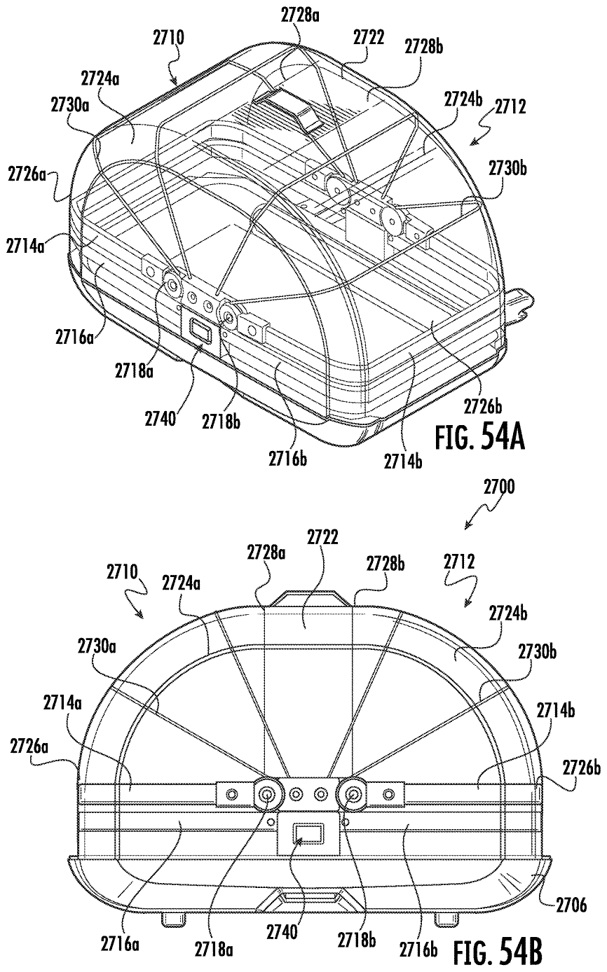

It should be understood that the second canopy unit 2712 may have a similar configuration to the first canopy unit 2710. A first end 2726b of the second canopy 2724b may be attached to the second canopy bow 2714b, and a second, opposite end 2728b of the second canopy 2724b may be connected to the center panel 2722. Once or more supports 2730b may be operable to support the intermediate portion of the canopy 2724b. The second canopy bow 2714b may be movable from a first position arranged adjacent to the frame 2716b (FIGS. 52A, 54A) and a second position (FIGS. 53, 55B), adjacent to the center panel 2722. Operation of the second canopy unit 2712 is substantially similar to that of the first canopy unit 2710 and therefore is not described herein in further detail. In embodiments of the pet carrier 2700 including a first canopy unit 2710 and a second canopy unit 2712, a position of the first canopy 2724a may be adjusted independently of the second canopy 2724b.

Although described as a separate first canopy unit 2710 and second canopy unit 2712, it should be understood that in other embodiments, a single canopy unit having a first canopy bow 2714a (rotatable as described above) and a second canopy bow 2714b (rotatable as described above) mounted at different locations about a single canopy frame formed by the frames 2716a, 2716b are also within the scope of the disclosure. In such embodiments, the canopy unit may include two separate canopies 2724a, 2724b connected by a center panel 2722 as previously described, a single canopy 2724 having a first end 2726 connected to the first canopy bow 2714a and a second opposite end 2728 connected to the second canopy bow 2714b may be used. In such a configuration, center of the single canopy, disposed between the first and second canopy bows 2714a, 2714b will remain stationary relative to the base 2706.

Similar to the embodiment of FIGS. 46-51, each canopy bow 2714a, 2714b may have a first portion 2632a, 2632b of a locking mechanism or other coupling device located there at configured to cooperate with a second portion (not shown) arranged at an the base 2706 for example to retain the canopy 2724a, 2724b in a closed position.

In the embodiments illustrated and described herein, the one or more canopy units 2610, 2710, 2712 are integrated into both the first and second sections 2602, 2702, 2604, 2704 of the pet carriers 2600, 2700. For example, the canopy 2616, 2724a, 2724b and the canopy bow 2614, 2714a, 2714b in combination may form the first section 2602, 2702 of the pet carrier 2600, 2700 and the canopy frame 2612, 2716a, 2716b may be mounted to the base 2606, 2706 of the second section 2604, 2704. In the illustrated, non-limiting embodiment, the second section 2604, 2704 includes a sidewall 2607, 2707 protruding from the base. In an embodiment, the sidewall 2607, 2707, extends about an entire periphery of the base 2606, 2706. The canopy frame 2612, 2716a, 2716b may be arranged at the sidewall 2607, 2707. However, embodiments where the canopy frame 2612, 2716a, 2716b is also located at the first section 2602, 2702 of the pet carrier 2600, 2700 are also within the scope of the disclosure.

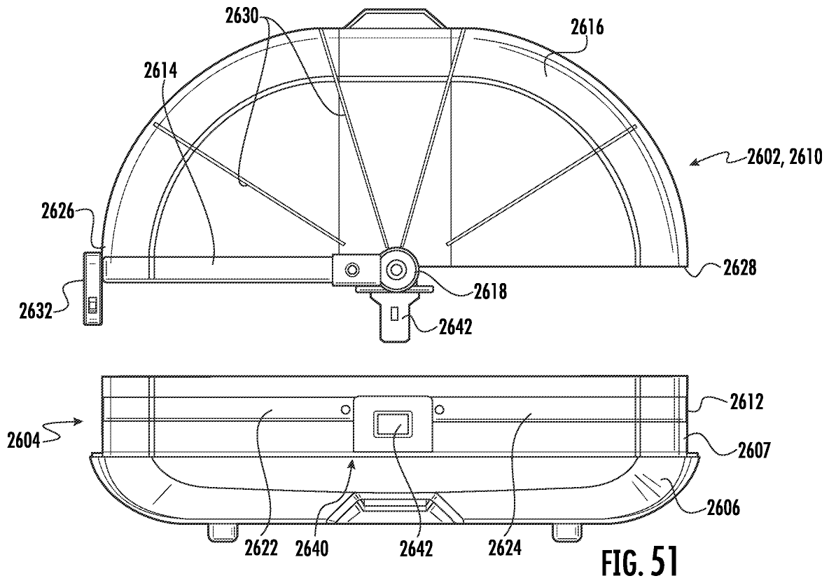

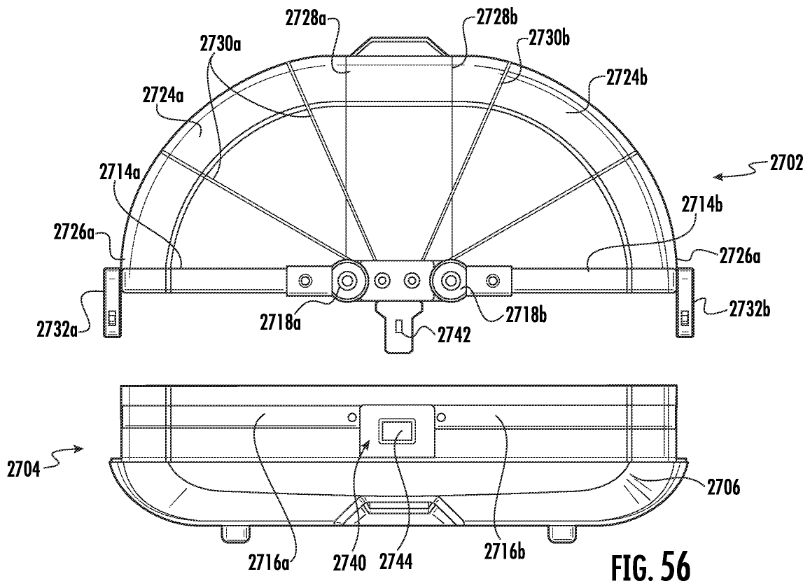

In an embodiment, the canopy 2616, 2724a, 2724b of each respective canopy unit 2610, 2710, 2712 is permanently coupled to the pet carrier 2600, 2700. However, in an embodiment, such as shown in FIGS. 51 and 56, the canopy 2616, 2724a, 2724b may be removably affixed to the pet carrier 2600, 2700, such as via one or more connectors. In the illustrated, non-limiting embodiment, the connector 2640, 2740 includes a first portion 2642, 2742, such as a buckle, and a second portion 2644, 2744, such as a latch plate slidably receivable within the buckle 2642, 2742. Although the buckle 2642, 2742 is illustrated as being mounted at the second section 2604, 2704, such as the canopy frame 2612, 2716a, 2716b for example, and the latch plate 2644, 2744 is illustrated as extending from the first section 2602, 2702, such as from a positioning end of a canopy bow 2614, 2714a, 2714b for example, it should be understood that embodiments where the buckle 2642, 2742 is arranged at the first section 2602, 2702 and the latch plate 2644, 2744 is arranged at the second section 2604, 2704 are also contemplated herein. Further, the connector 2640, 2740 illustrated and described herein is intended as an example only, and any suitable connector operable to releasably couple the first and second sections is within the scope of the disclosure.

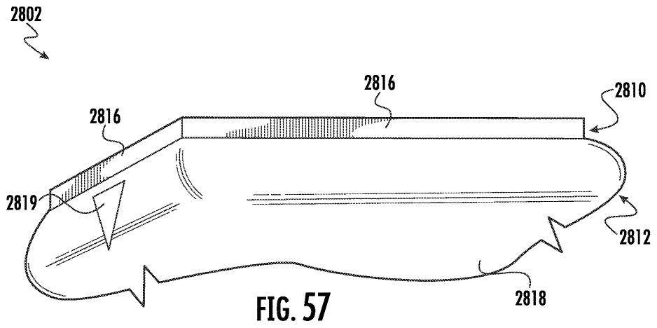

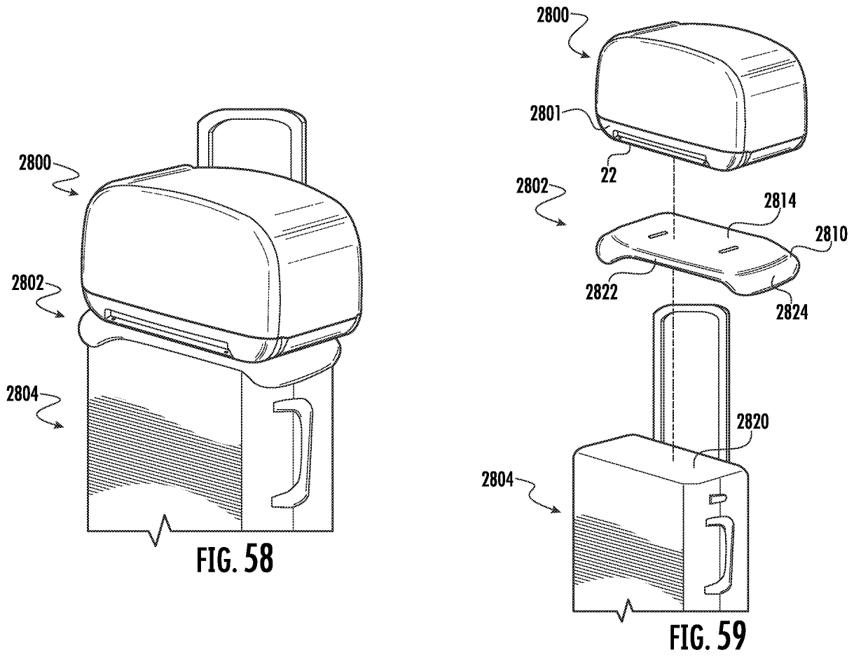

With reference now to FIGS. 57-59, an example of an adapter 2802 suitable for use with a pet carrier 2800 is illustrated. The adapter 2802, as shown, is intended to provide an interface for securely positioning the pet carrier 2800 about a secondary body 2804. Because a pet carrier 2800 as described herein may be used to transport an animal on a vehicle such as an aircraft, in some embodiments, the secondary body or component 2804 may be a piece of luggage. The adapter 2802 includes a body having a first or upper body portion 2810 and a second, lower body portion 2812. The upper body portion 2810 may include a generally flat surface 2814 (see FIG. 59) upon which the bottom 22 of the pet carrier 2800 is positionable. As shown, the size of the upper body portion 2810 may be equal to or larger than the base 2801 of the pet carrier 2800. Further, in an embodiment, the upper body portion 2810 may include at least one sidewall 2816 extending upwardly from the surface 2814 at an angle to form a barrier that restricts sliding movement of the pet carrier 2800 relative to the adapter 2802 when positioned thereon. In the illustrated, non-limiting embodiment, the at least one sidewall 2816 extends about an entire periphery of the upper surface 2814; however, embodiments where only a portion of the upper surface 2814 is bounded by a sidewall 2816 are also contemplated herein. Alternatively, or in addition to the sidewall, the upper surface 2814 may be contoured, such as curved or sloped adjacent to an edge thereof, to restrict movement of the pet carrier 2800. The pet carrier 2800 may be movably mountable to the upper body portion of the adapter. However, in other embodiments, the adapter 2802 may include an affixing mechanism illustrated schematically at 2819, such as a hook, latch, snap or other connector for example, mechanically couplable to the pet carrier 2800 to restrict movement of the pet carrier 2800 relative to the adapter 2802.

The lower body portion 2812 may include soft goods 2818 configured to conform to an upper surface 2820 of the secondary component 2804 positionable in contact therewith. In such embodiments, this adaptive interface may restrict movement of the adapter 2802 relative to the secondary component 2804. In other embodiments, the lower body portion 2812 may similarly include a surface 2822 and at least one sidewall 2824 (FIG. 59) extending at an angle from the lower surface 2824. The at least one sidewall may extend about an entire periphery of the lower surface or may extend about only a portion thereof. In such embodiments, the engagement between the sidewall and the secondary component 2804 may restrict sliding movement of the adapter 2802 relative to the secondary component 2804. In an embodiment, the lower body portion 2812 is movably mountable to the upper surface of the secondary component 2804. However, in other embodiments, the adapter 2802 includes an affixing mechanism 2819, such as a hook, latch, snap, or other connector for example, mechanically couplable to the secondary component 2804 to restrict movement of the adapter 2802 relative to the secondary component 2804. It should be appreciated that in some embodiments, the adapter 2802 may include a first affixing mechanism for connecting to one of the pet carrier 2800 and the secondary component 2804 and a second affixing mechanism for connecting to the other of the pet carrier 2800 and the secondary component 2804.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A pet carrier for containing animals on a vehicle seat including at least one vehicle seat anchor, the pet carrier comprising:
a body defining an enclosure having an interior within which an animal is receivable, the body including a cavity; and
at least one rigid latch connector mounted to the body for movement between a stowed position and a deployed position, wherein the at least one rigid latch connector is receivable within the cavity when in the stowed position and the at least one rigid latch connector is connectable to the at least one vehicle seat anchor of the vehicle seat when in the deployed position.

2. The pet carrier of claim 1, wherein the at least one rigid latch connector is translatable along an axis between the stowed position and the deployed position.

3. The pet carrier of claim 1, wherein the at least one rigid latch connector is rotatable about an axis between the stowed position and the deployed position.

4. The pet carrier of claim 1, further comprising at least one biasing mechanism operably coupled to the at least one rigid latch connector to bias the at least one rigid latch connector to the deployed position.

5. The pet carrier of claim 1, wherein the body includes a first section and a second section, the first section including a frame and containment materials extending at least partially about the frame, and the second section including a base, the frame being connectable to the base.

6. The pet carrier of claim 5, wherein the cavity is formed in the base.

7. The pet carrier of claim 5, further comprising a latch deployment mechanism operable to automatically transform the at least one rigid latch connector from the stowed position to the deployed position in response to an input.

8. The pet carrier of claim 7, wherein the latch deployment mechanism includes a deployment actuator operably coupled to the at least one rigid latch connector by a deployment assembly, the at least one rigid latch connector automatically transforming from the stowed position to the deployed position in response to operation of the deployment actuator.

9. The pet carrier of claim 8, wherein the at least one rigid latch connector further comprises a plurality of rigid latch connectors, the deployment actuator being operably coupled to the plurality of rigid latch connectors such that the plurality of rigid latch connectors are simultaneously transformable between the stowed position and the deployed position in response to operation of the deployment actuator.

10. The pet carrier of claim 8, wherein the deployment actuator is a handle arranged at the base.

11. The pet carrier of claim 8, wherein the deployment actuator is a handle arranged at front of the body.

12. The pet carrier of claim 8, further comprising a release mechanism operably coupled to the at least one rigid latch connector to unlock the at least one rigid latch connector.

13. The pet carrier of claim 12, wherein the release mechanism further comprises:
a release actuator; and
at least one transmitted operatively connecting the at least one rigid latch connector to the release actuator.

14. The pet carrier of claim 13, wherein the release actuator is a handle arranged at the first section of the body.

15. The pet carrier of claim 13, wherein the deployment actuator is the release actuator.

16. A pet carrier for containing animals on a vehicle seat, the pet carrier comprising:
a body defining an enclosure having an interior within which an animal is receivable, the body including a cavity; and
a plurality of rigid latch connectors mounted to the body for movement between a stowed position and a deployed position, wherein an axial distance defined between the plurality of rigid latch connectors in the deployed position is greater than the axial distance defined between the plurality of rigid latch connectors in the stowed position.

17. The pet carrier of claim 16, wherein the plurality of rigid latch connectors in the stowed position are parallel to the plurality of rigid latch connectors in the deployed position.

18. The pet carrier of claim 16, wherein the plurality of rigid latch connectors are rotatable about an axis between the stowed position and the deployed position.

19. The pet carrier of claim 16, wherein the plurality of rigid latch connectors are translatable about an axis between the stowed position and the deployed position.

20. The pet carrier of claim 16, wherein the plurality of rigid latch connectors are operable to rotate and translate simultaneously between the stowed position and the deployed position.

21. The pet carrier of claim 16, wherein the body includes a first section and a second section, the first section including a frame and containment materials extending at least partially about the frame, and the second section including a base, the frame being connectable to the base.

22. The pet carrier of claim 21, wherein the body is rectangular in shape and has a longer side and a shorter side, the plurality of rigid latch connectors being extendable from the shorter side.

23. The pet carrier of claim 21, wherein the pet carrier is receivable within an area under the vehicle seat, wherein a size of the base is equal to or less than the area under the vehicle seat when the plurality of rigid latch connectors are in the stowed position, and the size of the base exceeds the area under the vehicle seat when the plurality of rigid latch connectors are in the stowed position.

24. The pet carrier of claim 21, wherein at least one storage recess for receiving the plurality of rigid latch connectors is formed in the base.

25. The pet carrier of claim 24, wherein the at least one storage recess includes a first storage recess for receiving a first rigid latch connector of the plurality of rigid latch connectors and a second storage recess for receiving a second rigid latch connector of the plurality of rigid latch connectors, the first storage recess being separate from the second storage recess.

26.-120. (canceled)
